(19) United States
(12) Patent Application Publication
(10) Pub. No.: US 2023/0120554 A1
(43) Pub. Date: Apr. 20, 2023

(54) INK SET, IMAGE FORMING METHOD, AND IMAGE FORMING APPARATUS

(71) Applicants: Hiroshi Gotou, Kanagawa (JP); Toshiyuki Kobashi, Tokyo (JP); Tomohiro Hirade, Kanagawa (JP); Daisuke Ozaki, Kanagawa (JP)

(72) Inventors: Hiroshi Gotou, Kanagawa (JP); Toshiyuki Kobashi, Tokyo (JP); Tomohiro Hirade, Kanagawa (JP); Daisuke Ozaki, Kanagawa (JP)

(73) Assignee: Ricoh Company, Ltd., Tokyo (JP)

(21) Appl. No.: 17/932,082

(22) Filed: Sep. 14, 2022

(30) Foreign Application Priority Data
Oct. 18, 2021 (JP) 2021-170325
Jul. 15, 2022 (JP) 2022-114358

(51) Int. Cl. C09D 11/40; B41J 2/21; C09D 11/102; C09D 11/54

(52) U.S. Cl. CPC C09D 11/40; B41J 2/2117; C09D 11/102; C09D 11/54

(57) ABSTRACT

An ink set includes a white ink and a color ink. The white ink and the color ink each independently include water-dispersible resin particles, and a blocked isocyanate compound. A resin of the water-dispersible resin particles includes a crosslinkable functional group. The blocked isocyanate compound includes a functional group that can crosslink with the resin of the water-dispersible resin particles. An absolute value of a difference in static surface tension between the white ink and the color ink at 25° C. is 1.0 mN/m or less. Absolute values of differences in dynamic surface tension between the white ink and the color ink at 25° C. with bubble lifetime of 15 msec, a bubble lifetime of 150 msec, and a bubble lifetime of 1,500 msec are each independently 1.0 mN/m or less. The bubble lifetime is measured according to the maximum bubble pressure method.

### CROSS-REFERENCE TO RELATED APPLICATION

The present application claims priority under 35 U.S.C. § 119 to Japanese Patent Application No. 2021-170325, filed Oct. 18, 2021, and Japanese Patent Application No. 2022-114358, filed Jul. 15, 2022. The contents of which are incorporated herein by reference in their entirety.

### BACKGROUND OF THE INVENTION

### 1. Field of the Invention

The disclosures herein generally relate to an ink set, an image forming method, and an image forming apparatus.

### 2. Description of the Related Art

An inkjet recording method has been becoming very popular in recent years, because the inkjet recording method achieves easy formation of color images at low running cost. Moreover, the inkjet recording method has been also used for dyeing (or printing on) fabric (e.g., woven fabric, knitted fabric, and nonwoven fabric). Conventionally, screen printing, roller printing, etc. have been used as a method of printing on fabric. However, extensive research has been carried out to apply the inkjet recording method to the printing on fabric, because application of the inkjet recording method to the printing is advantageous considering small-lot production of various kinds of products, and instant printing. Also, pigment printing has been studied. In the pigment printing, a pigment and a fixing resin are blended in an ink composition for printing on fabric. In case of pigment printing, it is important that the pigment physically adheres to fiber filaments of fabric.

When printing is performed on a dark-color recording medium, for example, it has been known that a white ink is applied to a recording medium, to which a pre-processing fluid has been applied, to form a base, and a color ink is then applied to the white base to improve coloring of a resultant image (see Japanese Unexamined Patent Application Publication No. 2008-266853).

### SUMMARY OF THE INVENTION

In one embodiment, an ink set includes a white ink and a color ink. The white ink and the color ink each independently include water-dispersible resin particles, and a blocked isocyanate compound. A resin of the water-dispersible resin particles includes a crosslinkable functional group, and the blocked isocyanate compound includes a functional group that can crosslink with the resin of the water-dispersible resin particles. An absolute value of a difference in static surface tension between the white ink and the color ink at 25° C. is 1.0 mN/m or less. An absolute value of a difference in dynamic surface tension between the white ink and the color ink at 25° C. with a bubble lifetime of 15 msec, an absolute value of a difference in dynamic surface tension between the white ink and the color ink at 25° C. with a bubble lifetime of 150 msec, and an absolute value of a difference in dynamic surface tension between the white ink and the color ink at 25° C. with a bubble lifetime of 1,500 msec are each independently 1.0 mN/m or less, where the bubble lifetime is a bubble lifetime measured according to the maximum bubble pressure method.

### BRIEF DESCRIPTION OF THE DRAWINGS

FIG. 1 is a schematic perspective view illustrating an example of the image forming apparatus of the present disclosure;

FIG. 2 is a schematic perspective view illustrating an example of a storage unit of the image forming apparatus of the present disclosure; and

FIG. 3 is a schematic view illustrating an example of a chart printed by the image forming apparatus of the present disclosure.

### DESCRIPTION OF THE PREFERRED EMBODIMENTS

In the following, embodiments of the present invention will be described with reference to the accompanying drawings.

Further, the present invention is not limited to these embodiments, but various variations and modifications may be made without departing from the scope of the present invention.

### (Ink Set)

The ink set of the present disclosure includes a white ink and a color ink, and preferably further includes a pre-processing fluid. The ink set may further include other components according to the necessity.

The white ink and the color ink in the ink set each independently include water-dispersible resin particles, and a blocked isocyanate compound. A resin of the water-dispersible resin particles includes a crosslinkable functional group, and the blocked isocyanate compound includes a functional group that can crosslink with the resin of the water-dispersible resin particles.

An absolute value of a difference in static surface tension between the white ink and the color ink at 25° C. is 1.0 mN/m or less.

An absolute value of a difference in dynamic surface tension between the white ink and the color ink at 25° C. with a bubble lifetime of 15 msec, an absolute value of a difference in dynamic surface tension between the white ink and the color ink at 25° C. with a bubble lifetime of 150 msec, and an absolute value of a difference in dynamic surface tension between the white ink and the color ink at 25° C. with a bubble lifetime of 1,500 msec are each independently 1.0 mN/m or less. The bubble lifetime is a bubble lifetime measured according to the maximum bubble pressure method.

The present disclosure has an object to provide an ink set that imparts excellent rubbing fastness to a resultant image, and can reduce color bleeding and beading.

The present disclosure can provide an ink set that imparts excellent rubbing fastness to a resultant image, and can reduce color bleeding and beading.

In the present specification, the “ink set” is not particularly limited, provided that the white ink and the color ink are each independently present. For example, the ink set is not limited to an embodiment where a white ink storage unit in which the white ink is stored and a color ink storage unit in which the color ink is stored are manufactured and sold as an integrated unit. Even when the white ink storage unit and the color ink storage unit are each separately produced, sold, etc., for example, such an embodiment is intended to be encompassed by the ink set of the present disclosure if an assumption is given that the white ink and the color ink are to be used in combination, or combined use of the white ink and the color ink is substantially advised or guided.

In the present specification, the term “white ink” means a liquid composition that is applied to a recording medium to form a white image. When the ink set includes the pre-processing fluid, moreover, the term “white ink” means a liquid composition that is applied to an area of a recording medium, to which the pre-processing fluid has been applied, to form a white image.

The white ink forms a white image on a recording medium. The white image functions as a base of a color image, which is formed by applying the color ink to the area of the recording medium where the white ink has been applied, to improve coloring of the color image.

In the present specification, the term “white” means a color that is commonly regarded as white, and includes a white color that may be slightly tinted.

The Hunter whiteness of a white image formed on a recording medium with the white ink is not particularly limited, and may be appropriately selected in accordance with the intended purpose. The Hunter whiteness of the white image is preferably 75 or greater, more preferably 80 or greater, and particularly preferably 85 or greater. When the Hunter whiteness of the white image is 75 or greater, coloring of a color image improves.

The Hunter whiteness can be determined by measuring Lab color values of a white image formed on a recording medium by means of a spectrophotometer (e.g., X-Rite eXact, available from X-Rite), and calculating the Hunter whiteness according to Mathematical Equation (1). The Lab color values of the Lab color space are in accordance with a color system defined by the International Commission on Illumination (CIE), and are also referred to as L*a*b* values.

Hunter whiteness=100−sqr[(100−L)²+(a²+b²)] Mathematical Equation (1)

The ink set may include, as the white ink, a single white ink, or a combination of white inks.

In the present specification, the term “color ink” means a liquid composition that is applied to an area of a recording medium, to which the white ink has been applied, to form a color image.

In the present specification, the term “color” means colors except the above-described “white,” and includes colors, such as black, cyan, magenta, and yellow.

The ink set may include, as the color ink, a single-color ink, or a combination of color inks.

In the present specification, the term “pre-processing fluid” means a liquid composition that is applied to a recording medium and comes into contact with the white ink or color ink applied to the area of the recording medium where the pre-processing fluid has been applied later after the application of the pre-processing fluid, to thereby cause aggregation in the white ink or the color ink, or thicken the white ink or the color ink.

### [Static Surface Tension]

An absolute value of a difference in static surface tension between the white ink and the color ink included in the ink set at 25° C. is 1.0 mN/m or less, preferably 0.8 mN/m or less, more preferably 0.6 mN/m or less, and even more preferably 0.5 mN/m or less. As the absolute value of the difference in the static surface tension between the white ink and the color ink of the ink set at 25° C. is getting closer to 0 mN/m, an effect of reducing color bleeding and beading is exhibited more significantly. Since the difference in the static surface tension is expressed with an absolute value, the difference is 0 mN/m or greater. When the absolute value of the difference in the static surface tension between the white ink and the color ink in the ink set at 25° C. is greater than 1.0 mN/m, color bleeding occurs if, after applying the white ink to the recording medium, the color ink is applied to the area of the recoding medium, to which the white ink has been applied.

When the ink set includes a plurality of the white inks and/or a plurality of the color inks, moreover, the difference in the static surface tension is not limited, provided that the absolute value of the difference in the static surface tension between a certain combination of the white ink and the color ink is 1.0 mN/m or less. It is preferable that the absolute value of the maximum difference in the static surface tension between the white ink and the color ink be 1.0 mN/m or less. It is more preferable that the absolute values of the differences in the static surface tension between all the combinations of the white ink and the color ink be 1.0 mN/m or less.

The static surface tension of the white ink included in the ink set at 25° C. and the static surface tension of the color ink included in the ink set at 25° C. are each independently preferably 40.0 mN/m or less, more preferably 36.0 mN/m or less, and even more preferably 30.0 mN/m or less. As the static surface tension of the white ink at 25° C. and the static surface tension of the color ink at 25° C. are each independently 40.0 mN/m or less, color bleeding between one color ink and another color ink can be minimized as well as color bleeding between the white ink and the color ink.

When the ink set includes a plurality of the white inks and/or a plurality of the color inks, moreover, the static surface tension of the certain white ink and the static surface tension of the certain color ink are each independently preferably 40.0 mN/m or less. It is more preferable that the static surface tension of all the white inks and the static surface tension of all the colors ink be each independently 40.0 mN/m or less.

The phrase “each independently” means that the values of the static surface tension may be identical or different, provided that the values of the static surface tensions of the white inks and the color inks at 25° C. are all 40.0 mN/m or less.

The static surface tension of the white ink or the color ink at 25° C. can be measured by means of an automatic surface tensiometer (e.g., DY-300, available from Kyowa Interface Science Co., Ltd.) according to the plate method (the Wilhelmy plate method). Moreover, the temperature 25° C. for measuring the static surface tension is not a temperature of a recording medium, but the temperature of the white ink or the color ink itself.

### [Dynamic Surface Tension]

An absolute value of a difference in the dynamic surface tension between the white ink and the color ink at 25° C. with a bubble lifetime of 15 msec, an absolute value of a difference in dynamic surface tension between the white ink and the color ink at 25° C. with a bubble lifetime of 150 msec, and an absolute value of a difference in dynamic surface tension between the white ink and the color ink at 25° C. with a bubble lifetime of 1,500 msec are each independently 1.0 mN/m or less, and preferably 0.9 mN/m or less. The bubble lifetime is a bubble lifetime measured according to the maximum bubble pressure method. As the absolute values of the differences in the dynamic surface tension between the white ink and the color ink at 25° C. with the bubble lifetime of 15 msec, 150 msec, and 1,500 msec, respectively, are each independently getting closer to 0 mN/m, an effect of reducing color bleeding and beading is exhibited more significantly. Since the difference in the dynamic surface tension is expressed with an absolute value, the difference is 0 mN/m or greater. When the absolute values of the differences between in the dynamic surface tension between the white ink and the color ink at 25° C. with the bubble lifetime of 15 msec, 150 msec, and 1,500 msec, respectively, are each independently greater than 1.0 mN/m, color bleeding occurs if, after applying the white ink to the recording medium, the color ink is applied to the area of the recoding medium, to which the white ink has been applied.

When the ink set includes a plurality of the white inks and/or a plurality of the color inks, moreover, the difference in the dynamic surface tension is not limited, provided that the absolute values of the differences between in the dynamic surface tension between the white ink and the color ink at 25° C. with the bubble lifetime of 15 msec, 150 msec, and 1,500 msec, respectively, are each independently 1.0 mN/m or less. It is preferable for the absolute value of the maximum difference in the dynamic surface tension between a certain combination of the white ink and the color ink at 25° C. with the bubble lifetime of 15 msec, 150 msec, or 1,500 msec to be each independently 1.0 mN/m or less. It is more preferable that the absolute values of the differences in the dynamic surface tension between all the combinations of the white ink and the color ink at 25° C. with the bubble lifetime of 15 msec, 150 msec, and 1,500 msec, respectively, be each independently 1.0 mN/m or less.

The phrase “each independently” means that the absolute values may be identical or different, provided that the absolute values of the differences in the dynamic surface tension between the combinations of the white ink and the color ink at 25° C. with the bubble lifetime of 15 msec, 150 msec, and 1,500 msec, respectively, are all 1.0 mN/m or less.

The dynamic surface tension of the white ink or the color ink at 25° C. with the bubble lifetime of 15 msec, 150 msec, and 1,500 msec according to the maximum bubble pressure method can be measured by means of a portable dynamic surface tensiometer (e.g., SITA Pro line t15, available from EKO INSTRUMENTS CO., LTD.).

The mechanism for reducing color bleeding with the ink set will be described hereinafter.

It has been known that rubbing fastness of an image can improve when a crosslinkable resin having a polycarbonate-based skeleton and a blocked isocyanate compound are added to an ink composition, and re-dispersibility of the crosslinkable resin is facilitated by adding an alkaline (basic) compound to the ink composition (see Japanese Patent No. 6794746). However, such an ink composition tends to cause image defects, such as blurring of printed letters, and has a problem that quality of a resultant image is significantly degraded.

When printing is performed on a recording medium of dark color, moreover, a white ink is typically applied to the recording medium to form a base, and a color ink is then applied to the area, to which the white ink has been applied, to improve coloring of a color image. When the color ink is applied within a short period (e.g., within 20 seconds) from the application of the white ink, however, the white ink and the color ink are mixed so that color bleeding occurs due to inadequate drying of the white ink. This is because the recording medium has low permeability (including a case of a nonpermeable recording medium), or the color ink is applied to the recording medium, to which the white ink has been applied, without heating the recording medium with a heating unit during a period between the application of the white ink and the application of the color ink. Moreover, there is also a problem of beading. The beading is density unevenness observed in a color image. The beading occurs because drying performance of the color ink that is applied to the area where the white ink is applied is impaired due to inadequate drying of the white ink as mentioned above.

Meanwhile, the ink set of the present disclosure can minimize color bleeding even when drying of the white ink is inadequate, because the absolute value of the difference in static surface tension between the white ink and the color ink at 25° C. is 1.0 mN/m or less, and the absolute value of the difference in the dynamic surface tension between the white ink and the color ink at 25° C. with a bubble lifetime of 15 msec, the absolute value of the difference in the dynamic surface tension between the white ink and the color ink at 25° C. with a bubble lifetime of 150 msec, and the absolute value of the difference in the dynamic surface tension between the white ink and the color ink at 25° C. with a bubble lifetime of 1,500 msec are each independently 1.0 mN/m or less, where the bubble lifetime is a bubble lifetime measured according to the maximum bubble pressure method.

When drying of the white ink is inadequate as described above, moreover, if a plurality of color inks is used, color bleeding between the color inks occurs in addition to color bleeding between the white ink and each color ink, as the color inks applied to the area, to which the white ink has been applied, come into contact with one another, and are mixed with one another.

In the ink set, meanwhile, the absolute value of the difference in the dynamic surface tension between the color inks at 25° C. with the bubble lifetime of 15 msec according to the maximum bubble pressure method is preferably 1.0 mN/m or less, and more preferably 0.9 mN/m or less. Since the absolute value of the difference in the dynamic surface tension between the color inks at 25° C. with the bubble lifetime of 15 msec according to the maximum bubble pressure method is preferably 1.0 mN/m or less, color bleeding between the color inks can be minimized. Since the difference in the dynamic surface tension between the color inks at 25° C. with the bubble lifetime of 15 msec according to the maximum bubble pressure method is expressed with an absolute value, the difference is 0 mN/m or greater.

Moreover, the difference in the dynamic surface tension between a certain combination of color inks among all the color inks is not limited, provided that the absolute value of the difference in the dynamic surface tension between such a combination of the color inks at 25° C. with the bubble lifetime of 15 msec according to the maximum bubble pressure method is 1.0 mN/m or less. It is preferable that the absolute value of the maximum difference in the dynamic surface tension between a certain combination of the color inks among all the color inks at 25° C. with the bubble lifetime of 15 msec according to the maximum bubble pressure method be 1.0 mN/m or less. It is more preferable that the absolute values of the differences in the dynamic surface tension between all the combinations of the color inks at 25° C. with the bubble lifetime of 15 msec according to the maximum bubble pressure method be each independently 1.0 mN/m or less.

When the ink set includes a black ink, a cyan ink, a magenta ink, and a yellow ink as a plurality of the color inks, for example, absolute values of differences in dynamic surface tension between the black ink and the cyan ink, between the black ink and the magenta ink, between the black ink and the yellow ink, between the cyan ink and the magenta ink, between the cyan ink and the yellow ink, and between the magenta ink and the yellow ink at 25° C. with the bubble lifetime of 15 msec according to the maximum bubble pressure method are all each independently preferably 1.0 mN/m or less.

The phrase “each independently” means that the absolute values may be identical or different, provided that the absolute values of the differences in the dynamic surface tensions between the color inks at 25° C. with 15 msec are all 1.0 mN/m or less.

When the ink set includes the black ink, the cyan ink, the magenta ink, and the yellow ink as a plurality of the color inks, as described above, the values of the dynamic surface tension of all the color inks at 25° C. with the bubble lifetime of 15 msec according to the maximum bubble pressure method preferably satisfy Relational Expression (1) below. As the color ink moves towards the side closer to the left end of Relational Expression (1) (i.e., the color ink has the larger absolute value of the difference in the dynamic surface tension with other color inks at 25° C. with 15 msec), such a color ink largely affects visually the area of other color inks when color bleeding occurs. Since Relational Expression (1) is satisfied, however, color bleeding where the color ink positioned at the left side of Relational Expression (1) enters the area of the color ink positioned at the right side of the Relational Expression (1) (i.e., the color ink having the smaller absolute value of the difference in the dynamic surface tension with other color inks at 25° C. with 15 msec) can be minimized.

Black ink>cyan ink≥magenta ink≥yellow ink Relational Expression (1)

### <White Ink and Color Ink>

The white ink and the color ink (may be collectively referred to as an “ink” hereinafter) each independently include water-dispersible resin particles, and a blocked isocyanate compound. A resin of the water-dispersible resin particles includes a crosslinkable functional group, and the blocked isocyanate compound includes a functional group that can crosslink with the resin of the water-dispersible resin particles. The white ink and the color ink each independently preferably further include an organic solvent, water, a colorant, and a surfactant, and may further include other components according to the necessity.

In the preset specification, the phrase “each independently” means that the composition of the white ink and the composition of the color ink may be identical or different, provided that the composition of the white ink and the composition of the color ink both include the water-dispersible resin particles, and the blocked isocyanate compound.

When the ink set includes the pre-processing fluid in addition to the white ink and the color ink, either the colorant or the resin, or both the colorant and the resin are preferably anionic. In this case, the anionic colorant or the anionic resin may be referred to as an “anionic compound.” Since the colorant and/or the resin is anionic, the white ink or the color ink causes aggregation to thicken the white ink or the color ink, as the white ink or the color ink comes into contact with the components (e.g., a flocculant) included in the pre-processing fluid to retain the white ink or the color ink on the surface of the recording medium.

### —Water-Dispersible Resin Particles—

The water-dispersible resin particles are not particularly limited, provided that the resin constituting each water-dispersible resin particle includes a crosslinkable functional group. The water-dispersible resin particles may be appropriately selected in accordance with the intended purpose. The water-dispersible resin particles may be self-emulsifying resin particles where a hydrophilic component is introduced to the resin for stably dispersing the resin particles in water, or particles that can be dispersible in water using an emulsifier that is externally added.

The water-dispersible resin particles for use are not particularly limited, and may be appropriately selected in accordance with the intended purpose. The water-dispersible resin particles are preferably particles capable of imparting film elasticity and tensile strength to a resultant coating film, and more preferably urethane resin particles because desired physical properties can be easily imparted to a coating film owing to a wide margin of freedom in designing the urethane resin particles.

The urethane resin is not particularly limited, provided that the urethane resin has a urethane-skeleton and is dispersible in water. The urethane resin may be appropriately selected in accordance with the intended purpose. Considering compatibility with a material of an inkjet head, the urethane resin is preferably an anionic urethane resin (i.e., an anionic resin having a urethane-skeleton) having an anionic functional group, such as a carboxyl group, a sulfo group, and a hydroxy group.

Specific examples of the anionic urethane resin include SUPERFLEX 460, SUPERFLEX 460S, SUPERFLEX 470, and SUPERFLEX 840 (all available from DKS Co., Ltd.); and TAKELAC (registered trademark) WS-4022, TAKELAC (registered trademark) WS-5100, TAKELAC (registered trademark) WS-5984, and TAKELAC (registered trademark) WS-6021 (all available from Mitsui Chemicals, Inc.).

Preferably usable as the urethane resin are a polyether-based urethane resin including an ether bond in a main chain in addition to the urethane bond, a polyester-based urethane resin including an ester bond in a main chain in addition to the urethane bond, and a polycarbonate-based urethane resin including a carbonate bond in a principle chain in addition to the urethane bond. Among the above-listed examples, the polycarbonate-based urethane resin and the polyether-based urethane resin are preferable as the urethane resin.

The above-listed urethane resins may be used alone or in combination. In combination with the water-dispersible resin particles having the above-described physical properties, one or more water-dispersible resins, such as an acrylic resin, an acryl-styrene resin, a vinyl acetate resin, and an acryl-vinyl acetate resin, may be used, provided that the effects obtainable by the present disclosure are not adversely affected.

The volume average particle diameter of the water-dispersible resin particles is not particularly limited, and may be appropriately selected in accordance with the intended purpose. The volume average particle diameter of the water-dispersible resin particles is preferably 0.01 μm or greater and 0.15 μm or less, and more preferably 0.02 μm or greater and 0.1 μm or less.

For example, the volume average particle diameter of the water-dispersible resin particles may be measured by means of a particle size analyzer (Nanotrac Wave II-UT151, available from Microtrac MRB).

An amount (i.e., a solid amount) of the water-dispersible resin particles in the white ink or the color ink is not particularly limited, and may be appropriately selected in accordance with the intended purpose. The amount (i.e., the solid amount) of the water-dispersible resin particles relative to a total mass of the white ink or the color ink is preferably 3% by mass or greater and 15% by mass or less, and more preferably 5% by mass or greater and 13% by mass or less. When the amount (i.e., the solid amount) of the water-dispersible resin particles is 15% by mass or greater, ejection stability of the ink may be impaired. When the amount (i.e., the solid amount) of the water-dispersible resin particles is 3% by mass or less, rubbing fastness of a resultant image may be significantly degraded.

### —Blocked Isocyanate Compound—

The blocked isocyanate compound includes a functional group that can crosslink with the resin of the water-dispersible resin particles. The blocked isocyanate compound is added to the ink as a crosslinking agent for the water-dispersible resin particles.

The blocked isocyanate compound is an isocyanate compound in which an isocyanate group is protected with a blocking agent, where the active isocyanate group is regenerated as the blocking agent is detached from the isocyanate group by heating. It is assumed that the isocyanate group generated by heating reacts with the water-dispersible resin particles (e.g., the urethane resin particles), or reacts with the crosslinkable functional group of the resin of the water-dispersible resin particles, and a functional group or an active hydrogen site of a recording medium, such as fabric, to form a crosslink structure with a urethane bond or a urea bond.

The blocking agent is not particularly limited, and may be appropriately selected in accordance with the intended purpose. Examples of the blocking agent include a phenol-based compound, an aromatic secondary amine compound, a cyclic amine compound, a lactam compound, an oxime compound, and sodium sulfite. The above-listed examples may be used alone or in combination.

More specifically, the blocked isocyanate compound is preferably a blocked isocyanate compound having a urethane skeleton.

As specific examples of the blocked isocyanate compound having a urethane skeleton, various commercial products, such as ERASTRON (registered trademark) series, ERASTRON (registered trademark) BN series (both available from DKS Co., Ltd.), TAKENATE (registered trademark) series (available from Mitsui Chemicals, Inc.), and ADEKA BONTIGHTER HUX series (available from ADEKA CORPORATION) may be used. More preferably used are commercial products, such as ERASTRON (registered trademark) E-37, ERASTRON (registered trademark) H-3-DF, ERASTRON (registered trademark) H-15, ERASTRON (registered trademark) NEW BAP-15, ERASTRON (registered trademark) F-29, and ERASTRON (registered trademark) W-11P (all available from DKS Co., Ltd.); TAKENATE (registered trademark) XWB-ST001, and TAKENATE (registered trademark) XWB-ST047 (both available from Mitsui Chemicals, Inc.); and ADEKA BONTIGHTER HUX-3861, and ADEKA BONTIGHTER HUX-3560 (both available from ADEKA CORPORATION).

Considering fastness, an ink film is generally desired to have a film thickness of from approximately 10 μm through approximately 300 μm. However, such a thick ink film has a problem that a texture or characteristics a recording medium (e.g., fabric) originally has are impaired.

Since the blocked isocyanate compound is used in the ink set of the present disclosure, adequate fastness can be secured without forming a thick ink film as in the related art. Therefore, the ink set of the present disclosure has an advantage that a texture or characteristics of the recording medium originally has are not impaired. Particularly, the ink set has an advantage that an ink film having strong adhesion and fastness can be formed by using the water-dispersible resin particles (e.g., the urethane resin particles) in combination with the blocked isocyanate compound.

An amount of the blocked isocyanate compound in the white ink or the color ink is not particularly limited, and may be appropriately selected in accordance with the intended purpose. The amount of the blocked isocyanate compound relative to 1 part by mass of the water-dispersible resin particles (based on the mass of the solids) is preferably 0.05 parts by mass or greater for securing fastness, particularly wet rubbing fastness, preferably 1.0 part by mass or less for preventing the texture or characteristics of the recording medium from being impaired, more preferably from 0.05 parts by mass through 0.6 parts by mass, and even more preferably 0.1 parts by mass through 0.55 parts by mass considering properties of an ink film to be formed.

The rubbing fastness can be determined by measuring rubbing fastness by means of a Type I rubbing tester according to the Type I rubbing tester (clockmeter) method specified in JIS L 0849. The rating of the rubbing fastness is preferably Grade 3-4 or better, more preferably Grade 4-5 or better in both the dry test and the wet test.

Note that, the amount of the blocked isocyanate compound in the white ink and the amount of the blocked isocyanate compound in the color ink may be identical or different.

### —Organic Solvent—

The organic solvent is not particularly limited, and may be appropriately selected in accordance with the intended purpose. As the organic solvent, an organic solvent having an equilibrium moisture content of 30% by mass or greater in an atmosphere having a temperature of 23° C. and relative humidity (RH) of 80% (may be merely referred to as a “wetting agent” hereinafter) is preferably used. Among such organic solvents, the organic solvent having the higher equilibrium moisture content and the higher boiling point (bp) is more preferable. Such an organic solvent is used considering reduction in color bleeding and beading (i.e., control of static surface tension and dynamic surface tension), but use of the organic solvent also contributes to improvement in ejection stability of the ink, and reduction in occurrences of adhesion of the waste ink in a maintenance system of an image forming apparatus.

The equilibrium moisture content (%) is a value determined by maintaining a temperature and humidity inside a desiccator to 23° C.±1° C. and RH80%±3% using a saturated aqueous solution obtained by blending potassium chloride and sodium chloride at a blending ratio (potassium chloride:sodium chloride) of 6:4 (parts by mass), placing a Petri dish in which each organic solvent is weighed and collected by 1 g inside the desiccator to measure an amount of the equilibrium moisture, and calculating according to Mathematical Equation (2) below.

Equilibrium moisture content (% by mass)=[amount of moisture absorbed by organic solvent/(amount of organic solvent+amount of moisture absorbed by organic solvent)]×100 Mathematical Equation (2)

Examples of the wetting agent include multivalent alcohols each having an equilibrium moisture content of 30% by mass or greater in an atmosphere having a temperature of 23° C. and the relative humidity of RH80%. Specific examples of the multivalent alcohols include diethylene glycol (bp: 245° C., equilibrium moisture content: 43% by mass), triethylene glycol (bp: 285° C., equilibrium moisture content: 39% by mass), tetraethylene glycol (bp: 324° C. through 330° C., equilibrium moisture content: 37% by mass), 1,3-butanediol (bp: 203° C. through 204° C., equilibrium moisture content: 35% by mass), glycerin (bp: 290° C., equilibrium moisture content: 49% by mass), diglycerin (bp: 270° C./20 hPa, equilibrium moisture content: 38% by mass), 1,2,3-butanetriol (bp: 175° C./33 hPa, equilibrium moisture content: 38% by mass), and 1,2,4-butanetriol (bp: 190° C. through 191° C./24 hPa, equilibrium moisture content: 41% by mass). The above-listed examples may be used alone or in combination. Among the above-listed examples, glycerin and 1,3-butanediol are preferable as the wetting agent.

Examples of the wetting agent, excluding the multivalent alcohols, include 2-methyl-1,3-butanediol (bp: 214° C.), 3-methyl-1,3-butanediol (bp: 203° C.), dipropylen glycol (bp: 232° C.), 1,5-pentanediol (bp: 242° C.), propylene glycol (bp: 187° C.), 2-methyl-2,4-pentanediol (bp: 197° C.), ethylene glycol (bp: 196° C. through 198° C.), tripropylen glycol (bp: 267° C.), hexylene glycol (bp: 197° C.), polyethylene glycol (in the state of a viscous liquid to solids), polypropylene glycol (bp: 187° C.), 1,6-hexanediol (bp: 253° C. to 260° C.), 1,2,6-hexanetriol (bp: 178° C.), trimethylolethane (solids, melting point (mp): 199° C. to 201° C.), and trimethylolpropane (solids, mp: 61° C.). The above-listed examples may be used alone or in combination.

An amount of the organic solvent (i.e., the wetting agent) in the white ink or the color ink is not particularly limited, and may be appropriately selected in accordance with the intended purpose. The amount of the organic solvent relative to a total mass of the white ink or the color ink is preferably 10.0% by mass or greater and 75.0% by mass or less, and more preferably 15.0% by mass or greater and 50.0% by mass or less. When the amount of the organic solvent (i.e., wetting agent) is 10.0% by mass or greater, a moisture retention effect of the white ink or the color ink improves. When the amount of the organic solvent is 75.0% by mass or less, the drying speed of the white ink or the color ink on a recording medium improves.

When a recording medium having low permeability (including a non-permeable recording medium) is used, moreover, the organic solvent is preferably an organic solvent having a solubility parameter (SP) value of 9.0 (cal/cm³)^{1/2} or greater and 11.8 (cal/cm³)^{1/2} or less. Specific examples of the organic solvent having the solubility parameter value of 9.0 (cal/cm³)^{1/2} or greater and 11.8 (cal/cm³)^{1/2} or less include 3-ethyl-3-oxetanemethanol (SP value: 11.31 (cal/cm³)^{1/2}), 3-methyl-3-oxetanemethanol (SP value: 11.79 (cal/cm³)^{1/2}), β-methoxy-N,N-dimethylpropionamide(3-methoxy-N, N-dimethylpropionamide) (SP value: 9.19 (cal/cm³)^{1/2}), 0-butoxy-N,N-dimethylpropionamide(3-butoxy-N,N-dimethylpropionamide) (SP value: 9.03 (cal/cm³)^{1/2}), 1,2-hexanediol (SP value: 11.8 (cal/cm³)^{1/2}), 2-ethyl-1,3-hexanediol (SP value: 10.6 (cal/cm³)^{1/2}), 2,2,4-trimethyl-1,3-pentanediol (SP value: 10.8 (cal/cm³)^{1/2}), diethylene glycol monoethyl ether (SP value: 10.14 (cal/cm³)^{1/2}), 3-methoxy-1-butanol (SP value: 9.64 (cal/cm³)^{1/2}), 3-methoxy-3-methyl-1-butanol (SP value: 9.64 (cal/cm³)^{1/2}), 3-methyl-1,5-pentanediol (SP value: 11.8 (cal/cm³)^{1/2}), methylpropylen triglycol (SP value: 9.43 (cal/cm³)^{1/2}), diethylene glycol mono-n-butyl ether (SP value: 9.86 (cal/cm³)^{1/2}), diethylene glycol monomethyl ether (SP value: 10.34 (cal/cm³)^{1/2}), triethylene glycol monomethyl ether (SP value: 10.12 (cal/cm³)^{1/2}), propylene glycol monopropyl ether (SP value: 9.82 (cal/cm³)^{1/2}), propylene glycol monomethyl ether (SP value: 10.19 (cal/cm³)^{1/2}), propylene glycol monobutyl ether (SP value: 9.69 (cal/cm³)^{1/2}), 3-methoxy-1-butanol (SP value: 10.65 (cal/cm³)^{1/2}), 3-methoxy-1-propanol (SP value: 10.41 (cal/cm³)^{1/2}), dipropylene glycol monomethyl ether (SP value: 9.84 (cal/cm³)^{1/2}), and 3-methyl-1,5-pentanediol (SP value: 11.8 (cal/cm³)^{1/2}). The above-listed examples may be used alone or in combination.

An amount of the organic solvent having the solubility parameter value of 9.0 (cal/cm³)^{1/2} or greater and 11.8 (cal/cm³)^{1/2} or less in the white ink or the color ink is not particularly limited, and may be appropriately selected in accordance with the intended purpose. The amount of the organic solvent having the solubility parameter value of 9.0 (cal/cm³)^{1/2} or greater and 11.8 (cal/cm³)^{1/2} or less relative to a total mass of the white ink or the color ink is preferably 0.5% by mass or greater and 5.0% by mass or less, and more preferably 1.0% by mass or greater and 4.0% by mass or less. Use of the organic solvent having the solubility parameter value of 9.0 (cal/cm³)^{1/2} or greater and 11.8 (cal/cm³)^{1/2} or less in the amount of 0.5% by mass or greater and 5.0% by mass or less is preferable considering reduction in color bleeding and beading (i.e., control of static surface tension and dynamic surface tension), as well as coloring of the white ink or the color ink.

### —Water—

The water is not particularly limited, and may be appropriately selected in accordance with the intended purpose. Examples of the water include pure water (e.g., ion-exchanged water, ultrafiltered water, reverse osmosis water, and distilled water), and ultrapure water (i.e., highly pure water). The above-listed examples may be used alone or in combination.

An amount of the water in the white ink or the color ink is not particularly limited, and may be appropriately selected in accordance with the intended purpose. Considering drying speed and ejection reliability of the white ink or the color ink, the amount of the water relative to a total mass of the white ink or the color ink is preferably 10.0% by mass or greater and 90.0% by mass or less, and more preferably 20.0% by mass or greater and 60.0% by mass or less.

### —Colorant—

The white ink includes a white colorant. The color ink includes a color colorant. In the present specification, the colorant may be merely referred to as a “colorant” if there is no need to distinguish between the white colorant and the color colorant.

A pigment may be used as the colorant. The pigment is not particularly limited. An inorganic pigment or an organic pigment may be used as the pigment. The above-listed examples may be used alone or in combination.

As the pigment, for example, a black pigment, a yellow pigment, a magenta pigment, a cyan pigment, a white pigment, a green pigment, an orange pigment, or a glossy color pigment or metallic pigment (e.g., a gold-color pigment and a silver-color pigment) may be used.

The inorganic pigment is not particularly limited, and may be appropriately selected in accordance with the intended purpose. Examples of the inorganic pigment include titanium oxide, iron oxide, calcium carbonate, barium sulfate, aluminium hydroxide, barium yellow, cadmium red, chrome yellow, and carbon black. Among the above-listed examples of the inorganic pigment, titanium oxide is preferable as a white colorant, and carbon black is preferable as a black colorant.

The carbon black is not particularly limited, and may be appropriately selected in accordance with the intended purpose. Examples of the carbon black include channel black, furnace black, gas black, and lamp black produced by any of methods known in the art, such as the contact method, the furnace method, and the thermal method.

The organic pigment is not particularly limited, and may be appropriately selected in accordance with the intended purpose. Examples of the organic pigment include an azo pigment, a polycyclic pigment, a dye chelate, a nitro pigment, a nitroso pigment, and aniline black. Among the above-listed examples of the organic pigment, an azo pigment and a polycyclic pigment are preferable.

Examples of the azo pigment include azo lake, an insoluble azo pigment, a condensed azo pigment, and a chelate azo pigment.

Examples of the polycyclic pigment include a phthalocyanine pigment, a perylene pigment, a perinone pigment, an anthraquinone pigment, a quinacridone pigment, a dioxazine pigment, an indigo pigment, a thioindigo pigment, an isoindolinone pigment, and a quinophthalone pigment.

Examples of the dye chelate include a basic dye-based chelate, and an acidic dye-based chelate.

Specific examples of the organic pigment include C.I. Pigment Yellow 1, 3, 12, 13, 14, 17, 24, 34, 35, 37, 42 (yellow iron oxide), 53, 55, 74, 81, 83, 95, 97, 98, 100, 101, 104, 408, 109, 110, 117, 120, 128, 139, 150, 151, 155, 153, 180, 183, 185, and 213; C.I. Pigment Orange 5, 13, 16, 17, 36, 43, and 51; C.I. Pigment Red 1, 2, 3, 5, 17, 22, 23, 31, 38, 48:2 (Permanent Red 2B(Ca)), 48:3, 48:4, 49:1, 52:2, 53:1, 57:1 (Brilliant Carmine 6B), 60:1, 63:1, 63:2, 64:1, 81, 83, 88, 101 (red iron oxide), 104, 105, 106, 108 (cadmium red), 112, 114, 122 (quinacridone magenta), 123, 146, 149, 166, 168, 170, 172, 177, 178, 179, 185, 190, 193, 209, and 219; C.I. Pigment Violet 1 (rhodamine lake), 3, 5:1, 16, 19, 23, and 38; C.I. Pigment Blue 1, 2, 15 (phthalocyanine blue), 15:1, 15:2, 15:3 (phthalocyanine blue), 15:4, 16, 17:1, 56, 60, and 63; and C.I. Pigment Green 1, 4, 7, 8, 10, 17, 18, and 36.

The BET specific surface area of the pigment is not particularly limited, and may be appropriately selected in accordance with the intended purpose. The BET specific surface area of the pigment is preferably 10 m²/g or greater and 1,500 m²/g or less, more preferably 20 m²/g or greater and 600 m²/g or less, and even more preferably 50 m²/g or greater and 300 m²/g or less.

The pigment having the desired BET specific surface area can be obtained by a typical size reduction or pulverization process.

The size reduction or pulverization process is not particularly limited, and may be appropriately selected from methods known in the art. Examples of the size reduction or pulverization method include ball mill pulverization, jet mill pulverization, and ultrasonication. The pigment may be subjected to one of the above-listed processes or any combination of the above-listed processes.

The 50% volume median particle diameter (D50) of the pigment is not particularly limited, and may be appropriately selected in accordance with the intended purpose. The D50 of the pigment is preferably 50 nm or greater and 350 nm or less in the white ink or the color ink.

The 50% volume median particle diameter (D50) of the pigment can be measured, for example, by means of a particle size analyzer (Nanotrac Wave II-UT151, available from Microtrac MRB).

An amount (i.e., a solid amount) of the pigment in the white ink or the color ink is not particularly limited, and may be appropriately selected in accordance with the intended purpose. The amount (the sold amount) of the pigment relative to a total mass of the white ink or the color ink is preferably 1.0% by mass or greater and 15.0% by mass or less, and more preferably 1.5% by mass or greater and 10.0% by mass or less. When the amount (i.e., the solid amount) of the pigment is 1.0% by mass or greater, coloring of the white ink or the color ink improves and image density of a resultant image improves. When the amount (i.e., the solid amount) of the pigment is 15.0% by mass or less, ejection of the white ink or the color ink is stabilized.

As specific examples of the composite pigment, a silica/carbon black composite material, a silica/phthalocyanine PB15:3 composite material, a silica/disazo yellow composite material, and a silica/quinacridone PR122 composite material (all available from TODA KOGYO CORP.) are preferable considering small primary particle diameters thereof.

When an inorganic pigment particle having a primary particle diameter of 20 nm is coated with an equal amount of an organic pigment, a primary particle diameter of the resultant composite pigment is approximately 25 nm. If the above-described composite pigment particles are dispersed to be present as the primary particles using an appropriate dispersant, a composite pigment dispersion ink including very fine dispersed particles each having a diameter of 25 nm can be produced. The organic pigment coating the surface of the inorganic pigment particle contributes to dispersion of the composite pigment, but the characteristics of the inorganic pigment included as a core also appear through the thin organic pigment layer that has a thickness of approximately 2.5 nm. Therefore, it is important to select a pigment dispersant that can stably disperse the composite pigment considering both characteristics of the organic pigment and the inorganic pigment.

When the ink set includes the pre-processing fluid in addition to the white ink and the color ink, moreover, the colorant is preferably anionic as described above, and more preferably an anionic pigment.

As the anionic pigment, there are a surfactant-dispersing pigment where a pigment is dispersed with a surfactant, a resin-dispersing pigment where a pigment is dispersed with a resin, a dispersible resin-coated pigment where a surface of a pigment is coated with a resin, and a self-dispersible pigment where a hydrophilic group is introduced to a surface of a pigment. In any of the above-listed embodiments for dispersion, the anionic pigment is preferably water dispersible.

When the anionic pigment is the dispersible resin-coated pigment or the self-dispersible pigment, the anionic pigment preferably includes at least one hydrophilic group at a surface of a particle of the anionic pigment.

Examples of the hydrophilic group include —COOM, —SO₃M, —PO₃HM, —PO₃M₂, —CONM₂, —SO₃NM₂, —NH—C₆H₄—COOM, —NH—C₆H₄—SO₃M, —NH—C₆H₄—PO₃HM, —NH—C₆H₄—PO₃M₂, —NH—C₆H₄—CONM₂, and —NH—C₆H₄—SO₃NM₂. The above-listed hydrophilic groups can be introduced by any of methods known in the art. “M” in the above-listed hydrophilic groups is a counter ion.

The counter ion represented by M in the hydrophilic group is preferably a quaternary ammonium ion. Specific examples of the quaternary ammonium ion include a tetramethyl ammonium ion, a tetraethyl ammonium ion, a tetrapropyl ammonium ion, a tetrabutyl ammonium ion, a tetrapentyl ammonium ion, a benzyltrimethyl ammonium ion, a benzyltriethyl ammonium ion, and a tetrahexyl ammonium ion. Among the above-listed examples, the quaternary ammonium ion is preferably a tetraethyl ammonium ion, a tetrabutyl ammonium ion, or a benzyltrimethyl ammonium ion, and more preferably a tetrabutyl ammonium ion. The white ink or the color ink using the above-described pigment excels in storage stability over a long period, and prevents increase in viscosity of the ink when the moisture is evaporated from the ink. It is assumed that the dispersed-state of the pigment can be stably maintained with the hydrophilic group including the quaternary ammonium ion even when the moisture is evaporated from the water-rich ink to turn the ink into the organic solvent-rich state.

Other than the colorant having a hydrophilic group at a surface of a particle of the colorant, a polymer emulsion in which a pigment is included in each of polymer particles is preferable as the colorant. The pigment may be encapsulated in each polymer particle, or may be adsorbed on surfaces of the polymer particles. It is not necessary to encapsulate all the particles of the pigment in the polymer particles, or adsorb all the particles of the pigment on the surfaces of the polymer particles, provided that part of the particles of the pigment is dispersed in the emulsion. Examples of the polymer of the polymer particles include a vinyl-based polymer, a polyester-based polymer, and a polyurethane-based polymer. The above-listed examples may be used alone or in combination. Among the above-listed examples, the polymer of the polymer particles is preferably a vinyl-based polymer or a polyester-based polymer.

A mass ratio between the colorant and the organic solvent affects improvement in ejection stability of the ink or reduction in occurrences of adhesion of the waste ink in a maintenance system of an image forming apparatus, thus it is preferable that the mass ratio be appropriately adjusted. When an ink including a large amount of the colorant but a small amount of the organic ink is ejected from an inkjet head, for example, ejection failures may occur as the moisture evaporates from the ink present near the ink meniscus at the ink nozzle.

### —Surfactant—

The white ink and the color ink each preferably include a surfactant as one of measures to minimize color bleeding and beading (i.e., control static surface tension and dynamic surface tension).

As the surfactant, for example, a polyether-modified siloxane compound, an acetylene glycol surfactant, an acetylene alcohol surfactant, or a fluorosurfactant may be used. The above-listed examples may be used alone or in combination. Moreover, a silicone-based surfactant may be used in combination with any of the above-listed surfactants. Since the surfactant is used, the white ink or the color ink does not easily wet an ink repellent film of a nozzle plate of an inkjet head, thus ejection failures, which can be caused by deposition of the white ink or the color ink on the nozzle, can be minimized, leading to improvement in ejection stability of the white ink or the color ink.

The polyether-modified siloxane compound is preferably a compound represented by any of General Formulae (1) to (5) below.

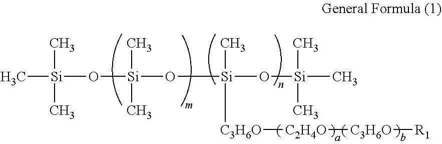

In General Formula (1), R₁ is a hydrogen atom or a C1-C4 alkyl group, m is an integer of 0 through 23, n is an integer of 1 through 10, a is an integer of 1 through 23, and b is an integer of 0 through 23.

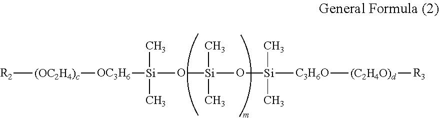

In General Formula (2), R₂ and R₃ are each independently a hydrogen atom or a C1-C4 alkyl group, m is an integer of 1 through 8, ad c and d are each independently an integer of 1 through 10.

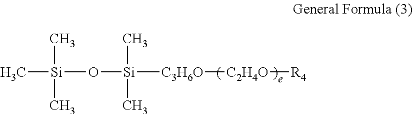

In General Formula (3), R₄ is a hydrogen atom or a C1-C4 alkyl group, and e is an integer of 1 through 8.

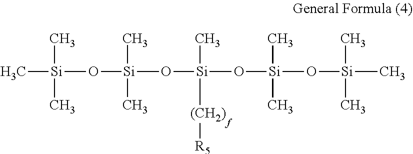

In General Formula (4), R₅ is a polyether group represented by General Formula (5) below, and f is an integer of 1 through 8.

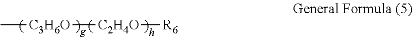

In General Formula (5), R₆ is a hydrogen atom or a C1-C4 alkyl group, g is an integer of 0 through 23, and h is an integer of 0 through 23, provided that g and h are not 0 at the same time.

Specific examples of the compound represented by General Formula (1) include compounds represented by Structural Formulae (1) to (8).

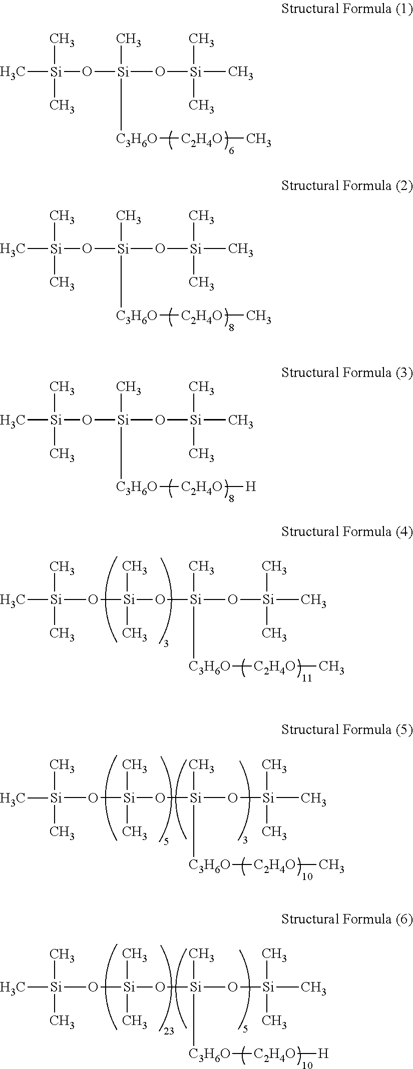

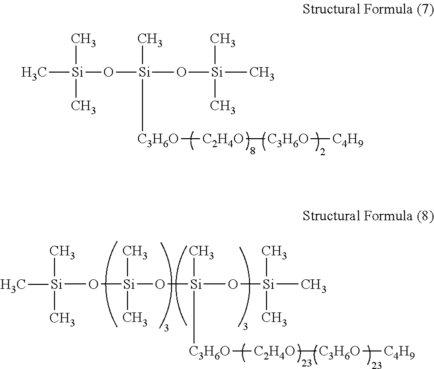

Specific examples of the compound represented by General Formula (2) include a compound represented by Structural Formula (9) below.

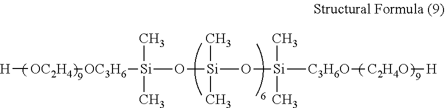

Specific examples of the compound represented by General Formula (3) include a compound represented by Structural Formula (10) below.

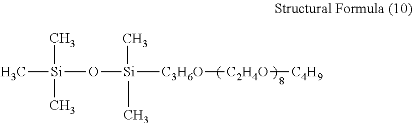

Specific examples of the compound represented by General Formula (4) include compounds represented by Structural Formulae (11) to (13) below.

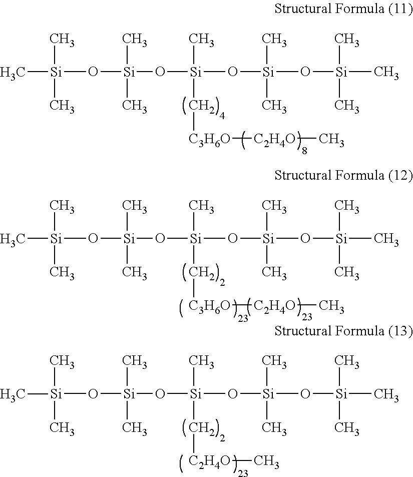

Examples of commercial products of the polyether-modified siloxane compound include DOWSIL 71 Additive, DOWSIL 74 Additive, DOWSIL 57 Additive, DOWSIL 8029 Additive, DOWSIL 8054 Additive, DOWSIL 8019 Additive, DOWSIL 8526 Additive, DOWSIL FZ-2123, and DOWSIL FZ-2191 (all available from DuPont Toray Specialty Materials K.K.); TSF4440, TSF4445, TSF4446, TSF4450, TSF4452, and TSF4460 (all available from Momentive Performance Materials); SILFACE (registered trademark) SAG002, SILFACE (registered trademark) SAG003, SILFACE (registered trademark) SAG005, SILFACE (registered trademark) SAG53A, SILFACE (registered trademark) SAG008, and SILFACE (registered trademark) SJM003 (all available from Nissin Chemical Co., Ltd.); TEGO (registered trademark) WetKL245, TEGO (registered trademark) Wet250, TEGO (registered trademark) Wet260, TEGO (registered trademark) Wet265, TEGO (registered trademark) Wet270, and TEGO (registered trademark) Wet280 (all available from EVONIK JAPAN CO., LTD.); and BYK-345, BYK-347, BYK-348, BYK-375, and BYK-377 (all available from BYK JAPAN K.K.).

Moreover, commercial products may be used as the acetylene glycol surfactant and the acetylene alcohol surfactant. Examples of the commercial products include SURFYNOL 104E, SURFYNOL 420, SURFYNOL 440, SURFYNOL 465, SURFYNOL SE, SURFYNOL SE-F, SURFYNOL PSA-336, SURFYNOL DF110D, SURFYNOL DF58, OLFINE E1004, OLFINE E1010, OLFINE E1020, OLFINE PD-001, OLFINE PD-002W, OLFINE PD-004, OLFINE PD-005, OLFINE EXP. 4001, OLFINE EXP. 4200, OLFINE EXP. 4123, and OLFINE EXP. 4300 (all available from Nissin Chemical Co., Ltd.).

The fluorosurfactant is not particularly limited, and may be appropriately selected in accordance with the intended purpose. As the fluorosurfactant, a perfluoroalkyl sulfonic acid compound, a perfluoroalkyl carboxylic acid compound, a perfluoroalkyl phosphoric acid ester compound, a perfluoroalkyl ethylene oxide adduct, and a polyoxyalkylene ether polymer compound having a perfluoroalkyl ether group in a side chain thereof are preferable because of low foamability.

Examples of the perfluoroalkyl sulfonic acid compound include perfluoroalkyl sulfonic acid, and perfluoroalkyl sulfonic acid salt.

Examples of the perfluoroalkyl carboxylic acid compound include perfluoroalkyl carboxylic acid, and perfluoroalkyl carboxylic acid salt.

Examples of the polyoxyalkylene ether polymer compound having a perfluoroalkyl ether group in a side chain thereof include sulfuric acid ester salt of a polyoxyalkylene ether polymer having a perfluoroalkyl ether group in a side chain thereof, and a salt of a polyoxyalkylene ether polymer having a perfluoroalkyl ether group in a side chain thereof.

The counter ion of the above-mentioned salt used as the fluorosurfactant is not particularly limited, and may be appropriately selected in accordance with the intended purpose. Examples of the counter ion include Li, Na, K, NH₄, NH₃CH₂CH₂OH, NH₂ (CH₂CH₂OH)₂, and NH(CH₂CH₂OH)₃.

An amount of the surfactant in the white ink or the color ink is not particularly limited, and may be appropriately selected in accordance with the intended purpose. The amount of the surfactant relative to a total mass of the white ink or the color ink is preferably 0.001% by mass or greater and 5.0% by mass or less, and more preferably 0.01% by mass or greater and 3.0% by mass or less. When the amount of the surfactant is 0.001% by mass or greater, effects obtainable by adding the surfactant may not be displayed. When the amount of the surfactant is greater than 5.0% by mass, the effects obtainable by adding the surfactant may be saturated.

### —Other Components—

As other components in the white ink or the color ink, various additives known in the art may be optionally used. Examples of the additives include a foaming inhibitor (or a defoaming agent), a pH regulator, a preservative or fungicide, a chelate reagent, a corrosion inhibitor, an antioxidant, a UV absorber, an oxygen absorber, a photo stabilizer, and resins other than the water-dispersible resin particles. The above-listed examples may be used alone or in combination.

### —Foaming Inhibitor (Defoaming Agent)—

A small amount of the foaming inhibitor is added to the white ink or the color ink to inhibit generation of air bubbles in the white ink or the color ink.

In the present specification, the term “foaming” or the phrase “generation of air bubbles” means that a liquid forms a thin film to encapsulate air with the film. Properties of the white ink or the color ink, such as surface tension and viscosity, affect generation of air bubbles. Specifically, a liquid having high surface tension, such as water, does not foam easily because a force keeping a surface area of the liquid as small as possible applies to the liquid. Conversely, a highly viscous and highly permeable ink easily foams, because the ink has low surface tension, and the generated air bubbles tend to be sustained without being easily broken due to the high viscosity of the solution.

Typically, the foaming inhibitor partially reduces the surface tension of a foam membrane to break a foam. Alternatively, the foaming inhibitor that is insoluble to a foaming liquid is scattered on the surface of the foaming liquid to break foam. When the polyester-modified siloxane compound, which has a significant effect of reducing surface tension, is used as a surfactant in the ink, the foaming inhibitor of the former system cannot partially reduce the surface tension of a foam membrane. Therefore, the latter forming inhibitor that is insoluble to the foaming liquid is preferably used. In this case, however, the foaming inhibitor insoluble to the foaming liquid may make the ink unstable.

Meanwhile, the foaming inhibitor including a compound represented by General Formula (6) below does not have a significant effect of reducing surface tension comparable to the polyether-modified siloxane compound, but has high affinity to the polyether-modified siloxane compound. Therefore, the foaming inhibitor is efficiently taken into the foam membrane to make the surface of the foam membrane partially imbalance due to a difference in surface tension between the polyether-modified siloxane compound and the foaming inhibitor to break the foam.

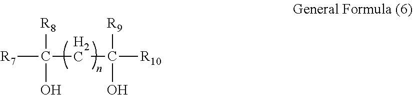

In General Formula (6), R₇ and R₈ are each independently a C3-C6 alkyl group, R₉ and R₁₀ are each independently a C1-C2 alkyl group, and n is an integer of 1 through 6.

Examples of the compound represented by General Formula (6) include 2,4,7,9-tetramethyldecane-4,7-diol, and 2,5,8,11-tetramethyldodecane-5,8-diol. Among the above-listed examples, the compound represented by General Formula (6) is preferably 2,5,8,11-tetramethyldodecane-5,8-diol considering a high foaming inhibition effect and high compatibility with the ink.

An amount of the foaming inhibitor in the white ink or the color ink is not particularly limited, and may be appropriately selected in accordance with the intended purpose. The amount of the foaming inhibitor relative to a total mass of the white ink or the color ink is preferably 0.01% by mass or greater and 10.0% by mass or less, and more preferably 0.1% by mass or greater and 5.0% by mass or less. When the amount of the foaming inhibitor is 0.01% by mass or greater, a foaming inhibition effect is obtained. When the amount of the foaming inhibitor is 10% by mass or less, the foaming inhibitor does not adversely affect physical properties of the ink, such as viscosity and particle diameters.

### —pH Regulator—

The pH regulator is not particularly limited, provided that the pH regulator can adjust the pH of the white ink or the color ink. The pH regulator may be appropriately selected in accordance with the intended purpose. Examples of the pH regulator include alcohol amines, hydroxides of alkali metal elements, hydroxides of ammonium, phosphonium hydroxides, and carbonates of alkali metal elements. The above-listed examples may be used alone or in combination. Among the above-listed examples, the pH regulator is preferably selected from the alcohol amines.

Examples of the alcohol amines include diethanolamine, triethanolamine, and 2-amino-2-ethyl-1,3-propanediol.

Examples of the hydroxides of alkali metal elements include lithium hydroxide, sodium hydroxide, and potassium hydroxide.

Examples of the hydroxides of ammonium include ammonium hydroxide, and quaternary ammonium hydroxide.

Examples of the phosphonium hydroxide include quaternary phosphonium hydroxide.

Examples of the carbonates of alkali metal elements include lithium carbonate, sodium carbonate, and potassium carbonate.

An amount of the pH regulator in the white ink or the color ink is not particularly limited, provided that the pH of the white ink or the color ink can be adjusted to a desired value. The pH regulator may be appropriately selected in accordance with the intended purpose.

The pH of the white ink or the color ink is preferably from 7 through 11 considering improvement in ejection stability of the ink.

### —Preservative or Fungicide—

The preservative or fungicide is not particularly limited, and may be appropriately selected in accordance with the intended purpose. Examples of the preservative or fungicide include 1,2-benzothiazolin-3-one, sodium dehydroacetate, sodium sorbate, sodium-2-pyridinethiol-1-oxide, sodium benzoate, and sodium pentachlorophenol. The above-listed examples may be used alone or in combination.

An amount of the preservative or fungicide in the white ink or the color ink is not particularly limited, provided that the effects obtainable by the present disclosure are not adversely affected. The amount of the preservative or fungicide may be appropriately selected in accordance with the intended purpose.

### —Chelating Reagent—

The chelating reagent is not particularly limited, and may be appropriately selected in accordance with the intended purpose. Examples of the chelating reagent include disodium ethylenediamine tetraacetate, sodium nitrilotriacetate, trisodium hydroxyethylethylenediamine triacetate, sodium diethylenetriamine pentaacetate, and sodium uramil diacetate. The above-listed examples may be used alone or in combination.

An amount of the chelating reagent is not particularly limited, provided that the effects obtainable by the present disclosure are not adversely affected. The amount of the chelating reagent may be appropriately selected in accordance with the intended purpose.

### —Corrosion Inhibitor—

The corrosion inhibitor is not particularly limited, and may be appropriately selected in accordance with the intended purpose. Examples of the corrosion inhibitor include acidic sulfite, sodium thiosulfate, antimony thiodiglycollate, diisopropylammonium nitrite, pentaerythritol tetranitrate, and dicyclohexylammonium nitrite. The above-listed examples may be used alone or in combination.

An amount of the corrosion inhibitor in the white ink or the color ink is not particularly limited, provided that the effects obtainable by the present disclosure are not adversely affected. The amount of the corrosion inhibitor may be appropriately selected in accordance with the intended purpose.

### —Antioxidant—

The antioxidant is not particularly limited, and may be appropriately selected in accordance with the intended purpose. Examples of the antioxidant include a phenol-based antioxidant, an amine-based antioxidant, a sulfur-based antioxidant, and a phosphorus-based antioxidant. The phenol-based antioxidant includes a hindered phenol-based antioxidant. The above-listed examples may be used alone or in combination.

An amount of the antioxidant in the white ink or the color ink is not particularly limited, provided that the effects obtainable by the present disclosure are not adversely affected. The amount of the antioxidant may be appropriately selected in accordance with the intended purpose.

### —UV Absorber—

The UV absorber is not particularly limited, and may be appropriately selected in accordance with the intended purpose. Examples of the UV absorber include a benzophenone-based UV absorber, benzotriazole-based UV absorber, a salicylate-based UV absorber, cyanoacrylate-based UV absorber, and a nickel complex salt-based UV absorber. The above-listed examples may be used alone or in combination.

An amount of the UV absorber in the white ink or the color ink is not particularly limited, provided that the effects obtainable by the present disclosure are not adversely affected. The amount of the UV absorber may be appropriately selected in accordance with the intended purpose.

### —Other Resins—

Other resins are not particularly limited, provided that the effects obtainable by the present disclosure are not adversely affected. Other resins may be appropriately selected in accordance with the intended purpose. Resin having excellent film formability, solvent resistance, water resistance, and weather resistance are effective for image formation. Examples of the resins include a condensation-type synthetic resin, an addition-type synthetic resin, and a natural polymer compound. The above-listed examples may be used alone or in combination.

Examples of the condensation-type synthetic resin include a polyester resin, a polyepoxy resin, a polyamide resin, a polyether resin, a poly(meth)acryl resin, an acryl-silicone resin, and a fluororesin.

In the present disclosure, the term “(meth)acryl” means acryl or methacryl.

Examples of the addition-type synthetic resin include a polyolefin resin, a polystyrene-based resin, a polyvinyl alcohol-based resin, a polyvinyl ester-based resin, a polyacrylic acid-based resin, and an unsaturated carboxylic acid-based resin.

Examples of the natural polymer compound include celluloses, rosins, and natural rubber.

An amount of the above-mentioned other resins in the white ink or the color ink is not particularly limited, provided that the effects obtainable by the present invention are not adversely affected. The amount of the above-mentioned other resins may be appropriately selected in accordance with the intended purpose.

### <<Physical Properties of White Ink or Color Ink>>

The physical properties of the white ink or the color ink are not particularly limited, provided that the absolute value of the difference in the static surface tension between the white ink and the color ink at 25° C. is 1.0 mN/m or less, and the absolute value of the difference in the dynamic surface tension between the white ink and the color ink at 25° C. with a bubble lifetime of 15 msec, the absolute value of the difference in the dynamic surface tension between the white ink and the color ink at 25° C. with a bubble lifetime of 150 msec, and the absolute value of the difference in the dynamic surface tension between the white ink and the color ink at 25° C. with a bubble lifetime of 1,500 msec are each independently 1.0 mN/m or less, where the bubble lifetime is a bubble lifetime measured according to the maximum bubble pressure method. The physical properties of the white ink or the color ink may be appropriately selected in accordance with the intended purpose.

For example, viscosity of the white ink or the color ink at 25° C. is preferably 5 mPa·s or greater and 25 mPa·s or less, and more preferably 6 mPa·s or greater and 20 mPa·s or less. When the viscosity of the white ink or the color ink at 25° C. is 5 mPa·s or greater, image density improves, and quality of printed letters improves. When the viscosity of the white ink or the color ink at 25° C. is 25 mPa·s or less, an ejection performance of the ink improves.

The viscosity of the white ink or the color ink can be measured, for example, by means of a viscometer (RE-85L, available from Toki Sangyo Co., Ltd.) at 25° C.

### <<Production Method of White Ink or Color Ink>>

The white ink or the color ink can be produced as a mixture by performing a stirring and mixing step. The stirring and mixing step is a step including stirring various materials to mix the materials to produce a mixture.

The stirring and mixing in the stirring and mixing step can be performed, for example, by means of a device, such as a sand mill, a homogenizer, a ball mill, a paint shaker, and an ultrasonic wave disperser.

### <Pre-Processing Fluid>

The pre-processing fluid includes water and a flocculant, and preferably further includes resin particles, wax particles, an organic solvent, and a surfactant. The pre-processing fluid may further include other components according to the necessity.

### —Water—

As the water, for example, pure water (e.g., ion-exchanged water, ultrafiltered water, reverse osmosis water, distilled water) or ultrapure water may be used.

An amount of the water in the pre-processing fluid is not particularly limited, and may be appropriately selected in accordance with the intended purpose. Considering drying speed of the pre-processing fluid, the amount of water relative to a total mass of the pre-processing fluid is preferably 10.0% by mass or greater and 90.0% by mass or less, and more preferably 20.0% by mass or greater and 60.0% by mass or less.

### —Flocculant—

In the present specification, the “flocculant” is a component that causes aggregation in the white ink or the color ink, or thickens the white ink or the color ink when the pre-processing fluid comes into contact with the white ink or the color ink. Specific examples of the flocculant include components that can aggregate the colorant or the water dispersible resin particles (e.g., the anionic compound) included in the white ink or the color ink. Since the pre-processing fluid including the above-described flocculant is used, aggregation or thickening is caused in or with the white ink or the color ink brought into contact with the pre-processing fluid to retain the white ink or the color ink on a surface of a recording medium.

The flocculant is not particularly limited, and may be appropriately selected in accordance with the intended purpose. Examples of the flocculant include cationic compounds. The above-listed examples may be used alone or in combination. Among the above-listed examples, the flocculant is preferably at least one selected from the group consisting of an inorganic metal salt, an organic acid metal salt, an organic acid ammonium salt, and a cationic polymer, and more preferably at least one selected from the group consisting of an inorganic metal salt and a cationic polymer.

Examples of the inorganic metal salt include magnesium sulfate, aluminium sulfate, manganese sulfate, nickel sulfate, iron(II) sulfate, copper(II) sulfate, zinc sulfate, iron(II) nitrate, iron(III) nitrate, cobalt nitrate, strontium nitrate, copper(II) nitrate, nickel(II) nitrate, lead(II) nitrate, manganese(II) nitrate, nickel(II) chloride, calcium chloride, tin(II) chloride, strontium chloride, barium chloride, magnesium chloride, sodium sulfate, potassium sulfate, lithium sulfate, sodium hydrogen sulfate, potassium hydrogen sulfate, sodium nitrate, potassium nitrate, sodium carbonate, potassium carbonate, sodium hydrogen carbonate, potassium hydrogen carbonate, sodium chloride, and potassium chloride. Among the above-listed examples, the inorganic metal salt is preferably magnesium sulfate or potassium chloride.

Examples of the organic acid metal salt include sodium L-aspartate, magnesium L-aspartate, calcium ascorbate, sodium L-ascorbate, sodium succinate, disodium succinate, aluminium citrate, potassium citrate, calcium citrate, tripotassium citrate, trisodium citrate, disodium citrate, zinc lactate, aluminium lactate, potassium lactate, calcium lactate, sodium lactate, magnesium lactate, calcium acetate, potassium tartrate, calcium tartrate, sodium DL-tartrate, and potassium sodium tartrate.

The inorganic metal salt and the organic acid metal salt are each preferably at least one selected from the group consisting of a calcium salt, a magnesium salt, a nickel salt, and an aluminium salt. When the above-listed metal salts are selected for use, the effect of aggregating the water-dispersible particles included in the white ink or the color ink improves to reduce color bleeding and beading. Moreover, the above-listed salts are preferable considering storage stability of the pre-processing fluid.

Examples of the organic acid ammonium salt include ammonium acetate, ammonium propionate, ammonium lactate, ammonium oxalate, ammonium tartrate, ammonium succinate (diammonium succinate), diammonium malonate, diammonium hydrogen citrate, triammonium citrate, and ammonium L-glutamate.

The cationic polymer is preferably a quaternary ammonium salt-based cationic polymer compound. Specific examples of the quaternary ammonium salt-based cationic polymer compound include a dialkyl allyl ammonium chloride polymer, a dialkylaminoethyl (meth)acrylate quaternary ammonium salt polymer, a modified polyvinyl alcohol dialkyl ammonium salt polymer, a dialkyl diallyl ammonium salt polymer.

In the present disclosure, the term “(meth)acrylate” means acrylate or methacrylate.

Moreover, examples of other cationic polymers include cationic modified-polyamine compound, a cationic polyamide polyamine compound, a cationic urea-formalin resin compound, a cationic polyacrylamide compound, a cationic alkyl ketene dimer, a cationic dicyan diamide compound, a cationic dicyan diamide-formalin condensation compound, a cationic dicyan diamide-polyamine condensation compound, a cationic polyvinyl formamide compound, a cationic polyvinyl pyridine compound, a cationic polyalkylene polyamine compound, and an anionic epoxy polyamide compound.

Examples of the particularly preferable cationic polymer include compounds represented by General Formulae (7) to (10).

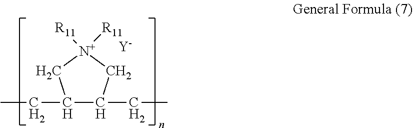

In General Formula (7), each R₁₁ is independently a methyl group or an ethyl group, Y⁻ is a halogen ion, and n is an integer.

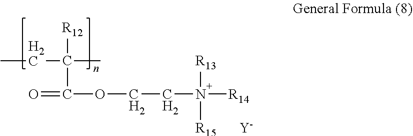

In General Formula (8), Y⁻ is a halogen ion, a nitric acid ion, a nitrous acid ion, or an acetic acid ion, R₁₂ is H or CH₃, R₁₃, R₁₄, and R₁₅ are each independently H or an alkyl group, and n is an integer.

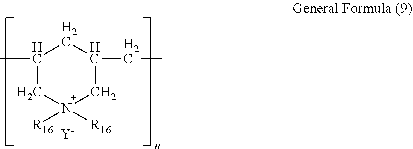

In General Formula (9), a plurality of R₁₆ is each independently a methyl group or an ethyl group, Y⁻ is a halogen ion, a nitric acid ion, a nitrous acid ion, or an acetic acid ion, and n is an integer.

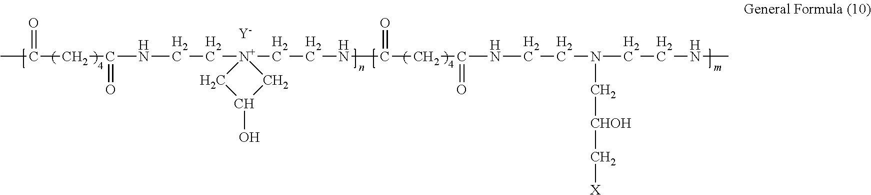

In General Formula (10), Y⁻ is a halogen ion, a nitric acid ion, a nitrous acid ion, or an acetic acid ion, X is a halogen atom, n is an integer of from 1 through 3, and m is an integer of from 1 through 3.

An amount of the flocculant in the pre-processing fluid is not particularly limited, and may be appropriately selected in accordance with the intended purpose. Considering solubility of the flocculant and reduction in color bleeding and beading, the amount of the flocculant relative to a total mass of the pre-processing fluid is preferably 0.1% by mass or greater and 30.0% by mass or less, and more preferably 1.0% by mass or greater and 20.0% by mass or less.

### —Resin Particles—

The pre-processing fluid preferably includes resin particles. Since the pre-processing fluid includes the resin particles, adhesion of the white ink and the color ink to a recording medium improves.

Since the resin particles are present together with the flocculant, which is a cationic compound, in the pre-processing fluid, the resin particles are preferably nonionic resin particles that can be dispersed owing to steric hindrance, not a typically used charge-repulsion emulsion, considering storage stability of the pre-processing fluid over a long period. When anionic resin particles, which are a charge-repulsion emulsion, are used, the resin particles aggregate if the resin particles are present together with an inorganic metal salt that is one example of the flocculant. Especially when the anionic resin particles are present together with a multivalent metal salt that generates trivalent cations through dissociation, the anionic resin particles aggregate as soon as the anionic resin particles come into contact with the multivalent metal salt. In the case that the cationic resin particles are used, moreover, the pre-processing fluid is adequately stable when the pre-processing fluid is left to stand at room temperature, but the pre-processing fluid thickens when the pre-processing fluid is left to stand with heating according to an acceleration test to confirm stability over a long period. For the reasons as described, the resin particles are preferably the nonionic resin particles as described above.

A method for confirming that the resin particles are the nonionic resin particles is not particularly limited. Examples of the method include a method where solids are separated from the pre-processing fluid by centrifugation, and the separated solids are analyzed by Pyrolysis-GC-MS (e.g., GC-17A, available from Shimadzu Corporation) to conform that a material including an acidic functional group (e.g., a carboxyl group and a sulfo group) or a basic functional group (e.g., an amino group) is not detected.

The nonionic resin particles are not particularly limited, and may be appropriately selected in accordance with the intended purpose. As the nonionic resin particles, for example, a polyolefin resin, a chlorinated polyolefin resin, a polyvinyl acetate resin, a polyvinyl chloride resin, a polyester resin, a polyurethane resin, an acrylic resin, a styrene butadiene resin, or a copolymer of a polymerizable compound used for polymerization of any of the foregoing resins may be used. The above-listed examples may be used alone or in combination. Among the above-listed examples, the nonionic resin particles are preferably ethylene-vinyl acetate copolymer resin particles, ethylene-vinyl acetate-vinyl chloride copolymer resin particles, ethylene-vinyl acetate-vinyl versatate copolymer particles, or chlorinated olefin resin particles. The above-listed resin particles can improve adhesion of the white ink and the color ink to a recording medium.

A glass transition temperature (Tg) of the nonionic resin particles is not particularly limited, and may be appropriately selected in accordance with the intended purpose. The glass transition temperature (Tg) of the nonionic resin particles is preferably −30° C. or higher and 30° C. or lower, and more preferably −25° C. or higher and 25° C. or lower. When the glass transition temperature (Tg) of the nonionic resin particles is −30° C. or higher, a resin coating film as formed is strong thus the film formed with the pre-processing fluid becomes robust. When the glass transition temperature (Tg) of the nonionic resin particles is 30° C. or less, the film formability of the resin improves and flexibility is secured, thus adhesion of the white ink and the color ink to a recording medium improves.

The volume average particle diameter of the nonionic resin particles is not particularly limited, and may be appropriately selected in accordance with the intended purpose. The volume average particle diameter of the nonionic resin particles is preferably 0.05 μm or greater and 2.0 μm or less, and more preferably 0.1 μm or greater and 1.0 μm or less.

For example, the volume average particle diameter of the nonionic resin particles can be measured by a particle size analyzer (Nanotrac Wave II-UT151, available from Microtrac MRB).

An amount (i.e., a solid amount) of the resin particles in the pre-processing fluid is not particularly limited, and may be appropriately selected in accordance with the intended purpose. The amount (i.e., the solid amount) of the resin particles relative to a total mass of the pre-processing fluid is preferably 0.5% by mass or greater and 20.0% by mass or less. When the amount (i.e., the solid amount) of the resin particles is 0.5% by mass or greater and 20.0% by mass or less, adhesion of the white ink and the color ink to a recording medium improves.

### —Wax Particles—

The wax particles are not particularly limited, and may be appropriately selected in accordance with the intended purpose. For example, water-dispersible wax particles may be used. Specific examples of the wax particles include particles of vegetable or animal wax, such as carnauba wax, Candelilla wax, bees wax, rice wax, and lanolin wax; particles of petroleum wax, such as paraffin wax, microcrystalline wax, polyethylene wax, polypropylene wax, oxidized polyethylene wax, and petrolatum; particles of mineral wax, such as montan wax and ozocerite; and particles of synthetic wax, such as carbon wax, Hoechst wax, polyethylene wax, and stearic acid amide. The above-listed examples may be used alone or in combination. Among the above-listed examples, the wax particles are preferably paraffin wax particles or polyethylene wax particles, and more preferably paraffin wax considering improvement in adhesion of the white ink and the color ink to a recording medium, and dispersibility of the wax particles in the pre-processing fluid.

A melting point of the wax particles is not particularly limited, and may be appropriately selected in accordance with the intended purpose. The melting point of the wax particles is preferably 50° C. or higher and 130° C. or lower, and more preferably 60° C. or higher and 120° C. or lower. When the melting point of the wax particles is 50° C. or higher and 130° C. or lower, adhesion of the white ink and the color ink to a recording medium improves.

The volume average particle diameter of the wax particles is not particularly limited, and may be appropriately selected in accordance with the intended purpose. The volume average particle diameter of the wax particles is preferably 1 μm or greater and 20 μm or less, and more preferably 1 μm or greater and 5 μm or less.

For example, the volume average particle diameter of the wax particles can be measured by a particle size analyzer (Nanotrac Wave II-UT151, Microtrac MRB).

An amount (i.e. a solid amount) of the wax particles in the pre-processing fluid is not particularly limited, and may be appropriately selected in accordance with the intended purpose. The amount of the wax particles relative to a total mass of the pre-processing fluid is preferably 0.05% by mass or greater and 5.0% by mass or less, and more preferably 0.1% by mass or greater and 3.0% by mass or less. When the amount (i.e., the solid amount) of the wax particles is 0.05% by mass or greater and 5.0% by mass or less, the white ink can be retained adjacent to a surface of a recording medium to improve the Hunter whiteness. When a white ink layer is formed after applying the pre-processing fluid including wax particles, and image formation is performed with a color ink layer on the white ink layer, however, color bleeding may more easily occur compared to the case where the pre-processing fluid free from wax particles is used.

### —Organic Solvent—

The organic solvent is not particularly limited, and may be appropriately selected in accordance with the intended purpose. For example, a water-soluble organic solvent may be used as the organic solvent. Examples of the water-soluble organic solvent include multivalent alcohols, ethers (e.g., multivalent alcohol alkyl ethers, and multivalent alcohol aryl ethers), nitrogen-containing heterocyclic compounds, amides, amines, and sulfur-containing compounds. The above-listed examples may be used alone or in combination.

Specific examples of the water-soluble organic solvent include multivalent alcohols, such as ethylene glycol, propylene glycol, diethylene glycol, 1,3-propanediol, 1,2-butanediol, 1,3-butanediol, 1,4-butanediol, 2,3-butanediol, 3-methyl-1,3-butanediol, triethylene glycol, polyethylene glycol, polypropylene glycol, 1,2-pentanediol, 1,3-pentanediol, 1,4-pentanediol, 2,4-pentanediol, 1,5-pentanediol, 1,2-hexanediol, 1,6-hexanediol, 1,3-hexanediol, 2,5-hexanediol, 1,5-hexanediol, glycerin, 1,2,6-hexanetriol, 2-ethyl-1,3-hexanediol, ethyl-1,2,4-butanetriol, 1,2,3-butanetriol, 2,2,4-trimethyl-1,3-pentanediol, and 3-methylpentane-1,3,5-triol; multivalent alcohol alkyl ethers, such as ethylene glycol monoethyl ether, ethylene glycol monobutyl ether, diethylene glycol monomethyl ether, diethylene glycol monoethyl ether, diethylene glycol monobutyl ether, tetraethylene glycol monomethyl ether, and propylene glycol monoethyl ether; multivalent alcohol aryl ethers, such as ethylene glycol monophenyl ether, and ethylene glycol monobenzyl ether; nitrogen-containing heterocyclic compounds, such as 2-pyrrolidone, N-methyl-2-pyrrolidone, N-hydroxyethyl-2-pyrrolidone, 1,3-dimethyl-2-imidazolidinone, ε-caprolactam, and γ-butyrolactone; amides, such as formamide, N-methylformamide, N,N-dimethylformamide, 3-methoxy-N,N-dimethylpropionamide, and 3-butoxy-N,N-dimethylpropionamide; amines, such as monoethanolamine, diethanolamine, and triethylamine; sulfur-containing compounds, such as dimethyl sulfoxide, sulfolane, and thiodiethanol; propylene carbonate; and ethylene carbonate.

The organic solvent is preferably an organic solvent having a boiling point of 250° C. or lower because the organic solvent facilitates drying of the pre-processing liquid, as well as functioning as a wetting agent.

The pre-processing liquid including at least one selected from the group consisting of propylene glycol, 1,3-butanediol, and 1,2-butanediol as the organic solvent is preferable because the pre-processing liquid easily wets a surface of a recording medium.

An amount of the organic solvent in the pre-processing fluid is not particularly limited, and may be appropriately selected in accordance with the intended purpose. Considering drying speed and ejection reliability of the pre-processing fluid, the amount of the organic solvent relative to a total mass of the pre-processing fluid is preferably 5.0% by mass or greater and 60.0% by mass or less, and more preferably 10.0% by mass or greater and 30.0% by mass or less.

### —Surfactant—

The surfactant is not particularly limited, and may be appropriately selected in accordance with the intended purpose. As the surfactant, a silicone-based surfactant, a fluorosurfactant, an amphoteric surfactant, a nonionic surfactant, or an anionic surfactant may be used. The above-listed examples may be used alone or in combination.

The silicone-based surfactant is not particularly limited, and may be appropriately selected in accordance with the intended purpose. The silicone-based surfactant is preferably a silicone-based surfactant that is not decomposed at high pH. Examples of the silicone-based surfactant include side chain-modified polydimethylsiloxane, both terminal-modified polydimethylsiloxane, one terminal-modified polydimethylsiloxane, and side chain and both terminal-modified polydimethylsiloxane. Among the above-listed examples, the silicone-based surfactant is particularly preferably a silicone-based surfactant including, as a modifying group, a polyoxyethylene group, or a polyoxyethylene polyoxypropylene group because excellent properties as a water-based surfactant are obtained. Moreover, a polyether-modified silicone-based surfactant may be used as the silicon-based surfactant. Examples of the polyether-modified silicone-based surfactant include a compound where a polyalkylene oxide structure is introduced into a side chain of the Si site of dimethylsiloxane.

The fluorosurfactant is not particularly limited, and may be appropriately selected in accordance with the intended purpose. As the fluorosurfactant, the same fluorosurfactant that can be included in the white ink or the color ink may be used. Preferable embodiments of the fluorosurfactant are also the same as the preferable embodiments of the fluorosurfactant for the white ink or the color ink.

The amphoteric surfactant is not particularly limited, and may be appropriately selected in accordance with the intended purpose. Examples of the amphoteric surfactant include laurylaminopropionic acid salt, lauryl dimethyl betaine, stearyl dimethyl betaine, and lauryl dihydroxyethyl betaine.

The nonionic surfactant is not particularly limited, and may be appropriately selected in accordance with the intended purpose. Examples of the nonionic surfactant include polyoxyethylene alkylphenyl ether, polyoxyethylene alkyl ester, polyoxyethylene alkyl amine, polyoxyethylene alkyl amide, a polyoxyethylene propylene block polymer, sorbitan fatty acid ester, polyoxyethylene sorbitan fatty acid ester, and ethylene oxide adducts of acetylene alcohol.

The anionic surfactant is not particularly limited, and may be appropriately selected in accordance with the intended purpose. Examples of the anionic surfactant include a polyoxyethylene alkyl ether acetic acid salt, dodecylbenzenesulfonic acid salt, a lauric acid salt, and a salt of polyoxyethylene alkyl ether sulfate.

### —Other Components—

Other components are not particularly limited, provided that the effects obtainable by the present disclosure are not adversely affected. The above-mentioned other components may be appropriately selected in accordance with the intended purpose. Examples of the above-mentioned other components include a defoaming agent, a preservative or fungicide, and a corrosion inhibitor.

### —Defoaming Agent—

The defoaming agent is not particularly limited, and may be appropriately selected in accordance with the intended purpose. Examples of the defoaming agent include a silicone-based defoaming agent, a polyester-based defoaming agent, and a fatty acid ester-based defoaming agent. Moreover, the defoaming agent identical to the defoaming agent (or the foaming inhibitor) in the white ink or the color ink may be used. The above-listed examples may be used alone or in combination. Among the above-listed examples, the defoaming agent is preferably a silicone-based defoaming agent because the silicone-based defoaming agent has a high defoaming effect.

### —Preservative or Fungicide and Corrosion Inhibitor—

The preservative or fungicide is not particularly limited, and may be appropriately selected in accordance with the intended purpose. For example, the same preservative or fungicide to the preservative or fungicide in the white ink or the color ink may be used.

The corrosion inhibitor is not particularly limited, and may be appropriately selected in accordance with the intended purpose. For example, the same corrosion inhibitor to the corrosion inhibitor in the white ink or the color ink may be used.

### <Recording Medium>

A recording medium, to which the white ink, the color ink, and the pre-processing fluid are applied, is not particularly limited, and may be appropriately selected in accordance with the intended purpose. Examples of the recording medium include plain paper, gloss paper, special paper, fabric, a film, a transparent plastic sheet for overhead projectors (OHP), and a general-purpose printing sheet. Among the above-listed examples, low-permeable recording media for signs and displays, and fabric are preferable because such recording media typically tend to cause color bleeding and beading, and effects obtainable by using in combination with the ink set become significant. The fabric is recording media that tend to cause color bleeding and beading, because the fabric has a surface structure having many projections and recesses unlike films or paper, leading to a large amount of the white ink or the color ink to be applied.

Fabric will be described as an example of the recording medium. In the present specification, the term “fabric” means fiber filaments that are woven into woven fabric, knitted fabric, nonwoven fabric, etc.

The fiber filaments are preferably organic fiber filaments, such as synthetic fiber filaments, semi-synthetic fiber filaments, regenerated fiber filaments, and natural fiber filaments.

Examples of the synthetic fiber filaments include fiber filaments of polyester, polyamide, acryl, polyolefin, polyvinyl alcohol, polyvinyl chloride, polyurethane, and polyimide.

Examples of the semi-synthetic fiber filaments include fiber filaments of acetate, diacetate, and triacetate.

Examples of the regenerated fiber filaments include fiber filaments of polynosic, rayon, Lyocell, and cupra.

Examples of the natural fiber filaments include fiber filaments of cotton, hemp, silk, and animal hairs.

Among the fiber filaments for forming the fabric, synthetic fiber filaments, such as polyester, tend to cause color bleeding and beading compared to natural fiber filaments, such as cotton, and it is also difficult to retain the white ink on a surface of fabric formed with such synthetic fiber filaments. However, the ink set satisfactorily functions on such fabric to minimize color bleeding and beading, and the white ink can be retained on the surface of the fabric. Therefore, use of the ink set with the fabric formed with synthetic fiber filaments is advantageous.

The fabric is preferably fabric where a colorant, such as a pigment and a dye, is chemically or physically held inside or on surfaces of fiber filaments constituting the fabric to color the dark color fabric. When the fabric is in dark color, a white base is formed between the fabric and a color image for improving coloring of the color image formed on the fabric. For this reason, the ink set including the white ink and the color ink is suitably used with the dark color fabric.

In the present specification, the “dark color fabric” means fabric having the L* value in the range of 60>L*, as lightness (L*) of the fabric is measured by a spectrophotometer (e.g., X-Rite eXact, available from X-Rite), preferably fabric having the L* value in the range of 50>L*, more preferably fabric having the L* value in the range of 40>L*, even more preferably fabric having the L* value in the range of 30>L*, and particularly preferably fabric having the L* value in the range of 20>L*.

### (Ink Cartridge)

The ink cartridge of the present disclosure stores the ink set of the present disclosure therein. The ink cartridge includes the ink set and a container, and may further include other members according to the necessity.

Use of the ink cartridge is advantageous because direct contact with the ink can be avoided during handling, such as replacement of the ink, the ink does not deposit on hands and fingers, or clothes of the handler, and contamination of the ink with foreign matter, such as dust, can be minimized.

The ink cartridge may accommodate the ink set as a single unit. Alternatively, the white ink and the color ink may be independently accommodated in separately cartridges. When the ink set includes a plurality of the white inks and/or a plurality of the color inks, the ink cartridge may accommodate a set of the white ink(s) and the color ink(s) as a single unit, or the white inks and the color inks are each independently accommodated in separate ink cartridges.

The container is not particularly limited. A shape, structure, size, material, etc. of the container are appropriately selected in accordance with the intended purpose. For example, the container is preferably a container including an ink bag formed with an aluminium laminate film, or a resin film.

A production method of the ink cartridge is not particularly limited. The ink cartridge can be appropriately produced according any of methods known in the art.

The ink cartridge is preferably an ink cartridge that can be detachably mounted in an image forming apparatus, where the ink set stored in a container, such as the ink bags, are accommodated in a cartridge case (e.g., a plastic case) and the cartridge case is included in the ink cartridge. Owing to the above-described configuration of the ink cartridge, a replenishment or replacement procedure of the ink can be simplified, and productivity can be improved.

### (Image Forming Apparatus and Image Forming Method)

The image forming apparatus of the present disclosure includes a white ink storage unit, a color ink storage unit, a white ink application unit, and a color ink application unit. The image forming apparatus of the present disclosure may further include other units according to the necessity.

The image forming method of the present disclosure includes a white ink applying step, and a color ink applying step. The image forming method may further include other steps according to the necessity.

The image forming method of the present disclosure is suitably performed by the image forming apparatus of the present disclosure. The image forming method of the present disclosure will be described together with the image forming apparatus of the present disclosure hereinafter.

### <White Ink Storage Unit>

The white ink storage unit is a unit in which a white ink is stored.

The white ink storage unit may be the ink cartridge of the present disclosure.

The white ink stored in the white ink storage unit is the white ink included in the ink set of the present disclosure.

### <Color Ink Storage Unit>

The color ink storage unit is a unit in which a color ink is stored.

The color ink storage unit may be the ink cartridge of the present disclosure.

The color ink stored in the color ink storage unit is the color ink included in the ink set of the present disclosure.

### <White Ink Application Unit and White Ink Applying Step>

The white ink application unit is a unit configured to apply the white ink to a recording medium.

The white ink applying step is a step including applying the white ink to a recording medium.

The white ink applying step is suitably performed by the white ink application unit.

The recording medium is not particularly limited, and may be appropriately selected in accordance with the intended purpose. The recording media described in the subsection <Recording medium> in the section (Ink set) may be used as the recording medium, and preferable embodiments of the recording medium are the same as the preferable embodiments described in the above-mentioned subsection.

An application system of the white ink is not particularly limited, and may be appropriately selected in accordance with the intended purpose. Examples of the application system include an ejection system, and a coating system. Among the above-listed examples, the application system of the white ink is preferably an ejection system, and more preferably an inkjet system.

The ejection system is not particularly limited, and may be appropriately selected in accordance with the intended purpose. Examples of the ejection system include a system using a piezoelectric element actuator, a system using thermal energy, a system using an actuator utilizing electrostatic force, and a system using a charge-controlled continuous jet head.

An amount (or a deposition amount) of the white ink to be deposited on the recording medium significantly varies depending on the recording medium for use. Considering improvement in image quality and drying speed of the ink, the amount of the white ink is preferably 1 g/m² or greater and 500 g/m² or less, and more preferably 5 g/m² or greater and 400 g/m² or less.

When fabric is used as the recording medium, moreover, the amount (or the deposition amount) of the white ink on the recording medium is preferably 50 g/m² or greater and 500 g/m² or less, more preferably 100 g/m² or greater and 400 g/m² or less, and even more preferably 150 g/m² or greater and 300 g/m² or less.

### <Color Ink Application Unit and Color Ink Applying Step>

The color ink application unit is a unit configured to apply a color ink to an area of the recording medium to which the white ink is applied.

The color ink applying step is a step including applying a color ink to an area of the recording medium to which the white ink is applied.

The color ink applying step is suitably performed by the color ink application unit.

An application system of the color ink is not particularly limited, and may be appropriately selected in accordance with the intended purpose. For example, the same system to the application system of the white ink may be used. Examples of the preferable embodiment of the application system are the same as the examples listed for the white ink.

An amount (or a deposition amount) of the color ink to be deposited on the recording medium significantly varies depending on the recording medium for use. Considering improvement in image quality and drying speed of the ink, the amount (or the deposition amount) of the color ink is preferably 1 g/m² or greater and 50 g/m² or less, and more preferably 5 g/m² or greater and 30 g/m² or less.

When fabric is used as the recording medium, moreover, the amount (or the deposition amount) of the color ink on the recording medium is preferably 5 g/m² or greater and 50 g/m² or less, and more preferably 10 g/m² or greater and 30 g/m² or less.

The time span between the application of the white ink to the recording medium and the application of the color ink to the area of the recording medium, to which the white ink has been applied, (i.e., the time span between the white ink applying step and the color ink applying step) in the image forming method is preferably as short as possible considering productivity. The time span between the application of the white ink to the recording medium and the application of the color ink to the area of the recording medium, to which the white ink has been applied, is a time period for drying (e.g., causing aggregation in and/or thickening) the white ink. The above-described time span is secured for reducing color bleeding and breading that may occur due to inadequate drying (e.g., aggregation and/or thickening) of the white ink. According to the image forming method of the present disclosure, the white ink and the color ink having the specific relation of the static surface tension and the dynamic surface tension described in the section (Ink set) are used, and the white ink is applied to the recording medium, followed by applying the color ink to the area of the recording medium to which the white ink was been applied. Therefore, color bleeding and beading are minimized.

### <Other Units and Other Steps>

Examples of other units include a pre-processing fluid storage unit, a pre-processing fluid application unit, and a heating or drying unit.

Examples of other steps include a pre-processing fluid applying step, and a heating or drying step.

### <<Pre-Processing Fluid Storage Unit>>

The pre-processing fluid storage unit is a unit, in which a pre-processing fluid is stored.

The pre-processing fluid stored in the pre-processing fluid storage unit is the pre-processing fluid included in the ink set of the present disclosure.

### <<Pre-Processing Fluid Application Unit and Pre-Processing Fluid Applying Step>>

The pre-processing fluid application unit is a unit configured to apply the pre-processing fluid to an area of the recording medium to which the white ink is to be applied, prior to application of the white ink.

The pre-processing fluid applying step is a step including, prior to the white ink applying step, applying the pre-processing fluid to an area of the recording medium to which the white ink is to be applied.

The pre-processing fluid applying step is suitably performed by the pre-processing fluid application unit.

When the image forming apparatus includes pre-processing fluid storage unit and the pre-processing fluid application unit, the white ink application unit is also regarded as a unit configured to apply the white ink to the area of the recording medium, to which the pre-processing fluid has been applied.

When the image forming method includes the pre-processing fluid applying step, moreover, the white ink applying step is also regarded as a step including applying the white ink to the area of the recording medium, to which the pre-processing fluid has been applied.

An application system of the pre-processing fluid is not particularly limited, and may be appropriately selected in accordance with the intended purpose. For example, the same application system to the application system of the white ink may be used. Examples of a preferable embodiment of the application system include the preferable embodiments listed for the application system of the white ink.

An amount (or a deposition amount) of the pre-processing fluid deposited on the recording medium significantly varies depending on the recording medium for use. Considering improvement in image quality and drying speed, the amount (or the deposition amount) of the pre-processing fluid is preferably 0.1 g/m² or greater and 500 g/m² or less, and more preferably 1 g/m² or greater and 400 g/m² or less.

When fabric is used as the recording medium moreover, the amount (or the deposition amount) of the pre-processing fluid on the recording medium is preferably 100 g/m² or greater and 500 g/m² or less, more preferably 200 g/m² or greater and 500 g/m² or less, and even more preferably 300 g/m² or greater and 400 g/m² or less.

### <<Heating or Drying Unit and Heating or Drying Step>>

The heating or drying unit is a unit configured to heat or dry various fluids, such as the white ink, the color ink, and the pre-processing fluid, applied to the recording medium.

The heating step is a step including heating or drying various fluids, such as the white ink, the color ink, and the pre-processing fluid, applied to the recording medium.

The heating or drying step is suitably performed by the heating or drying unit.

The heating or drying unit is not particularly limited, and may be appropriately selected from heating units known in the art. Examples of the heating unit include a roll heater, a drum heater, a hot air generator, and a heat press.

Moreover, the drying step is not particularly limited, provided that the drying step includes drying various fluids, such as the white ink, the color ink, and the pre-processing fluid, applied to the recording medium. Examples of the drying step include a step including natural drying various fluids after applying the fluids. In the present specification, the term “drying step” means to give a time span of longer than 20 seconds from application of one fluid until application of another fluid. When the time span between application one fluid and application of another fluid is longer than 20 seconds, the image forming method is regarded as including the drying step. Accordingly, the image forming method does not include the drying step when the time span between application of one fluid and application of another fluid is within 20 seconds.

The image forming method preferably includes no heating or drying step for heating or drying the recording medium, to which the white ink is applied, between the white ink applying step and the color ink applying step considering image formation efficiency, because color bleeding and beading can be minimized even if the image forming method does not include the heating or drying step for heating or drying the recording medium to which the white ink has been applied between the white ink applying step and the color ink applying step as described above.

Similarly, the image forming apparatus preferably includes no heating or drying unit configured to heat or dry the recording medium, to which the white ink has been applied, during the time span between the application of the white ink and the application of the color ink.

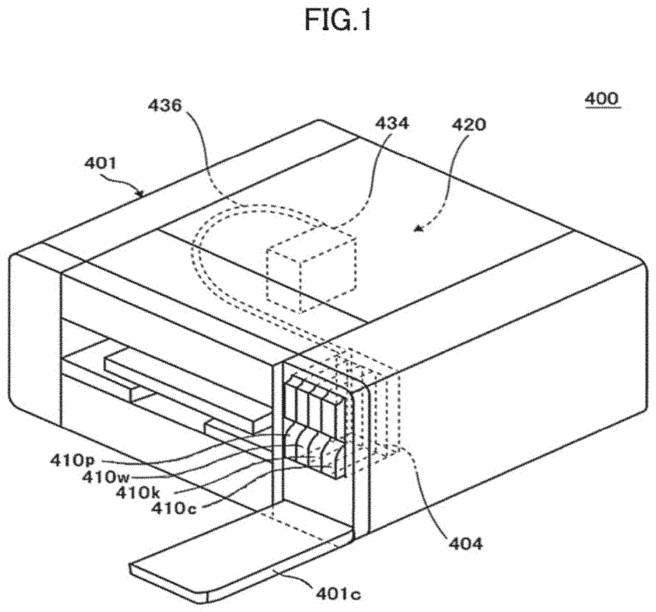

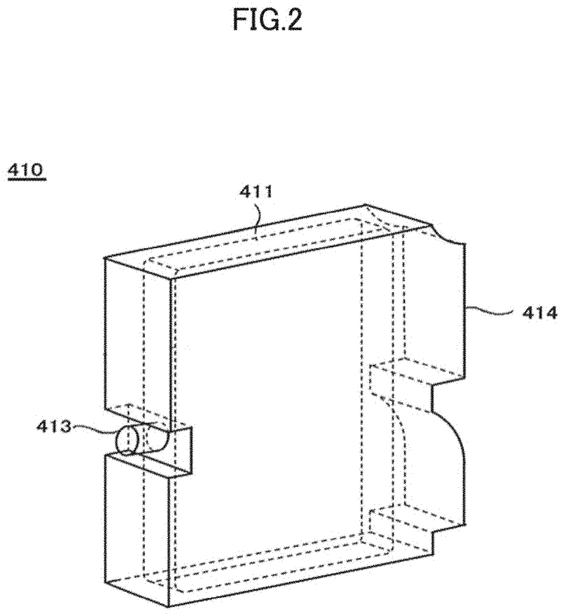

The image forming apparatus of the present disclosure will be concretely described with reference to FIGS. 1 and 2 hereinafter. However, the following embodiments shall not be construed as limiting the scope of the present disclosure.

FIG. 1 is a schematic perspective view illustrating an example of the image forming apparatus of the present disclosure. FIG. 2 is a schematic perspective view illustrating an example of a storage unit (e.g., a white ink storage unit, a color ink storage unit, and a pre-processing fluid storage unit) of the image forming apparatus of the present disclosure.

The image forming apparatus 400 illustrated in FIG. 1 is an image forming apparatus having a serial type inkjet ejection head. A system unit 420 is disposed inside a housing 401 of the image forming apparatus 400. A storage unit 411 in each of the pre-processing fluid storage unit 410p for the pre-processing fluid, the white ink storage unit 410w for the white ink, the black ink storage unit 410k for the black ink, and the cyan ink storage unit 410c for the cyan ink is formed, for example, with a packing material, such as an aluminium laminate film. For example, the storage unit 411 is accommodated in a storage container case 414 formed of a plastic. Owing to the above-described configuration, each storage unit 410 can be used as an ink cartridge.

A cartridge holder 404 is disposed at the back of the opening as a cover 401c of the main body of the image forming apparatus 400 is open. Each storage unit 410 (p, w, k, and c) is detachably mounted in the cartridge holder 404. As a result of the above-described configuration, the outlet 413 of each storage unit 410 (p, w, k, and c) and an inkjet ejection head 434 communicate via each supply tube 436 to eject a pre-processing fluid or each ink from the inkjet ejection head 434 towards a recording medium.

By means of the image forming apparatus 400 illustrated in FIG. 1, the pre-processing fluid is applied onto a recording medium according to an inkjet system, but the application method of the pre-processing fluid is not limited to the inkjet system, and any of the above-described application methods may be used.

The image forming apparatus 400 may include a heating or drying unit configured to heat or dry various fluids applied to the recording medium, such as the white ink, the color ink, and the pre-processing fluid. However, it is preferable that the image forming apparatus 400 do not include a heating or drying unit configured to heat or dry the recording medium to which the white ink has been applied during the period between the application of the white ink and the application of the color ink. Such a heating or drying unit is disposed for heating or drying the white ink to reduce color bleeding and beading caused by inadequate drying of the white ink. Use of the ink set of the present disclosure can reduce color bleeding and beading without disposing such a heating or drying unit in the image forming apparats

### EXAMPLES

The present disclosure will be described below by way of Preparation Examples, Production Examples, Examples, and Comparative Examples. The present disclosure should not be construed as being limited to Preparation Examples, Production Examples, and Examples below.

Pigment dispersions and pigment-containing polymer particle dispersion liquids were prepared according to the methods described in Preparation Examples 1 to 9 below.

### Preparation Example 1: Preparation of Surface-Modified Black Pigment Dispersion

By means of SILVERSON (registered trademark) Mixer, 100 g of BLACK PEARLS (registered trademark) 1000 (carbon black having the BET specific surface area of 343 m²/g, and dibutyl phthalate absorption (DBPA) of 105 mL/100 g) available from Cabot Corporation, 100 mmol of sulfanilic acid, and 1 L of ultrapure water were mixed at 6,000 rpm at room temperature (23° C.±0.5° C.) to obtain a slurry.

Next, 100 mmol of nitric acid was added to the obtain slurry. Thirty minutes later, 100 mmol of sodium nitrite dissolved in 10 mL of ultrapure water was slowly added. The resultant mixture was heated to 60° C. with stirring, and the mixture was allowed to react for 1 hour to obtain a modified pigment in which sulfanilic acid was added to the carbon black.

Next, the pH of the resultant was adjusted to 9 with a 10% by mass tetrabutylammonium hydroxide methanol solution. Thirty minutes later, a modified pigment dispersion was obtained. Subsequently, ultrafiltration was performed with a dialysis membrane using the modified pigment dispersion and ultrapure water, followed by performing ultrasonication to obtain a surface-modified black pigment dispersion having the solid pigment content of 20% by mass.

The surface modification level of the pigment in the obtained surface-modified black pigment dispersion was 0.75 mmol/g. The 50% volume median particle diameter (D50) of the particles of the pigment in the obtained surface-modified black pigment dispersion as measured by a particle size analyzer (Nanotrac Wave II-UT151, available from Microtrac MRB) was 120 nm.

### Preparation Example 2: Preparation of Surface-Modified Magenta Pigment Dispersion

One kilogram of a pigment dispersion, SMART Magenta 3122BA (C.I. Pigment Red 122 surface-treated dispersion, solid pigment: 14.5% by mass) available from Sensient Technologies Corporation was precipitated using a 0.1 N hydrochloric acid aqueous solution.

Next, pH of the resultant was adjusted to 9 with a 10% by mass tetraethylammonium hydroxide aqueous solution. Thirty minutes later, the modified pigment dispersion including the pigment to which at least one aminobenzoic acid group or aminobenzoic acid tetraethylammonium salt was bonded was obtained. Ultrafiltration was performed with a dialysis membrane using the obtained modified pigment dispersion and ultrapure water, followed by performing ultrasonication to obtain a surface-modified magenta pigment dispersion having the solid pigment content of 20% by mass.

The 50% volume median particle diameter (D50) of the particles of the pigment in the obtained surface-modified magenta pigment dispersion as measured by a particle size analyzer (Nanotrac Wave II-UT151, available from Microtrac MRB) was 104 nm.

### Preparation Example 3: Preparation of Surface-Modified Cyan Pigment Dispersion

One kilogram of a pigment dispersion, SMART Cyan 3154BA (C.I. Pigment Blue 15:4 surface treated dispersion, solid pigment content: 14.5% by mass) available from Sensient Technologies Corporation was precipitated with a 0.1 N hydrochloric acid aqueous solution.

Next, the pH of the resultant was adjusted to 9 with a 40% by mass benzyltrimethylammonium hydroxide methanol solution. Thirty minutes later, a modified pigment dispersion including the pigment to which at least one aminobenzoic acid group or aminobenzoic acid tetraethylammonium salt was bonded was obtained. Ultrafiltration was performed with a dialysis membrane using the obtained modified pigment dispersion and ultrapure water, followed by performing ultrasonication to obtain a surface-modified cyan pigment having the solid pigment content of 20% by mass.

The 50% volume median particle diameter (D50) of the particles of the pigment in the obtained surface-modified cyan pigment dispersion as measured by a particle size analyzer (Nanotrac Wave II-UT151, available from Microtrac MRB) was 116 nm.

### Preparation Example 4: Preparation of Surface-Modified Yellow Pigment

The pH of 1 kg of a pigment dispersion, SMART Yellow 3074BA (C.I. Pigment Yellow 74 surface-treated dispersion, solid pigment content: 14.5% by mass) available from Sensient Technologies Corporation was adjusted to 9 with a 10% by mass tetrabutylammonium hydroxide methanol solution. Thirty minutes later, ultrafiltration was performed with a dialysis membrane using the modified pigment dispersion including the pigment to which at least one aminobenzoic acid group or aminobenzoic acid tetraethylammonium salt was bonded and ultrapure water, followed by performing ultrasonication to obtain a surface-modified yellow pigment dispersion having the solid pigment content of 20% by mass.

The 50% volume median particle diameter (D50) of the particles of the pigment in the obtained surface-modified yellow pigment dispersion as measured by a particle size analyzer (Nanotrac Wave II-UT151, available from Microtrac MRB) was 145 nm.

### Preparation Example 5: Preparation of Magenta Pigment-Containing Polymer Particle Dispersion Liquid

After adequately purging a 1 L flask equipped with a mechanical stirrer, a thermometer, a nitrogen inlet tube, a reflux tube, and a dropping funnel with nitrogen gas, 11.2 g of styrene, 2.8 g of acrylic acid, 12.0 g of lauryl methacrylate, 4.0 g of polyethylene glycol methacrylate, 4.0 g of a styrene macromer, and 0.4 g of mercaptoethanol were mixed in the flask, and the resultant mixture was heated to 65° C. Next, a mixed solution including 100.8 g of styrene, 25.2 g of acrylic acid, 108.0 g of lauryl methacrylate, 36.0 g of polyethylene glycol methacrylate, 60.0 g of hydroxyethyl methacrylate, 36.0 g of a styrene macromer, 3.6 g of mercaptoethanol, 2.4 g of azobis methylvaleronitrile, and 18 g of methyl ethyl ketone was added to the flask by dropping over 2.5 hours. After the dropping, a mixed solution including 0.8 g of azobis methylvaleronitrile an 18 g of methyl ethyl ketone was added to the flask by dropping over 0.5 hours. After stirring the resultant mixture at 65° C. for 1 hour, 0.8 g of azobis methylvaleronitrile was added, followed by stirring for 1 hour. After completing the reaction, 364 g of methyl ethyl ketone was added to the flask to obtain 800 g of Polymer Solution A having a concentration of 50% by mass.

Next, 28 g of Polymer Solution A, 42 g of C.I. Pigment Red 122, 13.6 g of a 1 mol/L potassium hydroxide aqueous solution, 20 g of methyl ethyl ketone, and 13.6 g of ultrapure water were adequately stirred, followed by kneading the mixture with a roll mill. The obtained paste was added to 200 g of ultrapure water. After adequately stirring the mixture, methyl ethyl ketone and water were removed by an evaporator. Furthermore, pressure filtration was performed on the resultant dispersion liquid with a polyvinylidene fluoride membrane filter having the average pore diameter of 5.0 μm to remove coarse particles, to thereby obtain a magenta pigment-containing polymer particle dispersion liquid having the solid pigment content of 15% by mass and the total solid content of 20% by mass.

The 50% volume median particle diameter (D50) of the polymer particles in the obtained magenta pigment-containing polymer particle dispersion liquid as measured by a particle size analyzer (Nanotrac Wave II-UT151, available from Microtrac MRB) was 127 nm.

### Preparation Example 6: Preparation of Cyan Pigment-Containing Polymer Particle Dispersion Liquid

A cyan pigment-containing polymer particle dispersion liquid having the solid pigment content of 15% by mass and the total solid content of 20% by mass was prepared in the same manner as in Preparation Example 5, except that C.I. Pigment Red 122 used as the pigment was replaced with a phthalocyanine pigment (C.I. Pigment Blue 15:3).

The 50% volume median particle diameter (D50) of the polymer particles in the obtained cyan pigment-containing polymer particle dispersion liquid as measured by a particle size analyzer (Nanotrac Wave II-UT151, available from Microtrac MRB) was 93 nm.

### Preparation Example 7: Preparation of Yellow Pigment-Containing Polymer Particle Dispersion Liquid

A yellow pigment-containing polymer particle dispersion liquid having the solid pigment content of 15% by mass and the total solid content of 20% by mass was prepared in the same manner as in Preparation Example 5, except that C.I. Pigment Red 122 used as the pigment was replaced with an azobis yellow pigment (C.I. Pigment Yellow 155).

The 50% volume median particle diameter (D50) of the polymer particles in the obtained yellow pigment-containing polymer particle dispersion liquid as measured by a particle size analyzer (Nanotrac Wave II-UT151, available from Microtrac MRB) was 76 nm.

### Preparation Example 8: Preparation of Black Pigment-Containing Polymer Particle Dispersion Liquid

A black pigment-containing polymer particle dispersion liquid having the solid pigment content of 15% by mass and the total solid content of 20% by mass was prepared in the same manner as in Preparation Example 5, except that C.I. Pigment Red 122 used as the pigment was replaced with carbon black (FW100, available from Degussa).

The 50% volume median particle diameter (D50) of the polymer particles in the obtained black pigment-containing polymer particle dispersion liquid as measured by a particle size analyzer (Nanotrac Wave II-UT151, available from Microtrac MRB) was 104 nm.

### Preparation Example 9: Preparation of Polymer-Dispersing White Pigment Dispersion Liquid

After adequately stirring 55.6 g of a copolymer solution DISPERBYK-2081 (available from BYK Japan K.K.), 517 g of titanium oxide (TITONE R-25, available from SAKAI CHEMICAL INDUSTRY CO., LTD.), 50 g of β-methoxy-N,N-dimethylpropionamide, and 377.4 g of ultrapure water, a bead mill (DYNO-MILL) was charged with the resultant mixture and the mixture was dispersed until the 50% volume median particle diameter (D50) of the particles was to be 300 nm or less. Furthermore, pressure filtration was performed on the resultant dispersion liquid with a polyvinylidene fluoride membrane filter having the average pore diameter of 5.0 μm to remove coarse particles, to thereby obtain a polymer-dispersing white pigment dispersion liquid having the solid white pigment content of 50% by mass.

The 50% volume median particle diameter (D50) of the pigment particles in the obtained polymer-dispersing white pigment dispersion liquid as measured by a particle size analyzer (Nanotrac Wave II-UT151, available from Microtrac MRB) was 283 nm.

White inks and color inks were produced according to the methods described in Production Examples 1-1 to 1-50 below.

### Production Example 1-1: Production of Ink 1

A container equipped with a stirrer was charged with 2.00 parts by mass of 2,2,4-trimethyl-1,3-pentanediol, 25.00 parts by mass of glycerin, 5.00 parts by mass of propylene glycol, and 0.12 parts by mass of 2,4,7,9-tetramethyldecane-4,7-diol, and the resultant mixture was mixed and stirred for 30 minutes. Subsequently, 0.05 parts by mass of a preservative or fungicide (PROXEL(registered trademark) GXL) and 26.67 parts by mass of the magenta pigment-containing polymer particle dispersion liquid of Preparation Example 5 were added, and the resultant mixture was mixed and stirred for 20 minutes. Moreover, 33.33 parts by mass of TAKELAC (registered trademark) WS-6021 as water-dispersible resin particles, 1.25 parts by mass of TAKENATE (registered trademark) XWB-ST001 as a crosslinking agent, and the amount of ultrapure water to make a total amount of the entire mixture 100 parts by mass were added, and the resultant mixture was mixed and stirred for 60 minutes. Subsequently, pressure filtration was performed on the obtained mixture with a polyvinylidene fluoride membrane filter having the average pore diameter of 1.2 μm to remove coarse particles and dust, to thereby obtain Ink 1.

### Production Examples 1-2 to 1-50: Productions of Inks 2 to 50

Inks 2 to 50 were each obtained in the same manner as in Production Example 1-1, except that the formulation of the ink was changed to the materials and amounts presented in Tables 1-1 to 1-10 below.

In Tables 1-1 to 1-10, the unit of an amount of each material is “r by mass,” and the presented amount is a total amount, not a solid content nor an active ingredient content.

The details of the materials presented in Tables 1-1 to 1-10 are as follows.

### —Colorant—

Polymer-dispersing white pigment dispersion liquid: AC-AW62 (available from Dainichiseika Color & Chemicals Mfg. Co., Ltd., pigment solid content: 50% by mass)

### —Water-Dispersible Resin Particles—

SUPERFLEX 460: polyurethane dispersion having a solid content of 38% by mass, available from DKS Co., Ltd.
SUPERFLEX 460S: polyurethane dispersion having a solid content of 38% by mass, available from DKS Co., Ltd.
SUPERFLEX 470: polyurethane dispersion having a solid content of 38% by mass, available from DKS Co., Ltd.
TAKELAC (registered trademark) WS-5984: polyurethane dispersion having a solid content of 40% by mass, available from Mitsui Chemicals, Inc.
TAKELAC (registered trademark) WS-6021: polyurethane dispersion having a solid content of 30% by mass, available from Mitsui Chemicals, Inc.

### —Blocked Isocyanate Compound—

ERASTRON (registered trademark) E-37 (active ingredient: 28% by mass) available from DKS Co., Ltd.
ERASTRON (registered trademark) H-3-DF (active ingredient: 27.5% by mass) available from DKS Co., Ltd.
TAKENATE (registered trademark) XWB-ST001 (active ingredient: 40% by mass) available from Mitsui Chemicals, Inc.
ADEKA BONTIGHTER HUX-3861 (active ingredient: 35% by mass) available from ADEKA CORPORATION

### —Surfactant—

Compound represented by Structural Formula (8): polyether-modified siloxane compound (active ingredient: 100%)
TEGO (registered trademark) Wet 270: polyether-modified siloxane compound (active ingredient: 100%) available from EVONIK JAPAN CO., LTD.
SILFACE SAG503A: polyether-modified siloxane compound (active ingredient: 100%) available from Nissin Chemical Co., Ltd.
SURFYNOL 104E: 2,4,7,9-tetramethyl-5-decyne-4,7-diol (active ingredient: 50%) available from Nissin Chemical Co., Ltd.
UNIDYNE DSN403N: polyoxyethylene perfluoroalkyl ether (active ingredient: 100%) available from DAIKIN INDUSTRIES, LTD.

### —Preservative or Fungicide—

PROXEL(registered trademark) GXL: preservative or fungicide including 1,2-benzothiazolin-3-one as a main ingredient (active ingredient: 20%, dipropylene glycol included) available from Nitto Denko Avecia Inc.

TABLE 1-1

| | | Solid content | | | | | |
|---|---|---|---|---|---|---|---|
| | | or active | | | | | |
| | | ingredient | P. Ex. | P. Ex. | P. Ex. | P. Ex. | P. Ex. |
| | | content | 1-1 | 1-2 | 1-3 | 1-4 | 1-5 |
| Components (% by mass) | | (% by mass) | Ink 1 | Ink 2 | Ink 3 | Ink 4 | Ink 5 |
| Colorant (pigment | Prep. Ex. 5: M | 15 | 26.67 | — | — | — | — |
| dispersion | pigment- | | | | | | |
| liquid) | containing PDL | | | | | | |
| | Prep. Ex. 6: C | 15 | — | 26.67 | — | — | — |
| | pigment- | | | | | | |
| | containing PDL | | | | | | |
| | Prep. Ex. 7: Y | 15 | — | — | 26.67 | — | — |
| | pigment- | | | | | | |
| | containing PDL | | | | | | |
| | Prep. Ex. 8: B | 15 | — | — | — | 33.33 | — |
| | pigment- | | | | | | |
| | containing PDL | | | | | | |
| | AC-AW62 | 50 | — | — | — | — | 20.00 |
| Water-dispersible | TAKELAC ® | 30 | 33.33 | 33.33 | 33.33 | 33.33 | 33.33 |
| resin particles | WS-6021 | | | | | | |
| Crosslinking | TAKENATE ® XWB- | 40 | 1.25 | 1.25 | 1.25 | 1.25 | 1.25 |
| agent | ST001 | | | | | | |
| Organic solvent 1 | 2,2,4-trimethyl- | 100 | 2.00 | 3.00 | 3.00 | 2.00 | 2.00 |
| (SP value: | 1,3-penanediol | | | | | | |
| 9.0 to 11.8 | (SP value: 10.8) | | | | | | |
| (cal/cm³)^{1/2}) | | | | | | | |
| Organic solvent 2 | Glycerin (SP | 100 | 25.00 | 25.00 | 25.00 | 25.00 | 25.00 |
| (wetting agent) | value: 16.38) | | | | | | |
| | Propylene glycol | 100 | 5.00 | 5.00 | 5.00 | 2.00 | 5.00 |
| | (SP value: 13.72) | | | | | | |
| Preservative or | PROXEL ® GXL | 20 | 0.05 | 0.05 | 0.05 | 0.05 | 0.05 |
| fungicide | | | | | | | |
| Foaming inhibitor | 2,4,7,9- | 100 | 0.12 | 0.10 | 0.08 | 0.11 | 0.10 |
| (defoaming agent) | tetramethyldecane- | | | | | | |
| | 4,7-diol | | | | | | |

| | | | | | | |
|---|---|---|---|---|---|---|
| Ultrapure water | — | balance | balance | balance | balance | balance |
| Total (% by mass) | — | 100 | 100 | 100 | 100 | 100 |

In Table 1-1, the abbreviations denote as follows.

### P. Ex.: Production Example

M pigment-containing PDL: Magenta pigment-containing polymer particle dispersion liquid
C pigment-containing PDL: Cyan pigment-containing polymer particle dispersion liquid
Y pigment-containing PDL: Yellow pigment-containing polymer particle dispersion liquid
B pigment-containing PDL: Black pigment-containing polymer particle dispersion liquid
AC-AW62: Polymer-dispersing white pigment dispersion liquid

TABLE 1-2

| | | Solid content | | | | | |
|---|---|---|---|---|---|---|---|
| | | or active | | | | | |
| | | ingredient | P. Ex. | P. Ex. | P. Ex. | P. Ex. | P. Ex. |
| | | content | 1-6 | 1-7 | 1-8 | 1-9 | 1-10 |
| Components (% by mass) | | (% by mass) | Ink 6 | Ink 7 | Ink 8 | Ink 9 | Ink 10 |
| Colorant | Prep. Ex. 5: M | 15 | 26.67 | — | — | — | — |
| (pigment | pigment- | | | | | | |
| dispersion) | containing PDL | | | | | | |
| | Prep. Ex. 6: C | 15 | — | 26.67 | — | — | — |
| | pigment- | | | | | | |
| | containing PDL | | | | | | |
| | Prep. Ex. 7: Y | 15 | — | — | 26.67 | — | — |
| | pigment- | | | | | | |
| | containing PDL | | | | | | |
| | Prep. Ex. 8: B | 15 | — | — | — | 33.33 | — |
| | pigment- | | | | | | |
| | containing PDL | | | | | | |
| | AC-AW62 | 50 | — | — | — | — | 20.00 |
| Water-dispersible | SUPERFLEX | 38 | 15.79 | 15.79 | 15.79 | 15.79 | 15.79 |
| resin particles | 460 | | | | | | |
| Crosslinking | ERASTRON ® E- | 28 | 11.79 | 11.79 | 11.79 | 11.79 | 11.79 |
| agent | 37 | | | | | | |
| | 2,2,4-trimethyl- | 100 | 2.00 | 3.00 | 3.00 | 2.00 | 2.00 |
| | 1,3-penanediol | | | | | | |
| | (SP value: 10.8) | | | | | | |
| Organic solvent 2 | Glycerin | 100 | 25.00 | 25.00 | 25.00 | 25.00 | 25.00 |
| (wetting agent) | (SP value: 16.38) | | | | | | |
| | Propylene glycol | 100 | 5.00 | 5.00 | 5.00 | 2.00 | 5.00 |
| | (SP value: 13.72) | | | | | | |
| Preservative or | PROXEL ® GXL | 20 | 0.05 | 0.05 | 0.05 | 0.05 | 0.05 |
| fungicide | | | | | | | |
| Foaming inhibitor | 2,4,7,9- | 100 | 0.12 | 0.10 | 0.08 | 0.11 | 0.10 |
| (defoaming agent) | tetramethyldecane- | | | | | | |
| | 4,7-diol | | | | | | |

| | | | | | | |
|---|---|---|---|---|---|---|
| Ultrapure water | — | balance | balance | balance | balance | balance |
| Total (% by mass) | — | 100 | 100 | 100 | 100 | 100 |

In Table 1-2, the abbreviations denote as follows.

### P. Ex.: Production Example

M pigment-containing PDL: Magenta pigment-containing polymer particle dispersion liquid
C pigment-containing PDL: Cyan pigment-containing polymer particle dispersion liquid
Y pigment-containing PDL: Yellow pigment-containing polymer particle dispersion liquid
B pigment-containing PDL: Black pigment-containing polymer particle dispersion liquid
AC-AW62: Polymer-dispersing white pigment dispersion liquid

TABLE 1-3

| | | Solid content | | | | | |
|---|---|---|---|---|---|---|---|
| | | or active | | | | | |
| | | ingredient | P. Ex. | P. Ex. | P. Ex. | P. Ex. | P. Ex. |
| | | content | 1-11 | 1-12 | 1-13 | 1-14 | 1-15 |
| Components (% by mass) | | (% by mass) | Ink 11 | Ink 12 | Ink 13 | Ink 14 | Ink 15 |
| Colorant | Prep. Ex. 5: M | 15 | 26.67 | — | — | — | — |
| (pigment | pigment- | | | | | | |
| dispersion) | containing PDL | | | | | | |
| | Prep. Ex. 6: C | 15 | — | 26.67 | — | — | — |
| | pigment- | | | | | | |
| | containing PDL | | | | | | |
| | Prep. Ex. 7: Y | 15 | — | — | 26.67 | — | — |
| | pigment- | | | | | | |
| | containing PDL | | | | | | |
| | Prep. Ex. 8: B | 15 | — | — | — | 33.33 | — |
| | pigment- | | | | | | |
| | containing PDL | | | | | | |
| | AC-AW62 | 50 | — | — | — | — | 16.00 |
| Water-dispersible | TAKELAC ® | 40 | 25.00 | 25.00 | 25.00 | 25.00 | 30.00 |
| resin particles | WS-5984 | | | | | | |
| Crosslinking | ADEKA BONTIGHTER | 35 | 2.86 | 2.86 | 2.86 | 2.86 | 3.43 |
| agent | HUX-3861 | | | | | | |
| Organic solvent 1 | 2-ethyl-1,3- | 100 | 2.00 | 2.00 | 2.00 | 2.00 | 2.00 |
| (SP value: | hezanediol | | | | | | |
| 9.0 to 11.8 | (SP value: 10.6) | | | | | | |
| (cal/cm³)^{1/2}) | | | | | | | |
| Organic | Glycerin | 100 | 27.00 | 27.50 | 22.00 | 20.00 | 23.00 |
| solvent 2 | (SP value: 16.38) | | | | | | |
| (wetting | 3-ethyl-1,3- | 100 | 5.00 | 5.00 | 10.00 | 7.50 | 10.00 |
| agent) | butanediol (SP | | | | | | |
| | value: 12.05) | | | | | | |
| Surfactant | SILFACE SAG503A | 100 | 0.40 | 0.40 | 0.50 | 0.30 | 0.60 |
| Preservative | PROXEL ® GXL | 20 | 0.05 | 0.05 | 0.05 | 0.05 | 0.05 |
| or fungicide | | | | | | | |
| Foaming | 2,5,8,11- | 100 | 0.50 | 0.50 | 0.50 | 0.50 | 0.30 |
| inhibitor | tetramethyldodecane- | | | | | | |
| (defoaming | 5,8-diol | | | | | | |
| agent) | | | | | | | |
| pH regulator | 2-amino-2-ethyl- | 100 | 0.20 | 0.20 | 0.20 | 0.20 | 0.20 |
| | 1,3-propanediol | | | | | | |

| | | | | | | |
|---|---|---|---|---|---|---|
| Ultrapure water | — | balance | balance | balance | balance | balance |
| Total (% by mass) | — | 100 | 100 | 100 | 100 | 100 |

In Table 1-3, the abbreviations denote as follows.

### P. Ex.: Production Example

M pigment-containing PDL: Magenta pigment-containing polymer particle dispersion liquid
C pigment-containing PDL: Cyan pigment-containing polymer particle dispersion liquid
Y pigment-containing PDL: Yellow pigment-containing polymer particle dispersion liquid
B pigment-containing PDL: Black pigment-containing polymer particle dispersion liquid
AC-AW62: Polymer-dispersing white pigment dispersion liquid

TABLE 1-4

| | | Solid content | | | | | |
|---|---|---|---|---|---|---|---|
| | | or active | | | | | |
| | | ingredient | P. Ex. | P. Ex. | P. Ex. | P. Ex. | P. Ex. |
| | | content | 1-16 | 1-17 | 1-18 | 1-19 | 1-20 |
| Components (% by mass) | | (% by mass) | Ink 16 | Ink 17 | Ink 18 | Ink 19 | Ink 20 |
| Colorant | Prep. Ex. 5: M | 15 | 26.67 | — | — | — | — |
| (pigment | pigment- | | | | | | |
| dispersion) | containing PDL | | | | | | |
| | Prep. Ex. 6: C | 15 | — | 26.67 | — | — | — |
| | pigment- | | | | | | |
| | containing PDL | | | | | | |
| | Prep. Ex. 7: Yellow | 15 | — | — | 26.67 | — | — |
| | pigment- | | | | | | |
| | containing PDL | | | | | | |
| | Prep. Ex. 8: Black | 15 | — | — | — | 33.33 | — |
| | pigment- | | | | | | |
| | containing PDL | | | | | | |
| | AC-AW62 | 50 | — | — | — | — | 16.00 |
| Water- | SUPERFLEX 460S | 38 | 26.32 | 26.32 | 26.32 | 26.32 | 31.58 |
| dispersible | | | | | | | |
| resin particles | | | | | | | |
| Crosslinking | ERASTRON ® H-3-DF | 27.5 | 5.45 | 5.45 | 5.45 | 5.45 | 6.55 |
| agent | | | | | | | |
| Organic | 2-ethyl-1,3- | 100 | 2.00 | 2.00 | 2.00 | 2.00 | 2.00 |
| solvent 1 | hezanediol | | | | | | |
| (SP value: | (SP value: 10.6) | | | | | | |
| 9.0 to 11.8 | | | | | | | |
| (cal/cm³)^{1/2}) | | | | | | | |
| Organic | Glycerin | 100 | 27.00 | 27.50 | 22.00 | 20.00 | 23.00 |
| solvent 2 | (SP value: 16.38) | | | | | | |
| (wetting | 3-ethyl-1,3- | 100 | 5.00 | 5.00 | 10.00 | 7.50 | 10.00 |
| agent) | butanediol | | | | | | |
| | (SP value: 12.05) | | | | | | |
| Surfactant | SILFACE SAG503A | 100 | 0.40 | 0.40 | 0.50 | 0.30 | 0.60 |
| Preservative | PROXEL ® GXL | 20 | 0.05 | 0.05 | 0.05 | 0.05 | 0.05 |
| or fungicide | | | | | | | |
| Foaming | 2,5,8,11- | 100 | 0.50 | 0.50 | 0.50 | 0.50 | 0.30 |
| inhibitor | tetramethyldodecane- | | | | | | |
| (defoaming | 5,8-diol | | | | | | |
| agent) | | | | | | | |
| pH regulator | 2-amino-2-ethyl- | 100 | 0.20 | 0.20 | 0.20 | 0.20 | 0.20 |
| | 1,3-propanediol | | | | | | |

| | | | | | | |
|---|---|---|---|---|---|---|
| Ultrapure water | — | balance | balance | balance | balance | balance |
| Total (% by mass) | — | 100 | 100 | 100 | 100 | 100 |

In Table 1-4, the abbreviations denote as follows.

### P. Ex.: Production Example

M pigment-containing PDL: Magenta pigment-containing polymer particle dispersion liquid
C pigment-containing PDL: Cyan pigment-containing polymer particle dispersion liquid
Y pigment-containing PDL: Yellow pigment-containing polymer particle dispersion liquid
B pigment-containing PDL: Black pigment-containing polymer particle dispersion liquid
AC-AW62: Polymer-dispersing white pigment dispersion liquid

TABLE 1-5

| | | Solid content | | | | | |
|---|---|---|---|---|---|---|---|
| | | or active | | | | | |
| | | ingredient | P. Ex. | P. Ex. | P. Ex. | P. Ex. | P. Ex. |
| | | content | 1-21 | 1-22 | 1-23 | 1-24 | 1-25 |
| Components (% by mass) | | (% by mass) | Ink 21 | Ink 22 | Ink 23 | Ink 24 | Ink 25 |
| Colorant | Prep. Ex. 5: M | 15 | 26.67 | — | — | — | — |
| (pigment | pigment- | | | | | | |
| dispersion) | containing PLD | | | | | | |
| | Prep. Ex. 6: C | 15 | — | 26.67 | — | — | — |
| | pigment- | | | | | | |
| | containing PLD | | | | | | |
| | Prep. Ex. 7: Y | 15 | — | — | 26.67 | — | — |
| | pigment- | | | | | | |
| | containing PLD | | | | | | |
| | Prep. Ex. 8: B | 15 | — | — | — | 33.33 | — |
| | pigment- | | | | | | |
| | containing PLD | | | | | | |
| | Prep. Ex. 9: | 50 | — | — | — | — | 16.00 |
| | polymer-dispersing | | | | | | |
| | white pigment | | | | | | |
| | dispersion liquid | | | | | | |
| Water- | SUPERFLEX 470 | 38 | 26.32 | 26.32 | 26.32 | 26.32 | 26.32 |
| dispersible | | | | | | | |
| resin particles | | | | | | | |
| Crosslinking | ERASTRON ® E-37 | 28 | 7.14 | 7.14 | 7.14 | 7.14 | 7.14 |
| agent | | | | | | | |
| Organic | 2,2,4-trimethyl- | 100 | 2.00 | 2.00 | 2.00 | 2.00 | 2.00 |
| solvent 1 | 1,3-penanediol | | | | | | |
| (SP value: | (SP value: 10.8) | | | | | | |
| 9.0 to 11.8 | | | | | | | |
| (cal/cm³)^{1/2}) | | | | | | | |
| Organic | Glycerin | 100 | 26.50 | 27.00 | 27.00 | 19.50 | 24.99 |
| solvent 2 | (SP value: 16.38) | | | | | | |
| (wetting | 3-ethyl-1,3- | 100 | 5.00 | 5.00 | 5.00 | 7.50 | 5.00 |
| agent) | butanediol | | | | | | |
| | (SP value: 12.05) | | | | | | |
| Surfactant | Compound | 100 | 0.50 | 0.50 | 0.50 | 0.50 | 0.30 |
| | represented by | | | | | | |
| | Structural Formula | | | | | | |
| | (8) | | | | | | |
| Preservative | PROXEL ® GXL | 20 | 0.05 | 0.05 | 0.05 | 0.05 | 0.05 |
| or fungicide | | | | | | | |
| Foaming | 2,4,7,9- | 100 | 0.50 | 0.50 | 0.50 | 0.50 | 0.30 |
| inhibitor | tetramethyldecane- | | | | | | |
| (defoaming | 4,7-diol | | | | | | |
| agent) | | | | | | | |
| pH regulator | 2-amino-2-ethyl- | 100 | 0.20 | 0.20 | 0.20 | 0.20 | 0.20 |
| | 1,3-propanediol | | | | | | |

| | | | | | | |
|---|---|---|---|---|---|---|
| Ultrapure water | — | balance | balance | balance | balance | balance |
| Total (% by mass) | — | 100 | 100 | 100 | 100 | 100 |

In Table 1-5, the abbreviations denote as follows.

### P. Ex.: Production Example

M pigment-containing PDL: Magenta pigment-containing polymer particle dispersion liquid
C pigment-containing PDL: Cyan pigment-containing polymer particle dispersion liquid
Y pigment-containing PDL: Yellow pigment-containing polymer particle dispersion liquid
B pigment-containing PDL: Black pigment-containing polymer particle dispersion liquid

TABLE 1-6

| | | Solid content | | | | | |
|---|---|---|---|---|---|---|---|
| | | or active | | | | | |
| | | ingredient | P. Ex. | P. Ex. | P. Ex. | P. Ex. | P. Ex. |
| | | content | 1-26 | 1-27 | 1-28 | 1-29 | 1-30 |
| Components (% by mass) | | (% by mass) | Ink 26 | Ink 27 | Ink 28 | Ink 29 | Ink 30 |
| Colorant | Prep. Ex. 5: M | 15 | 26.67 | — | — | — | — |
| (pigment | pigment- | | | | | | |
| dispersion) | containing PDL | | | | | | |
| | Prep. Ex. 6: C | 15 | — | 23.33 | — | — | — |
| | pigment- | | | | | | |
| | containing PDL | | | | | | |
| | Prep. Ex. 7: Y | 15 | — | — | 26.67 | — | — |
| | pigment- | | | | | | |
| | containing PDL | | | | | | |
| | Prep. Ex. 8: B | 15 | — | — | — | 33.33 | — |
| | pigment- | | | | | | |
| | containing PDL | | | | | | |
| | AC-AW62 | 50 | — | — | — | — | 20.00 |
| Water- | TAKELAC ® | 40 | 17.50 | 17.50 | 17.50 | 17.50 | 20.00 |
| dispersible | WS-5984 | | | | | | |
| resin particles | TAKENATE ® XWB- | 40 | 8.75 | 8.75 | 8.75 | 8.75 | 10.00 |
| | ST001 | | | | | | |
| Organic | 3-methoxy-N,N- | 100 | 1.00 | 1.00 | 1.00 | 1.00 | 1.00 |
| solvent 1 | dimethylpropananamide | | | | | | |
| (SP value: | (SP value: 9.19) | | | | | | |
| 9.0 to 11.8 | 3-methoxy-3- | 100 | 1.00 | 1.00 | 1.00 | 1.00 | 1.00 |
| (cal/cm³)^{1/2}) | methyl-1-butanol | | | | | | |
| | (SP value: 9.64) | | | | | | |
| Organic | Glycerin | 100 | 20.55 | 19.00 | 20.00 | 19.00 | 18.30 |
| solvent 2 | (SP value: 16.38) | | | | | | |
| (wetting | 3-ethyl-1,3- | 100 | 9.00 | 9.00 | 9.00 | 6.50 | 9.00 |
| agent) | butanediol (SP | | | | | | |
| | value: 12.05) | | | | | | |
| Surfactant | SILFACE SAG503A | 100 | 0.45 | 0.60 | 0.55 | 0.30 | 0.50 |
| Preservative | PROXEL ® GXL | 20 | 0.0.5 | 0.05 | 0.05 | 0.05 | 0.05 |
| or fungicide | | | | | | | |
| Foaming | 2,4,7,9- | 100 | 0.40 | 0.40 | 0.40 | 0.40 | 0.40 |
| inhibitor | tetramethyldecane- | | | | | | |
| (defoaming | 4,7-diol | | | | | | |
| agent) | | | | | | | |
| pH regulator | 2-amino-2-ethyl- | 100 | 0.20 | 0.20 | 0.20 | 0.25 | 0.20 |
| | 1,3-propanediol | | | | | | |

| | | | | | | |
|---|---|---|---|---|---|---|
| Ultrapure water | — | balance | balance | balance | balance | balance |
| Total (% by mass) | — | 100 | 100 | 100 | 100 | 100 |

In Table 1-6, the abbreviations denote as follows.

### P. Ex.: Production Example

M pigment-containing PDL: Magenta pigment-containing polymer particle dispersion liquid
C pigment-containing PDL: Cyan pigment-containing polymer particle dispersion liquid
Y pigment-containing PDL: Yellow pigment-containing polymer particle dispersion liquid
B pigment-containing PDL: Black pigment-containing polymer particle dispersion liquid
AC-AW62: Polymer-dispersing white pigment dispersion liquid

TABLE 1-7

| | | Solid content | | | | | |
|---|---|---|---|---|---|---|---|
| | | or active | | | | | |
| | | ingredient | P. Ex. | P. Ex. | P. Ex. | P. Ex. | P. Ex. |
| | | content | 1-31 | 1-32 | 1-33 | 1-34 | 1-35 |
| Components (% by mass) | | (% by mass) | Ink 31 | Ink 32 | Ink 33 | Ink 34 | Ink 35 |
| Colorant | Prep. Ex. 5: M | 15 | 26.67 | — | — | — | — |
| (pigment | pigment- | | | | | | |
| dispersion) | containing PDL | | | | | | |
| | Prep. Ex. 6: C | 15 | — | 26.67 | — | — | — |
| | pigment- | | | | | | |
| | containing PDL | | | | | | |
| | Prep. Ex. 7: Y | 15 | — | — | 26.67 | — | — |
| | pigment- | | | | | | |
| | containing PDL | | | | | | |
| | Prep. Ex. 8: B | 15 | — | — | — | 33.33 | — |
| | pigment- | | | | | | |
| | containing PDL | | | | | | |
| | AC-AW62 | 50 | — | — | — | — | 20.00 |
| Water- | TAKELAC ® | 30 | 36.36 | 36.36 | 36.36 | 36.36 | 36.36 |
| dispersible | WS-6021 | | | | | | |
| resin particles | | | | | | | |
| Crosslinking | ADEKA BONTIGHTER | 35 | 1.56 | 1.56 | 1.56 | 1.56 | 1.56 |
| agent | HUX-3861 | | | | | | |
| Organic | 2,2,4-trimethyl- | 100 | 2.00 | 3.00 | 3.00 | 1.00 | 2.00 |
| solvent 1 | 1,3-penanediol | | | | | | |
| (SP value: | (SP value: 10.8) | | | | | | |
| 9.0 to 11.8 | | | | | | | |
| (cal/cm³)^{1/2}) | | | | | | | |
| Organic | Glycerin (SP | 100 | 25.00 | 25.00 | 25.00 | 25.00 | 25.00 |
| solvent 2 | value: 16.38) | | | | | | |
| (wetting | Propylene glycol | 100 | 5.00 | 5.00 | 5.00 | 2.00 | 5.00 |
| agent) | (SP value: 13.72) | | | | | | |
| Surfactant | SURFYNOL 104E | 50 | 0.50 | 0.50 | 0.55 | 0.50 | — |
| | UNIDYNE DSN403N | 100 | — | — | — | — | 0.02 |
| Preservative | PROXEL ® GXL | 20 | 0.05 | 0.05 | 0.05 | 0.05 | 0.05 |
| or fungicide | | | | | | | |
| Foaming | 2,4,7,9- | 100 | 0.10 | 0.10 | 0.10 | 0.10 | — |
| inhibitor | tetramethyldecane- | | | | | | |
| (defoaming agent) | 4,7-diol | | | | | | |

| | | | | | | |
|---|---|---|---|---|---|---|
| Ultrapure water | — | balance | balance | balance | balance | balance |
| Total (% by mass) | — | 100 | 100 | 100 | 100 | 100 |

In Table 1-7, the abbreviations denote as follows.

### P. Ex.: Production Example

M pigment-containing PDL: Magenta pigment-containing polymer particle dispersion liquid
C pigment-containing PDL: Cyan pigment-containing polymer particle dispersion liquid
Y pigment-containing PDL: Yellow pigment-containing polymer particle dispersion liquid
B pigment-containing PDL: Black pigment-containing polymer particle dispersion liquid
AC-AW62: Polymer-dispersing white pigment dispersion liquid

TABLE 1-8

| | | Solid | | | | | |
|---|---|---|---|---|---|---|---|
| | | content or | | | | | |
| | | active | | | | | |
| | | ingredient | P. Ex. | P. Ex. | P. Ex. | P. Ex. | P. Ex. |
| | | content | 1-36 | 1-37 | 1-38 | 1-39 | 1-40 |
| Components (% by mass) | | (% by mass) | Ink 36 | Ink 37 | Ink 38 | Ink 32 | Ink 40 |
| Colorant | Prep. Ex. 1: Surface | 20 | — | — | — | 25.00 | — |
| (pigment | modified black | | | | | | |
| dispersion) | pigment dispersion | | | | | | |
| | Prep. Ex. 2: Surface | 20 | 20.00 | — | — | — | — |
| | modified magenta | | | | | | |
| | pigment dispersion | | | | | | |
| | Prep. Ex. 3: Surface | 20 | — | 15.00 | — | — | — |
| | modified cyan | | | | | | |
| | pigment dispersion | | | | | | |
| | Prep. Ex. 4: Surface | 20 | — | — | 15.00 | — | — |
| | modified yellow | | | | | | |
| | pigment dispersion | | | | | | |
| | Prep. Ex. 9: | 50 | — | — | — | — | 16.00 |
| | Polymer-dispersing | | | | | | |
| | white pigment | | | | | | |
| | dispersion liquid | | | | | | |
| Water- | SUPERFLEX 470 | 38 | 23.68 | 23.68 | 23.68 | 23.68 | 26.32 |
| dispersible | | | | | | | |
| resin | | | | | | | |
| particles | | | | | | | |
| Crosslinking | ERASTRON ® E-37 | 28 | 8.04 | 8.04 | 8.04 | 8.04 | 8.93 |
| agent | | | | | | | |
| Organic | 2-ethyl-1,3- | 100 | 2.00 | 2.00 | 2.00 | 2.00 | 2.00 |
| solvent 1 | hexanediol | | | | | | |
| (SP value: | (SP value: | | | | | | |
| 9.0 to 11.8 | 10.6) | | | | | | |
| (cal/cm³) ^{1/2}) | | | | | | | |
| Organic | Glycerin | 100 | 21.00 | 23.00 | 23.00 | 20.00 | 21.00 |
| solvent 2 | (SP value: | | | | | | |
| (wetting | 16.38) | | | | | | |
| agent) | 1,3-butanediol | 100 | 10.50 | 11.50 | 11.50 | — | 10.50 |
| | (SP value: 13.78) | | | | | | |
| | 3-ethyl-1,3- | 100 | — | — | — | 10.00 | — |
| | butanediol | | | | | | |
| | (SP value: | | | | | | |
| | 12.05) | | | | | | |
| Surfactant | UNIDYNE DSN403N | 100 | 0.08 | 0.08 | 0.082 | 0.04 | 0.08 |
| Preservative | PROXEL ® | 20 | 0.05 | 0.05 | 0.05 | 0.05 | 0.05 |
| or fungicide | GXL | | | | | | |
| Foaming | 2,5,8,11- | 100 | 0.32 | 0.32 | 0.33 | 0.16 | 0.32 |
| inhibitor | tetramethyldodecane- | | | | | | |
| (defoaming | 5,8-diol | | | | | | |
| agent) | | | | | | | |
| pH regulator | 2-amino-2-ethyl- | 100 | 0.30 | 0.30 | 0.30 | 0.40 | 0.30 |
| | 1,3-propanediol | | | | | | |

| | | | | | | |
|---|---|---|---|---|---|---|
| Ultrapure water | — | balance | balance | balance | balance | balance |
| Total (% by mass) | — | 100 | 100 | 100 | 100 | 100 |

In Table 1-8, the abbreviations denote as follows.

### P. Ex.: Production Example

TABLE 1-9

| | | Solid | | | | | |
|---|---|---|---|---|---|---|---|
| | | content or | | | | | |
| | | active- | | | | | |
| | | ingredient | P. Ex. | P. Ex. | P. Ex. | P. Ex. | P. Ex. |
| | | content | 1-41 | 1-42 | 1-43 | 1-44 | 1-45 |
| Components (% by mass) | | (% by mass) | Ink 41 | Ink 42 | Ink 43 | Ink 44 | Ink 45 |
| Colorant | Prep. Ex. 5: M | 15 | 26.67 | — | — | — | — |
| (pigment | pigment- | | | | | | |
| dispersion) | containing PDL | | | | | | |
| | Prep. Ex. 6: C | 15 | — | 26.67 | — | — | — |
| | pigment- | | | | | | |
| | containing PDL | | | | | | |
| | Prep. Ex. 7: Y | 15 | — | — | 26.67 | — | — |
| | pigment- | | | | | | |
| | containing PDL | | | | | | |
| | Prep. Ex. 8: B | 15 | — | — | — | 33.33 | — |
| | pigment- | | | | | | |
| | containing PDL | | | | | | |
| | AC-AW62 | 50 | — | — | — | — | 20.00 |
| Water- | SUPERFLEX 460 | 38 | 26.32 | 26.32 | 26.32 | 26.32 | 26.32 |
| dispersible | | | | | | | |
| resin | | | | | | | |
| particles | | | | | | | |
| Organic | 2,2,4- | 100 | 2.00 | 3.00 | 3.00 | 2.00 | 2.00 |
| solvent 1 | trimethyl-1,3- | | | | | | |
| (SP value: | penanediol | | | | | | |
| 9.0 to 11.8 | (SR value: | | | | | | |
| (cal/cm³) ^{1/2}) | 10.8) | | | | | | |
| Organic | Glycerin | 100 | 25.00 | 25.00 | 25.00 | 25.00 | 25.00 |
| solvent 2 | (SP value: | | | | | | |
| (wetting | 16.38) | | | | | | |
| agent) | Propylene- | 100 | 5.00 | 5.00 | 5.00 | 2.00 | 5.00 |
| | glycol | | | | | | |
| | (SP value: | | | | | | |
| | 13.72) | | | | | | |
| Preservative | PROXEL ® | 20 | 0.05 | 0.05 | 0.05 | 0.05 | 0.05 |
| or fungicide | GXL | | | | | | |
| Foaming | 2,4,7,9- | 100 | 0.12 | 0.10 | 0.08 | 0.11 | 0.10 |
| inhibitor | tetramethyldecane- | | | | | | |
| (defoaming agent) | 4,7-diol | | | | | | |

| | | | | | | |
|---|---|---|---|---|---|---|
| Ultrapure water | — | balance | balance | balance | balance | balance |
| Total (% by mass) | — | 100 | 100 | 100 | 100 | 100 |

In Table 1-9, the abbreviations denote as follows.

### P. Ex.: Production Example

M pigment-containing PDL: Magenta pigment-containing polymer particle dispersion liquid
C pigment-containing PDL: Cyan pigment-containing polymer particle dispersion liquid
Y pigment-containing PDL: Yellow pigment-containing polymer particle dispersion liquid
B pigment-containing PDL: Black pigment-containing polymer particle dispersion liquid
AC-AW62: Polymer-dispersing white pigment dispersion liquid

TABLE 1-10

| | | Solid | | | | | |
|---|---|---|---|---|---|---|---|
| | | content or | | | | | |
| | | active | | | | | |
| | | ingredient | P. Ex. | P. Ex. | P. Ex. | P. Ex. | P. Ex. |
| | | content | 1-46 | 1-47 | 1-48 | 1-49 | 1-50 |
| Components (% by mass) | | (% by mass) | Ink 46 | Ink 47 | Ink 48 | Ink 49 | Ink 50 |
| Colorant | Prep. Ex. 5: M | 15 | 26.67 | — | — | — | — |
| (pigment | pigment- | | | | | | |
| dispersion) | containing PDL | | | | | | |
| | Prep. Ex. 6: C | 15 | — | 26.67 | — | — | — |
| | pigment- | | | | | | |
| | containing PDL | | | | | | |
| | Prep. Ex. 7: Y | 15 | — | — | 26.67 | — | — |
| | pigment- | | | | | | |
| | containing PDL | | | | | | |
| | Prep. Ex. 8: B | 15 | — | — | — | 33.33 | — |
| | pigment- | | | | | | |
| | containing PDL | | | | | | |
| | Prep. Ex. 9: | 50 | — | — | — | — | 16.00 |
| | Polymer- | | | | | | |
| | dispersing white | | | | | | |
| | pigment | | | | | | |
| | dispersion liquid | | | | | | |
| Water- | SUPERFLEX 470 | 38 | 26.32 | 26.32 | 26.32 | 26.32 | 26.32 |
| dispersible | | | | | | | |
| resin | | | | | | | |
| particles | | | | | | | |
| Crosslinking | ERASTRON ® E-37 | 28 | 7.14 | 7.14 | 7.14 | 7.14 | 7.14 |
| agent | | | | | | | |
| Organic solvent 1 | 2,2,4-trimethyl- | 100 | 2.00 | 2.00 | 2.00 | 2.00 | 2.00 |
| (SP value: | 1,3-penanediol | | | | | | |
| 9.0 to 11.8 | (SR value: | | | | | | |
| (cal/cm³) ^{1/2}) | 10.8) | | | | | | |
| Organic | Glycerin | 100 | 26.50 | 27.00 | 24.00 | 19.50 | 24.99 |
| solvent 2 | (SP value: | | | | | | |
| (wetting | 16.38) | | | | | | |
| agent) | 3-ethyl-1,3- | 100 | 5.00 | 5.00 | 7.00 | 7.50 | 5.00 |
| | butanediol | | | | | | |
| | (SP value: | | | | | | |
| | 12.05) | | | | | | |
| Surfactant | Compound | 100 | 0.30 | 0.30 | 0.30 | 0.30 | 0.33 |
| | represented by | | | | | | |
| | Structural | | | | | | |
| | Formula (8) | | | | | | |
| Preservative | PROXEL ® | 20 | 0.05 | 0.05 | 0.05 | 0.05 | 0.05 |
| or fungicide | GXL | | | | | | |
| Foaming | 2,4,7,9- | 100 | 0.30 | 0.30 | 0.30 | 0.30 | 0.40 |
| inhibitor | tetramethyldecane- | | | | | | |
| (defoaming agent) | 4,7-diol | | | | | | |
| pH regulator | 2-amino-2-ethyl- | 100 | 0.20 | 0.20 | 0.20 | 0.20 | 0.20 |
| | 1,3-propanediol | | | | | | |

| | | | | | | |
|---|---|---|---|---|---|---|
| Ultrapure water | — | balance | balance | balance | balance | balance |
| Total (% by mass) | — | 100 | 100 | 100 | 100 | 100 |

In Table 1-10, the abbreviations denote as follows.

### P. Ex.: Production Example

M pigment-containing PDL: Magenta pigment-containing polymer particle dispersion liquid
C pigment-containing PDL: Cyan pigment-containing polymer particle dispersion liquid
Y pigment-containing PDL: Yellow pigment-containing polymer particle dispersion liquid
B pigment-containing PDL: Black pigment-containing polymer particle dispersion liquid
AC-AW62: Polymer-dispersing white pigment dispersion liquid

### <Physical Properties of White Ink and Color Ink>

Various physical properties, such as viscosity, pH, static surface tension, and dynamic surface tension, of Inks 1 to 50 obtained in Production Examples 1-1 to 1-50 were measured. The results are presented in Tables 2-1 and 2-2 below.

### —Viscosity—

The viscosity of each of Inks 1 to 50 obtained in Production Examples 1-1 to 1-50 was measured at 25° C. by means of a viscometer (RE85L, available from Toki Sangyo Co., Ltd.).

—pH—

The pH of each of Inks 1 to 50 obtained in Production Examples 1-1 to 1-50 was measured at 25° C. by means of a pH meter (HM-30R, available from DKK-TOA CORPORATION).

### —Static Surface Tension—

The static surface tension of each of Inks 1 to 50 obtained in Production Examples 1-1 to 1-50 was measured at 25° C. by means of an automatic surface tensiometer (DY-300, available from Kyowa Interface Science Co., Ltd.) according to the plate method (the Wilhelmy plate method).

### —Dynamic Surface Tension—

The dynamic surface tensions of each of Inks 1 to 50 obtained in Production Examples 1-1 to 1-50 at the bubble lifetime of 15 msec, 150 msec, and 1,500 msec according to the maximum bubble pressure method, respectively, were measured at 25° C. by means of a portable dynamic surface tensiometer (SITA Pro line t15, available from EKO INSTRUMENTS CO., LTD.).

In the column “relationship of dynamic surface tension between color inks (15 msec)” of Tables 2-1 and 2-2 below, “B” denotes a black ink, “C” denotes a cyan ink, “M” denotes a magenta ink, and “Y” denotes a yellow ink.

TABLE 2-1

| | | Physical properties of ink | | | | | | |
|---|---|---|---|---|---|---|---|---|
| | | | | | | | | relation of |
| | | | | static | dynamic surface | | | dynamic surface |
| | | | | surface | tension (mN/m) | | | tension between |
| | | viscosity | | tension | 15 | 150 | 1,500 | color inks |
| Ink | Color | (mPa · s) | pH | (mN/m) | msec | msec | msec | (15 msec) |
| 1 | magenta | 11.42 | 7.96 | 42.6 | 53.9 | 44.6 | 42.7 | Y > B > C > M |
| 2 | cyan | 11.25 | 7.98 | 42.7 | 54.0 | 44.7 | 42.8 | |
| 3 | yellow | 11.29 | 7.85 | 43.6 | 54.7 | 45.5 | 43.7 | |
| 4 | black | 11.37 | 8.19 | 43.1 | 54.5 | 45.3 | 43.3 | |
| 5 | white | 11.20 | 8.30 | 43.0 | 54.2 | 45.0 | 43.1 | |
| 6 | magenta | 11.32 | 8.01 | 42.1 | 53.8 | 44.5 | 42.6 | Y > B > C > M |
| 7 | cyan | 11.18 | 8.03 | 42.2 | 53.9 | 44.5 | 42.8 | |
| 8 | yellow | 11.26 | 7.94 | 42.9 | 54.6 | 45.4 | 43.5 | |
| 9 | black | 11.33 | 8.22 | 42.6 | 54.3 | 45.2 | 43.1 | |
| 10 | white | 11.11 | 8.38 | 42.4 | 54.1 | 44.9 | 42.8 | |
| 11 | magenta | 10.82 | 8.71 | 26.8 | 38.5 | 31.0 | 27.8 | B > C > M ≥ Y |
| 12 | cyan | 11.03 | 8.35 | 26.9 | 38.7 | 31.1 | 28.0 | |
| 13 | yellow | 11.44 | 9.12 | 26.7 | 38.5 | 30.9 | 27.6 | |
| 14 | black | 10.65 | 9.04 | 27.0 | 39.1 | 31.6 | 28.3 | |
| 15 | white | 11.45 | 9.18 | 26.6 | 38.5 | 30.7 | 27.4 | |
| 16 | magenta | 10.79 | 8.70 | 26.7 | 38.4 | 30.9 | 27.7 | B > C > M ≥ Y |
| 17 | cyan | 11.00 | 8.32 | 26.8 | 38.6 | 31.0 | 27.9 | |
| 18 | yellow | 11.42 | 9.11 | 26.5 | 38.4 | 30.8 | 27.4 | |
| 19 | black | 10.62 | 9.01 | 26.9 | 39.0 | 31.5 | 28.2 | |
| 20 | white | 11.43 | 9.10 | 26.5 | 38.4 | 30.6 | 27.3 | |
| 21 | magenta | 10.82 | 8.82 | 24.0 | 38.4 | 31.6 | 27.5 | Y > B > C ≥ M |
| 22 | cyan | 10.51 | 8.55 | 24.4 | 38.6 | 31.7 | 27.7 | |
| 23 | yellow | 10.87 | 9.23 | 25.9 | 39.1 | 32.5 | 29.5 | |
| 24 | black | 10.95 | 9.28 | 24.5 | 38.7 | 31.8 | 27.8 | |
| 25 | white | 8.59 | 9.33 | 27.2 | 39.5 | 32.7 | 29.7 | |

TABLE 2-2

| | | Physical properties of ink | | | | | | |
|---|---|---|---|---|---|---|---|---|
| | | | | | | | | relation of |
| | | | | static | dynamic surface | | | dynamic surface |
| | | | | surface | tension (mN/m) | | | tension between |
| | | viscosity | | tension | 15 | 150 | 1,500 | color inks |
| Ink | Color | (mPa · s) | pH | (mN/m) | msec | msec | msec | (15 msec) |
| 26 | magenta | 10.75 | 9.32 | 25.8 | 39.1 | 31.2 | 27.7 | B > C > M ≥ Y |
| 27 | cyan | 10.90 | 9.24 | 26.1 | 39.3 | 31.3 | 27.8 | |
| 28 | yellow | 10.65 | 9.15 | 25.6 | 39.0 | 31.0 | 27.4 | |
| 29 | black | 10.66 | 9.16 | 26.3 | 39.8 | 31.9 | 28.1 | |
| 30 | white | 10.47 | 9.16 | 25.9 | 39.2 | 31.0 | 27.4 | |
| 31 | magenta | 11.46 | 7.97 | 35.9 | 49.9 | 38.2 | 34.9 | M > C > B > Y |
| 32 | cyan | 11.33 | 8.00 | 35.0 | 48.4 | 38.4 | 35.8 | |
| 33 | yellow | 11.41 | 7.86 | 35.0 | 44.8 | 36.1 | 34.2 | |
| 34 | black | 11.64 | 8.22 | 35.7 | 46.9 | 37.6 | 35.6 | |
| 35 | white | 11.25 | 8.33 | 31.2 | 59.1 | 48.9 | 37.8 | |
| 36 | magenta | 8.60 | 9.51 | 21.9 | 36.5 | 30.5 | 28.3 | B > M > C > Y |
| 37 | cyan | 8.54 | 9.40 | 21.7 | 36.2 | 30.0 | 28.0 | |
| 38 | yellow | 8.51 | 9.45 | 21.6 | 36.0 | 29.9 | 27.8 | |
| 39 | black | 8.65 | 9.63 | 22.4 | 36.9 | 30.8 | 28.7 | |
| 40 | white | 8.92 | 9.56 | 22.0 | 36.5 | 30.6 | 28.4 | |
| 41 | magenta | 11.12 | 7.96 | 44.3 | 55.9 | 48.2 | 44.9 | M > B > C > Y |
| 42 | cyan | 10.98 | 7.98 | 42.4 | 53.4 | 46.0 | 42.8 | |
| 43 | yellow | 11.06 | 7.85 | 40.5 | 51.8 | 43.6 | 41.2 | |
| 44 | black | 11.13 | 8.19 | 43.9 | 54.7 | 45.6 | 43.6 | |
| 45 | white | 10.91 | 8.30 | 42.7 | 54.1 | 44.9 | 42.8 | |
| 46 | magenta | 10.72 | 8.94 | 27.2 | 40.5 | 34.2 | 29.2 | Y > B > C > M |
| 47 | cyan | 10.44 | 8.88 | 27.5 | 40.8 | 34.6 | 23.6 | |
| 48 | yellow | 10.72 | 9.033 | 27.3 | 41.2 | 34.9 | 29.8 | |
| 49 | black | 10.88 | 9.08 | 27.3 | 40.9 | 34.6 | 29.5 | |
| 50 | white | 8.65 | 9.13 | 26.0 | 39.6 | 33.3 | 28.7 | |

Pre-processing fluids were prepared according to the methods described in Production Examples 2-1 to 2-12 below.

### Production Example 2-1: Production of Pre-Processing Fluid 1

Magnesium sulfate was weighed and collected in a glass beaker by 12.50 parts by mass. After adding 50.00 parts by mass of ultrapure water to the beaker, the resultant mixture was stirred for 5 minutes. Subsequently, 3.00 parts by mass of propylene glycol, 17.14 parts by mass of a nonionic resin emulsion (TAKELAC (registered trademark) W-635), 0.05 parts by mass of preservative or fungicide (PROXEL(registered trademark) GXL), and 0.10 parts by mass of 1,2,3-benzotriazole were added, and the resultant mixture was mixed and stirred for 15 minutes. Moreover, ultrapure water was added to make a total amount of the entre mixture 100 parts by mass, and the resultant mixture was mixed and stirred for 10 minutes. Pressure filtration was performed on the resultant mixture with a polyvinylidene fluoride membrane filter having the average pore diameter of 5.0 μm to remove dust, such as insoluble matter, to thereby obtain Pre-Processing Fluid 1.

### Production Examples 2-2 to 2-12: Production of Pre-Processing Fluids 2 to 12

Pre-Processing Fluids 2 to 12 were each obtained in the same manner as in Production Example 2-1, except that the formulation of the pre-processing fluid was changed to the materials and amounts presented in Tables 3-1-1 to 3-2-2.

In Tables 3-1-1 to 3-2-2, the unit of an amount of each material is “% by mass,” and the presented amount is based on a total amount, not just the amount of solids or the amount of the active ingredient content.

The details of the materials presented in Tables 3-1-1 to 3-2-2 are as follows.

### —Cationic Polymer—

SHALLOL (registered trademark) DC-902P: polydimethyl diallyl ammonium chloride (solid content: 51.0% by mass) available from DKS Co., Ltd.
DK6810: polyamine resin (solid content: 55.0% by mass) available from SEIKO PMC CORPORATION

### —Nonionic Resin Particles—

TAKELAC (registered trademark) W-635: polyurethane emulsion (solid content: 35% by mass) available from Mitsui Chemicals, Inc.
SUMIKAFLEX-850HQ: ethylene-vinyl acetate-vinyl chloride copolymer (solid content: 50% by mass) available from SUMITOMO CHEMICAL COMPANY, LIMITED
SUMIKAFLEX-951HQ: ethylene-vinyl acetate-vinyl versatate copolymer (solid content: 55% by mass) available from SUMITOMO CHEMICAL COMPANY, LIMITED

### —Wax—

AQUACER 497: paraffin wax (active ingredient: 50% by mass) available from BYK Japan K.K.
AQUACER 539: modified paraffin wax (active ingredient: 35% by mass) available from BYK Japan K. K.
AQUACER 531: modified polyethylene wax (active ingredient: 45% by mass) available from BYK Japan K.K.

### —Preservative or Fungicide—

PROXEL(registered trademark) GXL: preservative or fungicide including 1,2-benzothiazolin-3-one as a main ingredient (active ingredient: 20%, dipropylene glycol included) available from Nitto Denko Avecia Inc.

TABLE 3-1-1

| | | | Solid | | | |
|---|---|---|---|---|---|---|
| | | | content or | Production | Production | Production |
| | | | active | Ex. 2-1 | Ex. 2-2 | Ex. 2-3 |
| | | | ingredient, | Pre- | Pre- | Pre- |
| | | | content | Processing | Processing | Processing |
| Components (% by mass) | | | (% by mass) | Fluid 1 | Fluid 2 | Fluid 3 |
| Flocculant | organic acid | ammonium | 100 | — | — | — |
| | ammonium salt | lactate | | | | |
| | organic acid | calcium | 100 | — | — | — |
| | metal salt | lactate | | | | |
| | inorganic | mgnesium | 100 | 12.50 | — | 12.50 |
| | metal | sulfate | | | | |
| | salt | calcium | 100 | — | — | — |
| | | chloride | | | | |
| | cationic | SHALLOL ® | 51 | — | 19.61 | — |
| | polymer | DC-902P | | | | |
| | | DK6810 | 55 | — | — | — |

| | | | | | |
|---|---|---|---|---|---|
| Nonionic emulsion | TAKELAC ® | 35 | 17.14 | — | 17.14 |
| | W-635 | | | | |
| | SUMIKAFLEX | 50 | — | 12.00 | — |
| | 850HQ | | | | |
| | SUMIKAFLEX | 54.6 | — | — | — |
| | 951HQ | | | | |
| Organic solvent | propylene | 100 | 3.00 | — | 3.00 |
| | glycol | | | | |
| Wax particles | AQUACER497 | 50 | — | — | 2.00 |
| | AQUACER539 | 35 | — | — | — |
| | AQUACER531 | 45 | — | — | — |
| Preservatve | PROXEL ® | 20 | 0.05 | 0.05 | 0.05 |
| or fungicide | GXL | | | | |
| Corrosion inhibitor | 1,2,3- | 100 | 0.10 | 0.10 | 0.10 |
| | benzotriazole | | | | |

| | | | | |
|---|---|---|---|---|
| Ultrapure water | — | balance | balance | balance |
| Total (% by mass) | — | 100 | 100 | 100 |

TABLE 3-1-2

| | | | Solid | | | |
|---|---|---|---|---|---|---|
| | | | content or | Production | Production | Production |
| | | | active | Ex. 2-4 | Ex. 2-5 | Ex. 2-6 |
| | | | ingredient | Pre- | Pre- | Pre- |
| | | | content | Processing | Processing | Processing |
| Components (% by mass) | | | (% by mass) | Fluid 4 | Fluid 5 | Fluid 6 |
| Flocculant | organic acid | ammonium | 100 | — | — | — |
| | ammonium salt | lactate | | | | |
| | organic acid | calcium | 100 | — | — | — |
| | metal salt | lactate | | | | |
| | inorganic | mgnesium | 100 | — | — | — |
| | metal | sulfate | | | | |
| | salt | calcium | 100 | — | 15.00 | — |
| | | chloride | | | | |
| | cationic | SHALLOL ® | 51 | 19.61 | — | — |
| | polymer | DC-902P | | | | |
| | | DK6810 | 55 | — | — | 22.73 |

| | | | | | |
|---|---|---|---|---|---|
| Nonionic emulsion | TAKELAC ® | 35 | — | — | — |
| | W-635 | | | | |
| | SUMIKAFLEX | 50 | 12.00 | 20.00 | — |
| | 850HQ | | | | |
| | SUMIKAFLEX | 54.6 | — | — | 13.64 |
| | 951HQ | | | | |
| Organic solvent | propylene | 100 | — | — | — |
| | glycol | | | | |
| Wax particles | AOUACER497 | 50 | 1.00 | — | — |
| | AQUACER539 | 35 | 1.43 | — | — |
| | AQUACER531 | 45 | — | — | — |
| Preservatve | PROXEL ® | 20 | 0.05 | 0.05 | 0.05 |
| or fungicide | GXL | | | | |
| Corrosion inhibitor | 1,2,3- | 100 | 0.10 | 0.10 | 0.10 |
| | benzotriazole | | | | |

| | | | | |
|---|---|---|---|---|
| Ultrapure water | — | balance | balance | balance |
| Total (% by mass) | — | 100 | 100 | 100 |

TABLE 3-2-1

| | | | Solid | | | |
|---|---|---|---|---|---|---|
| | | | content or | Production | Production | Production |
| | | | active | Ex. 2-7 | Ex. 2-8 | Ex. 2-9 |
| | | | ingredient | Pre- | Pre- | Pre- |
| | | | conent | Processing | Processing | Processing |
| Components (% by mass) | | | (% by mass) | Fluid 7 | Fluid 8 | Fluid 9 |
| Flocculant | organic acid | ammonium | 100 | — | — | — |
| | ammonium salt | lactate | | | | |
| | organic acid | calcium | 100 | — | — | — |
| | metal salt | lactate | | | | |
| | inorganic | magnesium | 100 | — | — | — |
| | metal | sulfate | | | | |
| | salt | calcium | 100 | 15.00 | — | 15.00 |
| | | chloride | | | | |
| | cationic | SHALLOL ® | 51 | — | — | — |
| | polymer | DC-902P | | | | |
| | | DK6810 | 55 | — | 22.73 | — |

| | | | | | |
|---|---|---|---|---|---|
| Nonionic resin | TAKELAC ® | 35 | — | — | — |
| emulsion | W-635 | | | | |
| | SUMIKAFLEX | 50 | 20.00 | — | 20.00 |
| | 850HQ | | | | |
| | SUMIKAFLEX | 54.6 | — | 13.64 | — |
| | 951HQ | | | | |
| Organic solvent | propylene | 100 | — | — | — |
| | glycol | | | | |
| Wax particles | AQUACER497 | 50 | 5.00 | — | — |
| | AQUACER539 | 35 | — | 5.71 | — |
| | AQUACER531 | 45 | — | — | — |
| Preservative | PROXEL ® | 20 | 0.05 | 0.05 | 0.05 |
| or fungicide | GXL | | | | |
| Corrosion inhibitor | 1,2,3- | 100 | 0.10 | 0.10 | 0.10 |
| | benzotriazole | | | | |

| | | | | |
|---|---|---|---|---|
| Ultrapure water | — | balance | balance | balance |
| Total (% by mass) | — | 100 | 100 | 100 |

TABLE 3-2-2

| | | | Solid | | | |
|---|---|---|---|---|---|---|
| | | | concent or | Production | Production | Production |
| | | | active | Ex. 2-10 | Ex. 2-11 | Ex. 2-12 |
| | | | ingredient | Pre- | Pre- | Pre- |
| | | | conent | Processing | processing- | Processing |
| Components (% by mass) | | | (% by mass) | Fluid 10 | Fluid 11 | Fluid 12 |
| Flocculant | organic acid | ammonium | 100 | — | 15.00 | — |
| | ammonium salt | lactate | | | | |
| | organic acid | calcium | 100 | — | — | 15.00 |
| | metal salt | lactate | | | | |
| | inorganic | magnesium | 100 | — | — | — |
| | metal | sulfate | | | | |
| | salt | calcium | 100 | 15.00 | — | — |
| | | chloride | | | | |
| | cationic | SHALLOL ® | 51 | — | — | — |
| | polymer | DC-902P | | | | |
| | | DK6810 | 55 | — | — | — |

| | | | | | |
|---|---|---|---|---|---|
| Nonionic resin | TAKELAC ® | 35 | — | 17.14 | 17.14 |
| emulsion | W-635 | | | | |
| | SUMIKAFLEX | 50 | 20.00 | — | — |
| | 850HQ | | | | |
| | SUMIKAFLEX | 54.6 | — | — | — |
| | 951HQ | | | | |
| Organic solvent | propylene | 100 | — | — | — |
| | glycol | | | | |
| Wax particles | AQUACER497 | 50 | — | — | — |
| | AQUACER539 | 35 | — | — | — |
| | AQUACER531 | 45 | 5.55 | — | — |
| Preservative | PROXEL ® | 20 | 0.05 | 0.05 | 0.05 |
| or fungicide | GXL | | | | |
| Corrosion inhibitor | 1,2,3- | 100 | 0.10 | 0.10 | 0.10 |
| | benzotriazole | | | | |

| | | | | |
|---|---|---|---|---|
| Ultrapure water | — | balance | balance | balance |
| Total (% by mass) | — | 100 | 100 | 100 |

Image formation using the ink set was performed according to the methods described in Example 1 to 16 and Comparative Examples 1 to 7 below.

### Examples 1 to 14 and Comparative Examples 1 to 7

An inkjet printer (Direct to Garment Printer RICOH Ri 6000, available from Ricoh Company Limited) was set to deposit the same amount of an ink on a recording medium with varying driving voltage of a piezoelectric element to make an ejection amount of the ink identical in an atmosphere adjusted to 23° C.±0.5° C., and 50% RH±5% RH.

First, the predetermined pre-processing fluid was applied to the predetermined recording medium by the predetermined application method (i.e., the coating method) to give the predetermined deposition amount of the pre-processing fluid as presented in Tables 4-1-1 and 4-2-1 below. Thereafter, the recording medium was dried. When the recording medium was a dark color polyester T-shirt (00300-ACT), the recording medium was dried in an oven at 130° C. for 90 seconds. When the recording medium was a dark color cotton T-shirt (00085-CVT), the recording medium was dried in an oven at 165° C. for 90 seconds.

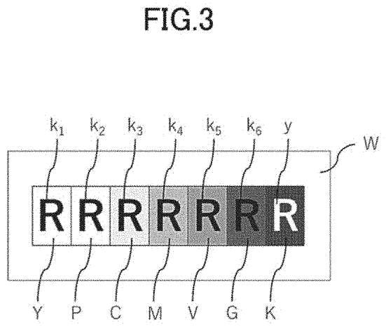

Next, the white ink and the color ink included in the predetermined ink set presented in Tables 4-1-1 and 4-2-1 were each set in the inkjet printer. The white ink was applied to the area of the recording medium, to which the pre-processing fluid had been applied, with the predetermined deposition amount presented in Tables 4-1-2 and 4-2-2. Seventeen seconds after the application of the white ink to the recording medium, the color ink was applied to the area of the recording medium, to which the white ink had been applied, with the predetermined deposition amount presented in Tables 4-1-2 and 4-2-2, to print a chart depicted in FIG. 3.

Heating of the recording medium was not performed during a period between the application of the white ink and the application of the color ink.

Next, the recording medium was heated to obtain a sample image. When the recording medium on which the chart depicted in FIG. 3 was printed was the dark-color polyester T-shirt (00300-ACT), the recording medium was dried in an oven at 130° C. for 3 minutes. When the recording medium on which the chart depicted in FIG. 3 was printed was the dark color cotton T-shirt (00085-CVT), the recording medium was heated in an oven at 165° C. for 2 minutes.

In FIG. 3, “W” is a white solid image section formed as a base, “Y” is a yellow solid image section formed on the base W, “M” is a red solid image section formed on the base W, “C” is a cyan solid image section formed on the base W, “P” is a magenta solid image section formed on the base W, “V” is a blue solid image section formed on the base W, “G” is a green solid image section formed on the base W, “K” is a black solid image section formed on the base W, “k₁” to “k₆” are each a black letter “R” formed on the base W, and “y” is a yellow letter “R” formed on the base W. Moreover, the chart depicted in FIG. 3 is formed based on the image digitalized without color collection using a software Photoshop (registered trademark) (available from Adobe (registered trademark)), and printed at 600 dpi×600 dpi.

### Example 15

A sample image was obtained in the same manner as in Example 1, except that the time span between the application of the white ink and the application of the color ink during printing of the sample image was changed from 17 seconds to 60 seconds.

### Example 16

A sample image was obtained in the same manner as in Example 1, except that the recording medium was dried in an oven at 165° C. for 90 seconds just after the application of white ink, followed by applying the color ink, without giving 17 seconds between the application of the white ink and the application of the color ink during printing of the sample image.

The details of the recording media presented in Tables 4-1-1 an 4-2-1 are as follows.

00300-ACT: dark color polyester T-shirt, glimmer (registered trademark) 00300-ACT Black, available from TOMS CO., LTD.
00085-CVT: dark color cotton T-shirt, Printstar (registered trademark) 00085-CVT Black, available from TOMS CO., LTD.

In Tables 4-1-2 and 4-2-2 below, “White ink-color ink time span” denotes the time span between the application of the white ink and the application of the color ink during printing of the sample image in Examples 1 to 16 and Comparative Examples 1 to 7.

In Tables 4-1-2 and 4-2-2, moreover, “Heating after white ink” denotes whether the heating step was performed after the application of the white ink but before the application of the color ink during printing of the sample image in Examples 1 to 16 and Comparative Examples 1 to 7. In the column of “heating after white ink,” the heating conditions (i.e., a temperature and duration) are presented when the heating step is “performed.”

TABLE 4-1-1

| | | | | Pre-processing fluid | | | |
|---|---|---|---|---|---|---|---|
| | | Recording medium | | Pre- | | Deposition | Ink set |
| | | Product | | Processing | Coating | amount | Ink |
| | | No. | Material | Fluid No. | method | (g/m²) | No. |
| Example | 1 | 00085-CVT | cotton | 1 | hand | 352 | 1 to 5 |
| | | | | | spray | | |
| | 2 | 00085-CVT | cotton | 2 | hand | 352 | 6 to 30 |
| | | | | | spray | | |
| | 3 | 00085-CVT | cotton | 3 | hand | 352 | 11 to 15 |
| | | | | | spray | | |
| | 4 | 00085-CVT | cotton | 4 | hand | 352 | 16 to 20 |
| | | | | | spray | | |
| | 5 | 00085-CVT | cotton | 5 | hand | 352 | 26 to 30 |
| | | | | | spray | | |
| | 6 | 00085-CVT | cotton | 6 | hand | 352 | 36 to 40 |
| | | | | | spray | | |
| | 7 | 00300-ACT | polyester | 5 | hand | 352 | 1 to 5 |
| | | | | | spray | | |
| | 8 | 00300-ACT | polyester | 6 | hand | 352 | 6 to 10 |
| | | | | | spray | | |
| | 9 | 00300-ACT | polyester | 7 | hand | 352 | 11 to 15 |
| | | | | | spray | | |
| | 10 | 00300-ACT | polyester | 8 | hand | 352 | 16 to 20 |
| | | | | | spray | | |
| | 11 | 00300-ACT | polyester | 9 | hand | 352 | 26 to 30 |
| | | | | | spray | | |
| | 12 | 00300-ACT | polyester | 10 | hand | 352 | 36 to 40 |
| | | | | | spray | | |
| | 13 | 00085-CVT | cotton | 11 | hand | 352 | 3 to 5 |
| | | | | | spray | | |
| | 14 | 00085-CVT | cotton | 12 | hand | 352 | 1 to 5 |
| | | | | | spray | | |
| | 15 | 00085-CVT | cotton | 1 | hand | 352 | 3 to 5 |
| | | | | | spray | | |
| | 16 | 00085-CVT | cotton | 1 | hand | 352 | 1 to 5 |
| | | | | | spray | | |

TABLE 4-1-2

| | | Deposition | Deposition | White ink- | |
|---|---|---|---|---|---|
| | | amount of | amount of | color ink | Heating |
| | | white ink | color ink | time span | step after |
| | | (g/m²) | (g/m²) | (sec) | white ink |
| Example | 1 | 220 | 19 ± 1 | 17 | Not performed |
| | 2 | 220 | 19 ± 1 | 17 | Not performed |
| | 3 | 220 | 19 ± 1 | 17 | Not performed |
| | 4 | 220 | 19 ± 1 | 17 | Not performed |
| | 5 | 220 | 19 ± 1 | 17 | Not performed |
| | 6 | 220 | 19 ± 1 | 17 | Not performed |
| | 7 | 220 | 19 ± 1 | 17 | Not performed |
| | 8 | 220 | 19 ± 1 | 17 | Not performed |
| | 9 | 220 | 19 ± 1 | 17 | Not performed |
| | 10 | 220 | 19 ± 1 | 17 | Not performed |
| | 11 | 220 | 19 ± 1 | 17 | Not performed |
| | 12 | 220 | 19 ± 1 | 17 | Not performed |
| | 13 | 220 | 19 ± 1 | 17 | Not performed |
| | 14 | 220 | 19 ± 1 | 17 | Not performed |
| | 15 | 220 | 19 ± 1 | 60 | Not performed |
| | 16 | 220 | 19 ± 1 | — | 165° C. 90 sec |

TABLE 4-2-1

| | | | | Pre-processing fluid | | | |
|---|---|---|---|---|---|---|---|
| | | Recording medium | | Pre- | | Deposition | Ink set |
| | | Product | | Processing | Coating | amount | Ink |
| | | No. | Material | Fluid No. | method | (g/m²) | No. |
| Comparative | 1 | 00085-CVT | cotton | 1 | hand | 352 | 21 to 25 |
| Example | | | | | spray | | |
| | 2 | 00085-CVT | cotton | 1 | hand | 352 | 31 to 35 |
| | | | | | spray | | |
| | 3 | 00085-CVT | cotton | 1 | hand | 352 | 41 to 45 |
| | | | | | spray | | |
| | 4 | 00300-ACT | polyester | 8 | hand | 352 | 21 to 25 |
| | | | | | spray | | |
| | 5 | 00300-ACT | polyester | 8 | hand | 352 | 31 to 35 |
| | | | | | spray | | |
| | 6 | 00300-ACT | polyester | 8 | hand | 352 | 41 to 45 |
| | | | | | spray | | |
| | 7 | 00085-CVT | cotton | 1 | hand | 352 | 46 to 50 |
| | | | | | spray | | |

TABLE 4-2-2

| | | Deposition | Deposition | White ink- | |
|---|---|---|---|---|---|
| | | amount of | amount of | color ink | Heating |
| | | white ink | color ink | time span | step after |
| | | (g/m²) | (g/m²) | (sec) | white ink |
| Comparative | 1 | 220 | 19 ± 1 | 17 | Not performed |
| Example | 2 | 220 | 19 ± 1 | 17 | Not performed |
| | 3 | 220 | 19 ± 1 | 17 | Not performed |
| | 4 | 220 | 19 ± 1 | 17 | Not performed |
| | 5 | 220 | 19 ± 1 | 17 | Not performed |
| | 6 | 220 | 19 ± 1 | 17 | Not performed |
| | 7 | 220 | 19 ± 1 | 17 | Not performed |

### <Evaluation of Sample Image>

The sample images obtained in Examples 1 to 16 and Comparative Examples 1 to 7 were each evaluated on the Hunter whiteness, color bleeding, beading, and rubbing fastness in the following manner. The results are presented in Tables 5-1 to 5-5.

### —Hunter Whiteness—

The color density was determined by measuring color values, Lab, of the white solid image section of each sample image obtained in Examples 1 to 16 and Comparative Examples 1 to 7 by means of a spectrophotometer (X-Rite eXact, available from X-Rite), and the Hunter whiteness was calculated according to Mathematical Equation (1) below. The results were evaluated based on the following evaluation criteria.

The image density was measured by placing the sample image on a stack of paper where 5 sheets of wood-free color paper, medium thickness black paper (available from Hokuetsu Corporation) were stacked.

Hunter whiteness=100−sqr[(100−L)²+(a²+b²)] Mathematical Equation (1)

### [Evaluation Criteria]

A+: The Hunter whiteness was 85 or greater.
A: The Hunter whiteness was 80 or greater and less than 85.
B: The Hunter whiteness was 75 or greater and less than 80.
C: The Hunter whiteness was 70 or greater and less than 75.
D: The Hunter whiteness was less than 70.

### —Color Bleeding—

On each sample image obtained in Examples 1 to 16 and Comparative Examples 1 to 7, the degree of color bleeding between the color solid image section and the white solid image section next to the color solid image section (e.g., bleeding at the color boundary between “W” and “Y” in FIG. 3), and the degree of color bleeding between one color solid image section, and another color solid image section next to the former color solid image section (e.g., bleeding at the color boundary between “K” and “y” or between “k₁” and “Y” in FIG. 3) were visually inspected by a specialist, and the results are evaluated based on the following criteria.

### [Evaluation Criteria]

A+: Bleeding did not occur at the color boundary.
A: Very slight bleeding occurred at the color boundary.
B: Slightly bleeding occurred at the color boundary.
C: Bleeding occurred at the color boundary.
D: Significant bleeding occurred at the color boundary.

### —Beading—

The degree of beading (uneven density) in the color solid image section of each sample image obtained in Examples 1 to 16 and Comparative Examples 1 to 7 was visually inspected by a specialist, and the results were evaluated based on the following evaluation criteria.

### [Evaluation Criteria]

A: There was no density unevenness.
B: Slight density unevenness was observed.
C: Density unevenness was observed.
D: Significant density unevenness was observed.

### —Rubbing Fastness—

The rubbing fastness test was performed by means of a Type I rubbing tester according to the Type I rubbing tester (clockmeter) method specified in JIS L 0849. The “dry rubbing” was tested according to the dry test specified in JIS L0849, and the “wet rubbing” was tested according to the wet test specified in JIS L0849. The results are evaluated based on the following evaluation criteria.

### [Evaluation Criteria]

A: The color of the rubbed sample was judged as Grade 4-5 to Grade 5
B: The color of the rubbed sample was judged as Grade 3-4 to Grade 4
C: The color of the rubbed sample was judged as Grade 2-3 to Grade 3
D: The color of the rubbed sample was judged as Grade 2 or lower

TABLE 5-1

| | | | Example | | | | | |
|---|---|---|---|---|---|---|---|---|
| | | | 1 | 2 | 3 | 4 | 5 | 6 |
| Recording medium | | | 00085-CVT | 00085-CVT | 00085-CVT | 00085-CVT | 00085-CVT | 00085-CVT |
| Pre-processing fluid No. | | | 1 | 2 | 3 | 4 | 5 | 6 |
| Ink set | Ink No. | | 1 to 5 | 6 to 10 | 11 to 15 | 16 to 20 | 26 to 30 | 36 to 40 |
| Static | Maximum difference | | 0.6 | 0.5 | 0.4 | 0.4 | 0.4 | 0.4 |
| surface | between white ink and | | | | | | | |
| tension | color ink (mN/m) | | | | | | | |
| Dynamic | Maximum | 15 msec | 0.5 | 0.5 | 0.6 | 0.6 | 0.6 | 0.5 |
| surface | difference | (mN/m) | | | | | | |
| tension | between | 150 msec | 0.5 | 0.5 | 0.9 | 0.9 | 0.9 | 0.7 |
| | white ink | (mN/m) | | | | | | |
| | and color | 1,500 msec | 0.6 | 0.7 | 0.9 | 0.9 | 0.7 | 0.6 |
| | ink | (mN/m) | | | | | | |
| | Relation | 15 msec | 0.8 | 0.8 | 0.6 | 0.6 | 0.8 | 0.9 |
| | between | (mN/m) | | | | | | |
| | color inks | | | | | | | |
| Evaluation | color bleeding | | A | A | A+ | A+ | A+ | A+ |
| results | beeding | | A | A | A | A | A | A |
| | Hunter whiteness | | A | A | A+ | A+ | A | A |
| | Rubbing | dry rubbing | A | A | A | A | A | A |
| | fastness | wet rubbing | B | A | A | A | A | A |

TABLE 5-2

| | | | Example | | | | | |
|---|---|---|---|---|---|---|---|---|
| | | | 7 | 8 | 9 | 10 | 11 | 12 |
| Recording medium | | | 00300-ACT | 00300-ACT | 00300-ACT | 00300-ACT | 00300-ACT | 00300-ACT |
| Pre-precessing fluid No. | | | 5 | 6 | 7 | 8 | 9 | 10 |
| Ink set | Ink No. | | 1 to 5 | 6 to 10 | 11 to 15 | 16 to 20 | 26 to 30 | 36 to 40 |
| Static | Maximum difference | | 0.6 | 0.5 | 0.4 | 0.4 | 0.4 | 0.4 |
| surface | between white ink and | | | | | | | |
| tension | color ink (mN/m) | | | | | | | |
| Dynamic | Maximum | 15 msec | 0.5 | 0.5 | 0.6 | 0.6 | 0.6 | 0.5 |
| surface | difference | (mN/m) | | | | | | |
| tension | between | 150 msec | 0.5 | 0.5 | 0.9 | 0.9 | 0.9 | 0.7 |
| | white ink | (mN/m) | | | | | | |
| | and color | 1,500 msec | 0.6 | 0.7 | 0.9 | 0.9 | 0.7 | 0.6 |
| | ink | (mN/m) | | | | | | |
| | Relation | 15 msec | 0.0 | 0.8 | 0.6 | 0.6 | 0.8 | 0.9 |
| | between | (mN/m) | | | | | | |
| | color inks | | | | | | | |
| Evaluation | Color bleeding | | A | A | A+ | A+ | A+ | A |
| results | Beading | | A | A | A | A | A | A |
| | Hunter whiteness | | B | B | A+ | A | B | A |
| | Rubbing | dry rubbing | A | A | A | A | A | A |
| | fastness | wet rubbing | B | A | B | B | A | A |

TABLE 5-3

| | | | Example | | | |
|---|---|---|---|---|---|---|
| | | | 13 | 14 | 15 | 16 |
| Recording medium | | | C0085-CVT | C0085-CVT | C0085-CVT | C0085-CVT |
| Pre-processing fluid No. | | | 11 | 12 | 1 | 1 |
| Ink set | Ink No. | | 1 to 5 | 1 to 5 | 1 to 5 | 1 to 5 |
| Static | Maximum difference | | 0.6 | 0.6 | 0.6 | 0.6 |
| surface | between white ink and | | | | | |
| tension | color ink (mN/m) | | | | | |
| Dynamic | Maximum | 15 msec | 0.5 | 0.5 | 0.5 | 0.5 |
| suface | difference | (mN/m) | | | | |
| tension | between | 150 msec | 0.5 | 0.5 | 0.5 | 0.5 |
| | white ink | (mN/m) | | | | |
| | and color | 1,500 msec | 0.6 | 0.6 | 0.6 | 0.6 |
| | ink | (mN/m) | | | | |
| | Relation | 15 msec | 0.8 | 0.8 | 0.8 | 0.8 |
| | between | (mN/m) | | | | |
| | color inks | | | | | |
| Evaluation | Color bleeding | | A | A | A+ | A |
| results | Beading | | A | A | A | A |
| | Hunter whiteness | | A | A | A | A |
| | Rubbing | dry rbbing | A | A | A | A |
| | fastness | wet rubbing | A | A | B | A |

TABLE 5-4

| | | | Comparative Example | | |
|---|---|---|---|---|---|
| | | | 1 | 2 | 3 |
| Recording medium | | | 00085- | 00085- | 00085- |
| | | | CVT | CVT | CVT |
| Pre-processing fluid No. | | | 1 | 1 | 1 |
| Ink set | Ink No. | | 21 to 25 | 31 to 35 | 41 to 45 |
| Static | Maximum difference | | 3.2 | 4.7 | 2.2 |
| surface | between white ink and | | | | |
| tension | color ink (mN/m) | | | | |
| Dynamic | Maximum | 15 msec | 1.1 | 14.3 | 2.3 |
| surface | difference | (mN/m) | | | |
| tension | between | 150 msec | 1.1 | 12.8 | 3.3 |
| | white ink | (mN/m) | | | |
| | and color | 1,500 msec | 2.2 | 3.6 | 2.1 |
| | ink | (mN/m) | | | |
| | Relation | 15 msec | 0.7 | 5.1 | 4.1 |
| | between | (mN/m) | | | |
| | color inks | | | | |
| Evaluation | Color bleeding | | C | D | D |
| results | Beading | | B | C | C |
| | Hunter whiteness | | A+ | A | A |
| | Rubbing | dry rubbing | A | A | C |
| | fastness | wet rubbing | B | B | D |

TABLE 5-5

| | | | Comparative Example | | | |
|---|---|---|---|---|---|---|
| | | | 4 | 5 | 6 | 7 |
| Recording medium | | | 00300-ACT | 00300-ACT | 00300-ACT | 00085-CVT |
| Pre-processing fluid No. | | | 8 | 8 | 8 | 1 |
| Ink set | Ink No. | | 21 to 25 | 31 to 35 | 41 to 45 | 46 to 50 |
| Static | Maximum difference | | 3.2 | 4.7 | 2.2 | 1.5 |
| surface | between white ink and | | | | | |
| tension | color ink (mN/m) | | | | | |
| Dynamic | Maximum | 15 msec | 1.1 | 14.3 | 2.3 | 1.6 |
| surface | difference | (mN/m) | | | | |
| tension | between | 150 msec | 1.1 | 12.8 | 3.3 | 1.6 |
| | white ink | (mN/m) | | | | |
| | and color | 1,500 msec | 2.2 | 3.6 | 2.1 | 1.1 |
| | ink | (mN/m) | | | | |
| | Relation | 15 msec | 0.7 | 5.1 | 4.1 | 0.7 |
| | between | (mN/m) | | | | |
| | color inks | | | | | |
| Evaluation | Color bleeding | | C | D | D | C |
| results | Beading | | D | C | C | B |
| | Hunter whiteness | | A | A | A | A |
| | Rubbing | dry rubbing | B | B | D | A |
| | fastness | wet rubbing | C | C | D | B |

For example, embodiments of the present disclosure are as follows.

<1> An ink set including:
a white ink; and
a color ink,
wherein the white ink and the color ink each independently include water-dispersible resin particles, and a blocked isocyanate compound, where a resin of the water-dispersible resin particles includes a crosslinkable functional group, and the blocked isocyanate compound includes a functional group that can crosslink with the resin of the water-dispersible resin particles,
wherein an absolute value of a difference in static surface tension between the white ink and the color ink at 25° C. is 1.0 mN/m or less, and
wherein an absolute value of a difference in dynamic surface tension between the white ink and the color ink at 25° C. with a bubble lifetime of 15 msec, an absolute value of a difference in dynamic surface tension between the white ink and the color ink at 25° C. with a bubble lifetime of 150 msec, and an absolute value of a difference in dynamic surface tension between the white ink and the color ink at 25° C. with a bubble lifetime of 1,500 msec are each independently 1.0 mN/m or less, where the bubble lifetime is a bubble lifetime measured according to the maximum bubble pressure method.
<2> The ink set according to <1>,
wherein the white ink and the color ink each independently include 0.1 parts by mass through 0.55 parts by mass of the blocked isocyanate compound relative to 1 part by mass of the water-dispersible resin particles.
<3> The ink set according to <1> or <2>,
wherein the white ink and the color ink each independently have static surface tension of 40.0 mN/m or less at 25° C.
<4> The ink set according to any one of <1> to <3>, wherein the color ink is a plurality of color inks including a black ink, a cyan ink, a magenta ink, and a yellow ink,
wherein an absolute value of a difference in dynamic surface tension between the color inks at 25° C. with the bubble lifetime of 15 msec is 1.0 mN/m or less, and
wherein the dynamic surface tension of the black ink at 25° C. with the bubble lifetime of 15 msec, the dynamic surface tension of the cyan ink at 25° C. with the bubble lifetime of 15 msec, the dynamic surface tension of the magenta ink at 25° C. with the bubble lifetime of 15 msec, and the dynamic surface tension of the yellow ink at 25° C. with the bubble lifetime of 15 msec satisfy Relational Expression (1) below,

Black ink>cyan ink≥magenta ink≥yellow ink Relational Expression (1).

<5> The ink set according to any one of <1> to <4>, further including a pre-processing fluid,
wherein the pre-processing fluid includes water and a flocculant, and
wherein the flocculant is at least one selected from the group consisting of an inorganic metal salt, an organic acid metal salt, an organic acid ammonium salt, and a cationic polymer.
<6> The ink set according to <5>,
wherein the pre-processing fluid further includes nonionic resin particles.
<7> The ink set according to <5> or <6>,
wherein the pre-processing fluid further includes wax particles.
<8> The ink set according to <7>,
wherein the wax particles are paraffin wax particles.
<9> An image forming method including:
applying a white ink to a recording medium; and
applying a color ink to an area of the recording medium to which the white ink is applied,
wherein the white ink and the color ink each independently include water-dispersible resin particles, and a blocked isocyanate compound, where a resin of the water-dispersible resin particles includes a crosslinkable functional group, and the blocked isocyanate compound includes a functional group that can crosslink with the resin of the water-dispersible resin particles,
wherein an absolute value of a difference in static surface tension between the white ink and the color ink at 25° C. is 1.0 mN/m or less, and wherein an absolute value of a difference in dynamic surface tension between the white ink and the color ink at 25° C. with a bubble lifetime of 15 msec, an absolute value of a difference in dynamic surface tension between the white ink and the color ink at 25° C. with a bubble lifetime of 150 msec, and an absolute value of a difference in dynamic surface tension between the white ink and the color ink at 25° C. with a bubble lifetime of 1,500 msec are each independently 1.0 mN/m or less, where the bubble lifetime is a bubble lifetime measured according to the maximum bubble pressure method.
<10> The image forming method according to <9>, further including
prior to the applying the white ink, applying a pre-processing fluid to an area of the recording medium to which the white ink is to be applied.
<11> The image forming method according to <9> or <10>,
wherein heating or drying the recording medium to which the white ink is applied is not performed during a period between the applying the white ink and the applying the color ink.
<12> The image forming method according to any one of <9> to <11>,
wherein a time span between the applying the white ink and the applying the color ink is within 20 seconds.
<13> The image forming method according to any one of <9> to <12>,
wherein the recording medium is dark color fabric.
<14> The image forming apparatus according to any one of <9> to <13>,
the white ink and the color ink each independently include 0.1 parts by mass through 0.55 parts by mass of the blocked isocyanate compound relative to 1 part by mass of the water-dispersible resin particles.
<15> The image forming method according to any one of <9> to <14>,
wherein the white ink and the color ink each independently have static surface tension of 40.0 mN/m or less at 25° C.
<16> The image forming method according to any one of <9> to <15>,
wherein the color ink is a plurality of color inks including a black ink, a cyan ink, a magenta ink, and a yellow ink,
wherein an absolute value of a difference in dynamic surface tension between the color inks at 25° C. with the bubble lifetime of 15 msec is 1.0 mN/m or less, and
wherein the dynamic surface tension of the black ink at 25° C. with the bubble lifetime of 15 msec, the dynamic surface tension of the cyan ink at 25° C. with the bubble lifetime of 15 msec, the dynamic surface tension of the magenta ink at 25° C. with the bubble lifetime of 15 msec, and the dynamic surface tension of the yellow ink at 25° C. with the bubble lifetime of 15 msec satisfy Relational Expression (1) below:

Black ink>cyan ink≥magenta ink≥yellow ink Relational Expression (1)

<17> The image forming method according to any one of <10> to <16>,
wherein the pre-processing fluid includes water and a flocculant, and
wherein the flocculant is at least one selected from the group consisting of an inorganic metal salt, an organic acid metal salt, an organic acid ammonium salt, and a cationic polymer.
<18> The image forming method according to <17>, wherein the pre-processing fluid further includes nonionic resin particles.
<19> The image forming method according to <17> or <18>,
wherein the pre-processing fluid further includes wax particles.
<20> The image forming method according to <19>, wherein the wax particles are paraffin wax particles.
<21> An image forming apparatus including:
a white ink storage unit in which a white ink is stored;
a color ink storage unit in which a color ink is stored;
a white ink application unit configured to apply the white ink to a recording medium; and
a color ink application unit configured to apply the color ink to an area of the recording medium to which the white ink is applied,
wherein the white ink and the color ink each independently include water-dispersible resin particles, and a blocked isocyanate compound, where a resin of the water-dispersible resin particles includes a crosslinkable functional group, and the blocked isocyanate compound includes a functional group that can crosslink with the resin of the water-dispersible resin particles,
wherein an absolute value of a difference in static surface tension between the white ink and the color ink at 25° C. is 1.0 mN/m or less, and
wherein an absolute value of a difference in dynamic surface tension between the white ink and the color ink at 25° C. with a bubble lifetime of 15 msec, an absolute value of a difference in dynamic surface tension between the white ink and the color ink at 25° C. with a bubble lifetime of 150 msec, and an absolute value of a difference in dynamic surface tension between the white ink and the color ink at 25° C. with a bubble lifetime of 1,500 msec are each independently 1.0 mN/m or less, where the bubble lifetime is a bubble lifetime measured according to the maximum bubble pressure method.
<22> The image forming apparatus according to <21>, further including:
a pre-processing fluid storage unit in which a pre-processing fluid is stored; and
a pre-processing fluid application unit configured to apply the pre-processing fluid to an area of the recording medium to which the white ink is to be applied, prior to application of the white ink.
<23> The image forming apparatus according to <21> or <22>,
wherein the image forming apparatus is free from a heating or drying unit configured to heat or dry the recording medium to which the white ink is applied.
<24> The image forming apparatus according to any one of <21> to <23>,
wherein the recording medium is dark color fabric.
<25> The image forming apparatus according to any one of <21> to <24>,
wherein the white ink and the color ink each independently include 0.1 parts by mass through 0.55 parts by mass of the blocked isocyanate compound relative to 1 part by mass of the water-dispersible resin particles.
<26> The image forming apparatus according to any one of <21> to <25>,
wherein the white ink and the color ink each independently have static surface tension of 40.0 mN/m or less at 25° C.
<27> The image forming apparatus according to any one of <21> to <26>,
wherein the color ink is a plurality of color inks including a black ink, a cyan ink, a magenta ink, and a yellow ink,
wherein an absolute value of a difference in dynamic surface tension between the color inks at 25° C. with the bubble lifetime of 15 msec is 1.0 mN/m or less, and
wherein the dynamic surface tension of the black ink at 25° C. with the bubble lifetime of 15 msec, the dynamic surface tension of the cyan ink at 25° C. with the bubble lifetime of 15 msec, the dynamic surface tension of the magenta ink at 25° C. with the bubble lifetime of 15 msec, and the dynamic surface tension of the yellow ink at 25° C. with the bubble lifetime of 15 msec satisfy Relational Expression (1) below:

Black ink>cyan ink≥magenta ink≥yellow ink Relational Expression (1)

<28> The image forming apparatus according to any one of <22> to <27>,
wherein the pre-processing fluid includes water and a flocculant, and
wherein the flocculant is at least one selected from the group consisting of an inorganic metal salt, an organic acid metal salt, an organic acid ammonium salt, and a cationic polymer.
<29> The image forming apparatus according to <28>, wherein the pre-processing fluid further includes nonionic resin particles.
<30> The image forming apparatus according to <28> or <29>,
wherein the pre-processing fluid further include wax particles.
<31> The image forming apparatus according to <30>, wherein the wax particles are paraffin wax particles.

The ink set according to any one of <1> to <8>, the image forming method according to any one of <9> to <20>, and the image forming apparatus according to any one of <21> to <31> can solve the above-described various problems existing in the art, and can achieve the object of the present disclosure.

What is claimed is:

1. An ink set comprising:
a white ink; and
a color ink,
wherein the white ink and the color ink each independently include water-dispersible resin particles, and a blocked isocyanate compound, where a resin of the water-dispersible resin particles includes a crosslinkable functional group, and the blocked isocyanate compound includes a functional group that can crosslink with the resin of the water-dispersible resin particles,
wherein an absolute value of a difference in static surface tension between the white ink and the color ink at 25° C. is 1.0 mN/m or less, and
wherein an absolute value of a difference in dynamic surface tension between the white ink and the color ink at 25° C. with a bubble lifetime of 15 msec, an absolute value of a difference in dynamic surface tension between the white ink and the color ink at 25° C. with a bubble lifetime of 150 msec, and an absolute value of a difference in dynamic surface tension between the white ink and the color ink at 25° C. with a bubble lifetime of 1,500 msec are each independently 1.0 mN/m or less, where the bubble lifetime is a bubble lifetime measured according to the maximum bubble pressure method.

2. The ink set according to claim 1, wherein the white ink and the color ink each independently include 0.1 parts by mass through 0.55 parts by mass of the blocked isocyanate compound relative to 1 part by mass of the water-dispersible resin particles.

3. The ink set according to claim 1, wherein the white ink and the color ink each independently have static surface tension of 40.0 mN/m or less at 25° C.

4. The ink set according to claim 1, wherein the color ink is a plurality of color inks including a black ink, a cyan ink, a magenta ink, and a yellow ink,
wherein an absolute value of a difference in dynamic surface tension between the color inks at 25° C. with the bubble lifetime of 15 msec is 1.0 mN/m or less, and
wherein the dynamic surface tension of the black ink at 25° C. with the bubble lifetime of 15 msec, the dynamic surface tension of the cyan ink at 25° C. with the bubble lifetime of 15 msec, the dynamic surface tension of the magenta ink at 25° C. with the bubble lifetime of 15 msec, and the dynamic surface tension of the yellow ink at 25° C. with the bubble lifetime of 15 msec satisfy Relational Expression (1) below,
Black ink>cyan ink≥magenta ink≥yellow ink Relational Expression (1).

5. The ink set according to claim 1, further comprising a pre-processing fluid,
wherein the pre-processing fluid includes water and a flocculant, and
wherein the flocculant is at least one selected from the group consisting of an inorganic metal salt, an organic acid metal salt, an organic acid ammonium salt, and a cationic polymer.

6. The ink set according to claim 5, wherein the pre-processing fluid further includes nonionic resin particles.

7. The ink set according to claim 5, wherein the pre-processing fluid further includes wax particles.

8. The ink set according to claim 7, wherein the wax particles are paraffin wax particles.

9. An image forming method comprising:
applying a white ink to a recording medium; and
applying a color ink to an area of the recording medium to which the white ink is applied,
wherein the white ink and the color ink each independently include water-dispersible resin particles, and a blocked isocyanate compound, where a resin of the water-dispersible resin particles includes a crosslinkable functional group, and the blocked isocyanate compound includes a functional group that can crosslink with the resin of the water-dispersible resin particles,
wherein an absolute value of a difference in static surface tension between the white ink and the color ink at 25° C. is 1.0 mN/m or less, and
wherein an absolute value of a difference in dynamic surface tension between the white ink and the color ink at 25° C. with a bubble lifetime of 15 msec, an absolute value of a difference in dynamic surface tension between the white ink and the color ink at 25° C. with a bubble lifetime of 150 msec, and an absolute value of a difference in dynamic surface tension between the white ink and the color ink at 25° C. with a bubble lifetime of 1,500 msec are each independently 1.0 mN/m or less, where the bubble lifetime is a bubble lifetime measured according to the maximum bubble pressure method.

10. The image forming method according to claim 9, further comprising
prior to the applying the white ink, applying a pre-processing fluid to an area of the recording medium to which the white ink is to be applied.

11. The image forming method according to claim 9,
wherein heating or drying the recording medium to which the white ink is applied is not performed during a period between the applying the white ink and the applying the color ink.

12. The image forming method according to claim 9,
wherein a time span between the applying the white ink and the applying the color ink is within 20 seconds.

13. The image forming method according to claim 9,
wherein the recording medium is dark color fabric.

14. An image forming apparatus comprising:
a white ink storage unit in which a white ink is stored;
a color ink storage unit in which a color ink is stored;
a white ink application unit configured to apply the white ink to a recording medium; and
a color ink application unit configured to apply the color ink to an area of the recording medium to which the white ink is applied,
wherein the white ink and the color ink each independently include water-dispersible resin particles, and a blocked isocyanate compound, where a resin of the water-dispersible resin particles includes a crosslinkable functional group, and the blocked isocyanate compound includes a functional group that can crosslink with the resin of the water-dispersible resin particles,
wherein an absolute value of a difference in static surface tension between the white ink and the color ink at 25° C. is 1.0 mN/m or less, and
wherein an absolute value of a difference in dynamic surface tension between the white ink and the color ink at 25° C. with a bubble lifetime of 15 msec, an absolute value of a difference in dynamic surface tension between the white ink and the color ink at 25° C. with a bubble lifetime of 150 msec, and an absolute value of a difference in dynamic surface tension between the white ink and the color ink at 25° C. with a bubble lifetime of 1,500 msec are each independently 1.0 mN/m or less, where the bubble lifetime is a bubble lifetime measured according to the maximum bubble pressure method.

15. The image forming apparatus according to claim 14, further comprising:
a pre-processing fluid storage unit in which a pre-processing fluid is stored; and
a pre-processing fluid application unit configured to apply the pre-processing fluid to an area of the recording medium to which the white ink is to be applied, prior to application of the white ink.
